(19) United States
(12) Patent Application Publication
(10) Pub. No.: US 2026/0299445 A1
(43) Pub. Date: Oct. 1, 2026

(54) ELECTROPHOTOGRAPHIC PHOTORECEPTOR, PROCESS CARTRIDGE, AND IMAGE FORMING APPARATUS

(71) Applicant: KYOCERA DOCUMENT SOLUTIONS INC., OSAKA (JP)

(72) Inventors: JUNICHIRO OTSUBO, OSAKA (JP); KATSUYA TAKANO, OSAKA (JP)

(21) Appl. No.: 19/578,910

(22) Filed: Mar. 26, 2026

(30) Foreign Application Priority Data
Mar. 27, 2025 (JP) 2025-054644

(51) Int. Cl. G03G 5/05; C08G 63/672

(52) U.S. Cl. CPC G03G 5/0546; C08G 63/672; G03G 5/056; G03G 2215/00957; G03G 2215/00962; G03G 2221/183

(57) ABSTRACT

An electrophotographic photoreceptor includes a conductive base and a photosensitive layer. The photosensitive layer includes a first photosensitive layer as an outermost surface. The first photosensitive layer contains a charge generating agent, a binder resin, an electron transporting agent, and a hole transporting agent. The binder resin includes a polyarylate resin and a polyester resin. The polyester resin contains first and second repeating units, with a content of 0.5% to 8.5% by mass relative to all binder resins. The polyarylate resin includes specific multiple repeating units and has a viscosity average molecular weight of 35,000 to 80,000. The electron transporting agent includes a compound selected from specific chemical structures.

### CROSS-REFERENCE TO RELATED PATENT APPLICATION

This application claims the benefit of Japanese Priority Patent Application JP 2025-054644 filed on Mar. 27, 2025, the entire contents of which are incorporated herein by reference.

### FIELD OF THE DISCLOSURE

The present disclosure relates to an electrophotographic photoreceptor, a process cartridge, and an image forming apparatus.

### BACKGROUND OF THE DISCLOSURE

Electrophotographic photoreceptors are used as image carriers in electrophotographic image forming apparatuses (e.g., printers or multifunction devices). The electrophotographic photoreceptor includes a photosensitive layer. As the electrophotographic photoreceptors, for example, a single-layer electrophotographic photoreceptor and a stacked electrophotographic photoreceptor are used. The single-layer electrophotographic photoreceptor includes a single photosensitive layer having a charge generating function and a charge transporting function. The stacked electrophotographic photoreceptor includes a photosensitive layer that includes a charge generating layer having a charge generating function and a charge transporting layer having a charge transporting function.

Image forming apparatuses using an electrophotographic technology are desired to have durability in mechanical and electrical characteristics, such as wear resistance. Improving wear resistance not only allows the photoreceptor surface to be prevented from wearing out but also achieving electrical stability of the photoreceptor surface. Therefore, even when repeated printing is performed, it is possible to prevent the electrical characteristics of the photoreceptor from deteriorating and suppress the adhesion of a toner to a non-image portion (so-called “fogging”).

For example, there has been known an electrophotographic photoreceptor including a polyarylate resin that includes specific repeating unit for improving wear resistance.

### SUMMARY OF THE DISCLOSURE

According to an embodiment of the present disclosure, there is provided an electrophotographic photoreceptor, including: a conductive base; and a photosensitive layer that includes at least one layer.

The photosensitive layer that includes at least one layer includes a first photosensitive layer, the first photosensitive layer being provided on an outermost surface side of the photosensitive layer that includes at least one layer.

The first photosensitive layer includes a charge generating agent, a binder resin that includes a polyarylate resin and a polyester resin, an electron transporting agent, and a hole transporting agent.

The polyester resin includes a first repeating unit represented by the following formula (a) and a second repeating unit represented by the following formula (b).

A content ratio of the polyester resin is 0.5 mass % or more and 8.5 mass % or less with respect to all binder resins included in the first photosensitive layer.

The polyarylate resin includes repeating units represented by the following formulae (1), (2), (3), and (4).

The polyarylate resin has a viscosity average molecular weight of 35,000 or more and 80,000 or less.

A third content ratio is more than 0% and less than 50%, the third content ratio being a content ratio of the repeating unit represented by the formula (3) with respect to a total number of repeating units represented by the formulae (1) and (3).

A fourth content ratio is 35% or more and less than 70%, the fourth content ratio being a content ratio of the repeating unit represented by the formula (4) with respect to a total number of repeating units represented by the formulae (2) and (4).

The electron transporting agent includes a compound represented by the following formula (11), (12), (13), (14), (15), (16), or (17).

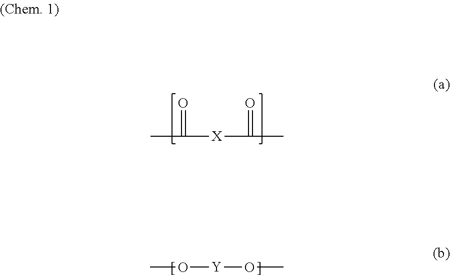

In the general formula (a), X represents a phenylene group that may be substituted with a first substituent group, the first substituent group being a phenyl group, an alkyl group having 1 to 8 carbon atoms, or an alkoxy group having 1 to 8 carbon atoms.

In the general formula (b), Y represents a divalent aliphatic hydrocarbon group having 1 to 8 carbon atoms, which may be substituted with a second substituent group, the second substituent group being a phenyl group or an alkoxy group having 1 to 8 carbon atoms.

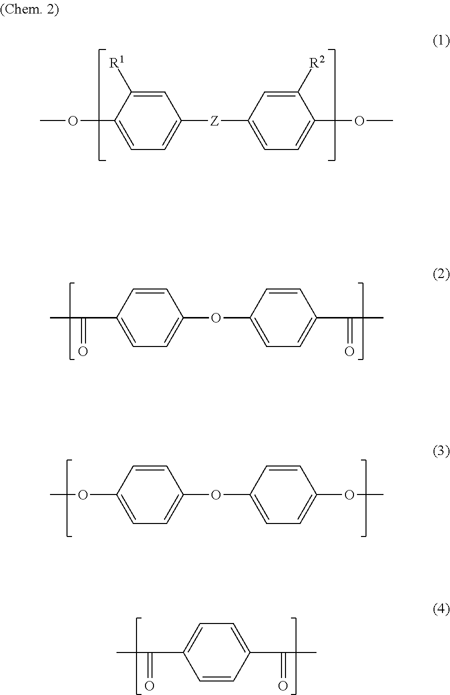

In the formula (1), R¹ and R² each represent a methyl group and Z represents a divalent group represented by the following formula (Z1), or

R¹ and R² each represent a hydrogen atom and Z represents a divalent group represented by the following formula (Z2).

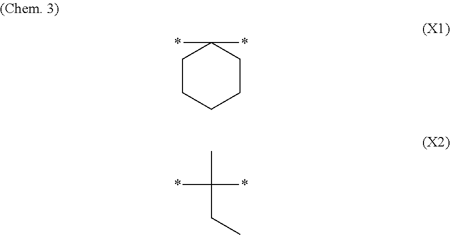

In the formulae (Z1) and (Z2), * represents atomic bonding.

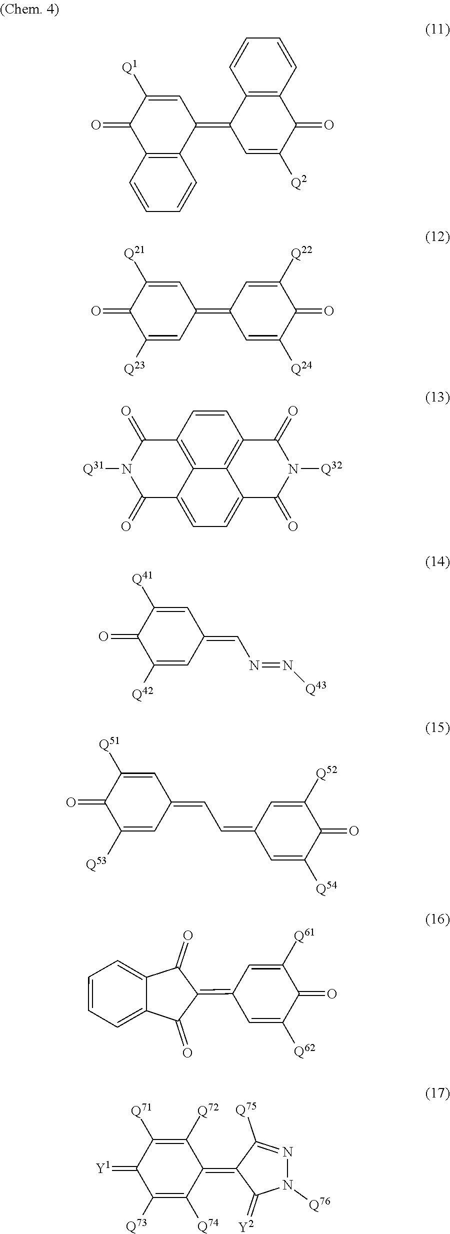

Q¹ and Q² in the formula (11), Q²¹, Q²², Q²³, and Q²⁴ in the formula (12), Q³¹ and Q³² in the formula (13), Q⁴¹, Q⁴², and Q⁴³ in the formula (14), Q⁵¹, Q⁵², Q⁵³, and Q⁵⁴ in the formula (15), Q⁶¹ and Q⁶² in the formula (16), and Q⁷¹, Q⁷², Q⁷³, Q⁷⁴, Q⁷⁵, and Q⁷⁶ in the formula (17) each independently represent a hydrogen atom, a halogen atom, a cyano group, an alkyl group having 1 to 6 carbon atoms, an alkenyl group having 2 to 6 carbon atoms, an alkoxy group having 1 to 6 carbon atoms, or an aryl group having 6 to 14 carbon atoms that may be substituted with at least one substituent group selected from the group consisting of an alkyl group having 1 to 6 carbon atoms and a halogen atom, and

Y¹ and Y² in the formula (17) each independently represent an oxygen atom or a sulfur atom.

### BRIEF DESCRIPTION OF THE DRAWINGS

FIG. 1 is a partial cross-sectional view of a single-layer electrophotographic photoreceptor that is an example of an electrophotographic photoreceptor according to a first embodiment of the present disclosure.

FIG. 2 is a partial cross-sectional view of a single-layer electrophotographic photoreceptor that is an example of the electrophotographic photoreceptor according to the first embodiment of the present disclosure.

FIG. 3 is a partial cross-sectional view of a single-layer electrophotographic photoreceptor that is an example of the electrophotographic photoreceptor according to the first embodiment of the present disclosure.

FIG. 4 is a partial cross-sectional view of a positively-charged stacked electrophotographic photoreceptor that is an example of the electrophotographic photoreceptor according to the first embodiment of the present disclosure.

FIG. 5 is a partial cross-sectional view of a positively-charged stacked electrophotographic photoreceptor that is an example of the electrophotographic photoreceptor according to the first embodiment of the present disclosure.

FIG. 6 is a partial cross-sectional view of a positively-charged stacked electrophotographic photoreceptor that is an example of the electrophotographic photoreceptor according to the first embodiment of the present disclosure.

FIG. 7 is a diagram showing an image forming apparatus according to a second embodiment of the present disclosure.

FIG. 8 is a diagram showing an example of a configuration of a scratching device.

FIG. 9 is a cross-sectional view taken along the line IV-IV in FIG. 8.

FIG. 10 is a side view of a fixing base, a scratching needle, and an electrophotographic photoreceptor shown in FIG. 8.

FIG. 11 is a diagram showing a scratch formed on a surface of a photosensitive layer.

FIG. 12 is a diagram schematically showing the occurrence of end-portion fogging.

### DETAILED DESCRIPTION OF THE EXEMPLARY EMBODIMENTS

An embodiment of the present disclosure will be described below in detail. However, the present disclosure is not limited to the following embodiments and can be appropriately modified within the spirit of the present disclosure and carried out. Note that the descriptions may be omitted where they are redundant, but the essence of the present disclosure is not limited. Hereinafter, the term “-based” is added after the compound name to collectively refer to the compound and derivatives thereof in some cases. Further, in the case of adding the term “-based” after a compound to refer to a polymer name, it means that the repeating unit of the polymer is derived from the compound or a derivative thereof. Further, a “general formula” and a “chemical formula” are collectively referred to as a “formula.” The term “each independently” in the description of formulae mean that they may represent the same group or different groups. Unless otherwise specified, the components described in the present specification may each be used alone, or two or more of them may be used in combination.

First, substituent groups used in the present specification will be described. Examples of the halogen atom (halogen group) include a fluorine atom (fluoro group), a chlorine atom (chloro group), a bromine atom (bromo group), and an iodine atom (iodo group).

An alkyl group having 1 to 8 carbon atoms, an alkyl group having 1 to 6 carbon atoms, and an alkyl group having 1 to 3 carbon atoms are each linear or branched-chain and unsubstituted, unless otherwise specified. Examples of the alkyl group having 1 to 8 carbon atoms include a methyl group, an ethyl group, an n-propyl group, an isopropyl group, an n-butyl group, a sec-butyl group, a tert-butyl group, an n-pentyl group, a 1-methylbutyl group, a 2-methylbutyl group, a 3-methylbutyl group, a 1-ethylpropyl group, a 2-ethylpropyl group, a 1,1-dimethylpropyl group, a 1,2-dimethylpropyl group, a 2,2-dimethylpropyl group, an n-hexyl group, a 1-methylpentyl group, a 2-methylpentyl group, a 3-methylpentyl group, a 4-methylpentyl group, a 1,1-dimethylbutyl group, a 1,2-dimethylbutyl group, a 1,3-dimethylbutyl group, a 2,2-dimethylbutyl group, a 2,3-dimethylbutyl group, a 3,3-dimethylbutyl group, a 1,1,2-trimethylpropyl group, a 1,2,2-trimethylpropyl group, a 1-ethylbutyl group, a 2-ethylbutyl group, a 3-ethylbutyl group, linear and branched-chain heptyl groups, and linear and branched-chain octyl groups. Examples of the alkyl group having 1 to 6 carbon atoms and the alkyl group having 1 to 3 carbon atoms are groups having the corresponding number of carbon atoms, of the groups mentioned as the examples of the alkyl group having 1 to 8 carbon atoms.

A perfluoroalkyl group having 1 to 10 carbon atoms, a perfluoroalkyl group having 3 to 10 carbon atoms, a perfluoroalkyl group having 5 to 7 carbon atoms, and a perfluoroalkyl group having 6 carbon atoms are linear or branched-chain and unsubstituted, unless otherwise specified. Examples of the perfluoroalkyl group having 1 to 10 carbon atoms include a trifluoromethyl group, a perfluoroethyl group, a perfluoro-n-propyl group, a perfluoroisopropyl group, a perfluoro-n-butyl group, a perfluoro-sec-butyl group, a perfluoro-tert-butyl group, a perfluoro-n-pentyl group, a perfluoro-1-methylbutyl group, a perfluoro-2-methylbutyl group, a perfluoro-3-methylbutyl group, a perfluoro-1-ethylpropyl group, a perfluoro-2-ethylpropyl group, a perfluoro-1,1-dimethylpropyl group, a perfluoro-1,2-dimethylpropyl group, a perfluoro-2,2-dimethylpropyl group, a perfluoro-n-hexyl group, a perfluoro-1-methylpentyl group, a perfluoro-2-methylpentyl group, a perfluoro-3-methylpentyl group, a perfluoro-4-methylpentyl group, a perfluoro-1,1-dimethylbutyl group, a perfluoro-1,2-dimethylbutyl group, a perfluoro-1,3-dimethylbutyl group, a perfluoro-2,2-dimethylbutyl group, a perfluoro-2,3-dimethylbutyl group, a perfluoro-3,3-dimethylbutyl group, a perfluoro-1,1,2-trimethylpropyl group, a perfluoro-1,2,2-trimethylpropyl group, a perfluoro-1-ethylbutyl group, a perfluoro-2-ethylbutyl group, a perfluoro-3-ethylbutyl group, linear and branched-chain perfluoroheptyl groups, linear and branched-chain perfluorooctyl groups, linear and branched-chain perfluorononyl groups, and linear and branched-chain perfluorodecyl groups. Examples of the perfluoroalkyl group having 3 to 10 carbon atoms, the perfluoroalkyl group having 5 to 7 carbon atoms, and the perfluoroalkyl group having 6 carbon atoms are groups having the corresponding number of carbon atoms, of the groups mentioned as the examples of the perfluoroalkyl group having 1 to 10 carbon atoms.

An alkanediyl group having 1 to 6 carbon atoms and an alkanediyl group having 1 to 3 carbon atoms are linear or branched-chain and unsubstituted, unless otherwise specified. Examples of the alkanediyl group having 1 to 6 carbon atoms include a methanediyl group (methylene group), an ethanediyl group, an n-propanediyl group, an isopropanediyl group, an n-butanediyl group, a sec-butanediyl group, a tert-butanediyl group, an n-pentanediyl group, a 1-methylbutanediyl group, a 2-methylbutanediyl group, a 3-methylbutanediyl group, a 1-ethylpropanediyl group, a 2-ethylpropanediyl group, a 1,1-dimethylpropanediyl group, a 1,2-dimethylpropanediyl group, a 2,2-dimethylpropanediyl group, an n-hexanediyl group, a 1-methylpentanediyl group, a 2-methylpentanediyl group, a 3-methylpentanediyl group, a 4-methylpentanediyl group, a 1,1-dimethylbutanediyl group, a 1,2-dimethylbutanediyl group, a 1,3-dimethylbutanediyl group, a 2,2-dimethylbutanediyl group, a 2,3-dimethylbutanediyl group, a 3,3-dimethylbutanediyl group, a 1,1,2-trimethylpropanediyl group, a 1,2,2-trimethylpropanediyl group, a 1-ethylbutanediyl group, a 2-ethylbutanediyl group, and a 3-ethylbutanediyl group. Examples of the alkanediyl group having 1 to 3 carbon atoms are groups having the corresponding number of carbon atoms, of the groups mentioned as the examples of the alkanediyl group having 1 to 6 carbon atoms.

An alkoxy group having 1 to 8 carbon atoms, an alkoxy group having 1 to 6 carbon atoms, and an alkoxy group having 1 to 3 carbon atoms are linear or branched-chain and unsubstituted, unless otherwise specified. Examples of the alkoxy group having 1 to 8 carbon atoms include a methoxy group, an ethoxy group, an n-propoxy group, an isopropoxy group, an n-butoxy group, a sec-butoxy group, a tert-butoxy group, an n-pentoxy group, a 1-methylbutoxy group, a 2-methylbutoxy group, a 3-methylbutoxy group, a 1-ethylpropoxy group, a 2-ethylpropoxy group, a 1,1-dimethylpropoxy group, a1,2-dimethylpropoxy group, a 2,2-dimethylpropoxy group, an n-hexyloxy group, a 1-methylpentyloxy group, a 2-methylpentyloxy group, a 3-methylpentyloxy group, a 4-methylpentyloxy group, a 1,1-dimethylbutoxy group, a 1,2-dimethylbutoxy group, a 1,3-dimethylbutoxy group, a 2,2-dimethylbutoxy group, a 2,3-dimethylbutoxy group, a 3,3-dimethylbutoxy group, a 1,1,2-trimethylpropoxy group, a 1,2,2-trimethylpropoxy group, a 1-ethylbutoxy group, a 2-ethylbutoxy group, a 3-ethylbutoxy group, linear and branched-chain heptyloxy groups, and linear and branched-chain octyloxy groups. Examples of the alkoxy group having 1 to 6 carbon atoms and the alkoxy group having 1 to 3 carbon atoms are groups having the corresponding number of carbon atoms, of the groups mentioned as the examples of the alkoxy group having 1 to 8 carbon atoms.

An alkenyl group is linear or branched-chain and unsubstituted, unless otherwise specified. The alkenyl group having 2 to 6 carbon atoms has 1 or more and 3 or less double bonds. Examples of the alkenyl group having 2 to 6 carbon atoms include an ethenyl group, a propenyl group, a butenyl group, a butadienyl group, a pentenyl group, a hexenyl group, a hexadienyl group, and a hexatrienyl group.

Each aryl group is unsubstituted, unless otherwise specified. Examples of the aryl group having 6 to 14 carbon atoms include a phenyl group, a naphthyl group, an indacenyl group, a biphenylenyl group, an acenaphthylenyl group, an anthryl group, and a phenanthryl group. Examples of other aryl groups having a different number of carbon atoms include those having a predetermined number of carbon atoms, of the above-mentioned aryl groups.

The substituent group used in the present specification has been described above.

### First Embodiment: Electrophotographic Photoreceptor

### [Overview of Electrophotographic Photoreceptor According to Present Disclosure]

The electrophotographic photoreceptor according to this embodiment is characterized by including a photosensitive layer that includes a charge generating agent, a specific electron transporting agent, and a binder resin including a specific polyarylate resin and a specific polyester resin. According to the electrophotographic photoreceptor, it is possible to suppress the occurrence of fogging effectively even in the case where repeated printing is performed under a high-temperature and high-humidity environment, while improving wear resistance.

The actions and effects will be described below.

In the electrophotographic photoreceptor according to this embodiment, by using a binder resin including a specific polyarylate resin, it is possible to improve the wear resistance of the electrophotographic photoreceptor.

Further, by using a binder resin including a specific polyester resin in a specific amount, it is possible to reduce the hygroscopicity of the photoreceptor. This prevents electrical characteristics from deteriorating due to adsorption of moisture or the like even in the case where repeated printing is performed under a high-temperature and high-humidity environment. As a result, it is possible to achieve the charge stability of the electrophotographic photoreceptor and suppress the occurrence of fogging.

Further, by including a specific electron transporting agent, electrons can be suitably extracted from the charge generating agent and rapidly transported to the photoreceptor surface. Therefore, it is possible to suppress the decrease in sensitivity and the increase in residual potential of the photoreceptor even during repeated printing under a high-temperature and high-humidity environment and suppress the occurrence of fogging effectively.

As described above, according to the configuration of the present disclosure, the effects of each component are exhibited without being impaired, and thus, the synergistic effects thereof allow an electrophotographic photoreceptor having excellent wear resistance and fogging resistance to be obtained.

Further, the electrophotographic photoreceptor according to this embodiment is configured to be of a positively-charged type, and is particularly useful when used in an image forming apparatus using a direct transfer method. This will be described below in detail.

First, the direct transfer method refers to a method of directly transferring a toner image on a photoreceptor (image carrier) to a recording medium (sheet of paper). Specifically, the toner image is transferred to the sheet of paper by causing the positively-charged electrophotographic photoreceptor to come into contact with a transfer roller to which a bias (negative voltage) of opposite polarity to the toner has been applied, via the sheet of paper. In the case where repeated printing is performed under a high-temperature and high-humidity environment using such an image forming apparatus using the contact transfer method, so-called end-portion fogging where the toner adheres to an end portion of the sheet of paper is likely to occur significantly.

FIG. 12 is a diagram schematically showing the occurrence of end-portion fogging. FIG. 12 shows a case where a front surface Pla of a first sheet of paper 166 (hereinafter, referred to as P1), a front surface P2a of a second sheet of paper 166 (hereinafter, referred to as P2), a back surface P1b of the first sheet of paper P1, a back surface P2b of the second sheet of paper P2, and a front surface P3a of a third sheet of paper 166 (hereinafter, referred to as P3) are fed in this order and a transfer roller 163 and the photoreceptor drum 161 are brought into contact with each other via the sheet of paper 166 to transfer a toner image to the sheet of paper 166, thereby forming an image. In FIG. 12, in the case where a width W1 of the sheet of paper 166 along a direction parallel to the rotation axis of the transfer roller 163 is smaller than a width W2 of the transfer roller 163 along the rotation axis, the photoreceptor drum 161 has an end portion region T1 (a non-paper-passing portion) where it comes into direct contact with the end portion of the transfer roller 163 in the rotation axis direction and an internal region B1 (a paper-passing portion) where the sheet of paper 166 is interposed between the photoreceptor drum 161 and the transfer roller 163. In this end portion region T1, the transfer roller and the photoreceptor are brought into direct contact with each other to undergo strong transfer, which makes the negative-voltage resistance the photoreceptor drum 161 more likely to decrease. In the case where the negative-voltage resistance has decreased in this end portion region T1, the toner is more likely to adhere in the end portion region T1. In the case where the back surface P2b of the second sheet of paper P2 is conveyed offset in a direction parallel to the rotation axis of the transfer roller 163 during transfer to the back surface P2b of the second sheet of paper P2, the toner in the end portion region T2 (the toner-adhered area within the end portion region T1) of the photoreceptor drum 161 is transferred to the end portion of the back surface P2b of the second sheet of paper 166, and appears as end-portion fogging in the region indicated by T3.

In this regard, by including the above polyester resin, hygroscopicity can be reduced, thereby suppressing the decrease in negative-voltage resistance. As a result, it is possible to suppress end-portion fogging effectively even in the case where repeated printing is performed under a high-temperature and high-humidity environment.

In the electrophotographic photoreceptor described in the above Background, it has been difficult to sufficiently suppress the occurrence of fogging although wear resistance can be improved. Specifically, it has been difficult to sufficiently suppress the occurrence of fogging in the case where repeated printing is performed under a high-temperature and high-humidity environment where the electrical characteristics of the photoreceptor tend to deteriorate and the occurrence of fogging becomes noticeable. Meanwhile, according to the present disclosure, it is possible to provide an electrophotographic photoreceptor, a process cartridge, and an image forming apparatus that have excellent wear resistance and are capable of suppressing the occurrence of fogging even in the case where repeated printing is performed under a high-temperature and high-humidity environment.

### [Details of Electrophotographic Photoreceptor According to Present Disclosure]

### 1. Electrophotographic Photoreceptor

A first embodiment of the present disclosure relates to an electrophotographic photoreceptor (hereinafter, referred to as a photoreceptor in some cases). The photoreceptor according to the first embodiment includes a conductive base, and a photosensitive layer that includes at least one layer. The photosensitive layer that includes at least one layer includes a first photosensitive layer. The first photosensitive layer is provided on the outermost surface side of the photosensitive layer that includes at least one layer. The surface side refers to the outer surface side of the photoreceptor (e.g., the side where exposure light enters) and is opposite to the side where the conductive base of the photoreceptor is provided.

The photoreceptor according to the first embodiment is, for example, a single-layer electrophotographic photoreceptor (hereinafter, referred to as a single-layer photoreceptor in some cases) or a positively-charged stacked electrophotographic photoreceptor (hereinafter, referred to as a positively-charged stacked photoreceptor in some cases). From the viewpoint of achieving more excellent fogging resistance, the photoreceptor according to the first embodiment is typically a positively-charged photoreceptor (photoreceptor of a single-layer type or a stacked type). Further, the photoreceptor according to the first embodiment is favorably used in an image forming apparatus using a direct transfer method in which a photoreceptor and a recording medium (sheet of paper or the like) are brought into direct contact with each other to transfer.

### (Single-Layer Photoreceptor)

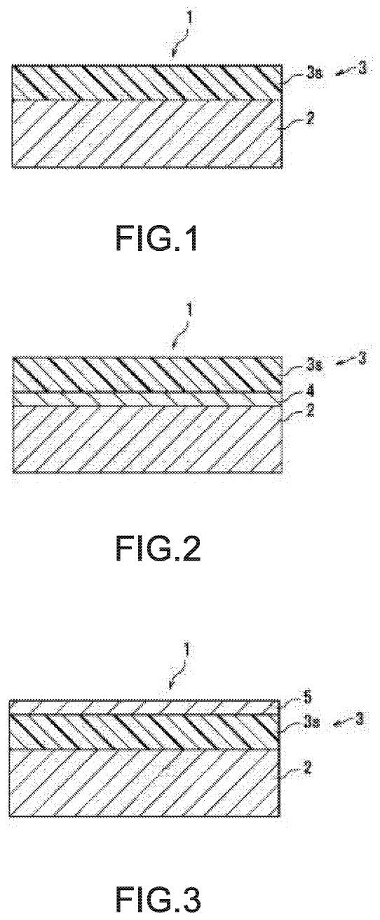

A single-layer photoreceptor 1 that is an example of the photoreceptor according to the first embodiment will be described below with reference to FIG. 1 to FIG. 3. FIG. 1 to FIG. 3 each show a partial cross-sectional view of the single-layer photoreceptor 1.

As shown in FIG. 1, the single-layer photoreceptor 1 includes, for example, a conductive base 2 and a photosensitive layer 3. The photosensitive layer 3 included in the single-layer photoreceptor 1 includes a single layer (one layer). The one layer of the photosensitive layer 3 is a single-layer photosensitive layer 3s that is a first photosensitive layer.

As shown in FIG. 2, the single-layer photoreceptor 1 may further include an intermediate layer 4 (undercoat layer) in addition to the conductive base 2 and the single-layer photosensitive layer 3s. The intermediate layer 4 is provided between the conductive base 2 and the single-layer photosensitive layer 3s. As shown in FIG. 1, the single-layer photosensitive layer 3s may be provided directly on the conductive base 2. Alternatively, as shown in FIG. 2, the single-layer photosensitive layer 3s may be provided on the conductive base 2 via the intermediate layer 4.

As shown in FIG. 3, the single-layer photoreceptor 1 may further include a protective layer 5 in addition to the conductive base 2 and the single-layer photosensitive layer 3s. The protective layer 5 is provided on the single-layer photosensitive layer 3s. It is favorable that the single-layer photosensitive layer 3s is provided as the top surface layer of the single-layer photoreceptor 1 as shown in FIG. 1 and FIG. 2. Providing the single-layer photosensitive layer 3s including a polyarylate resin (PA) described below as the top surface layer makes it easier to improve the wear resistance and fogging resistance of the single-layer photoreceptor 1. Note that, as shown in FIG. 3, the protective layer 5 may be provided as the top surface layer of the single-layer photoreceptor 1.

The thickness of the single-layer photosensitive layer 3s is not particularly limited but is favorably 5 μm or more and 100 μm or less, more favorably 10 μm or more and 50 μm or less.

The single-layer photosensitive layer 3s that is the first photosensitive layer includes a charge generating agent, a binder resin, an electron transporting agent, and a hole transporting agent. Hereinafter, the “hole transporting agent included in the single-layer photosensitive layer 3s” will be referred to as a “hole transporting agent (SL)” in some cases. Further, the “binder resin included in the single-layer photosensitive layer 3s” will be referred to as a “binder resin (SL)” in some cases. The single-layer photosensitive layer 3s may include an additive as necessary. The single-layer photoreceptor 1 has been described above with reference to FIG. 1 to FIG. 3.

### (Positively-Charged Stacked Photoreceptor)

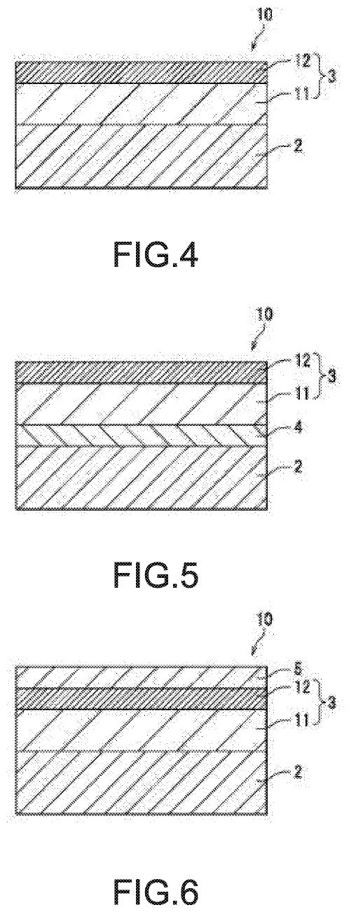

A positively-charged stacked photoreceptor 10 that is an example of the photoreceptor according to the first embodiment will be described with reference to FIG. 4 to FIG. 6. FIG. 4 to FIG. 6 each show a partial cross-sectional view of the positively-charged stacked photoreceptor 10.

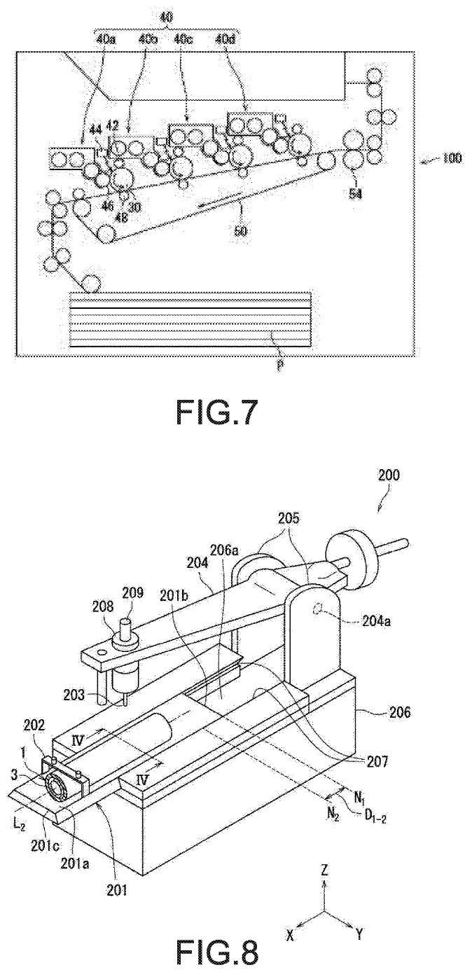

As shown in FIG. 4, the positively-charged stacked photoreceptor 10 includes, for example, the conductive base 2 and the photosensitive layer 3. The photosensitive layer 3 included in the positively-charged stacked photoreceptor 10 includes two layers. The two layers of the photosensitive layer 3 are a charge generating layer 12 and a charge transporting layer 11. The charge generating layer 12 is the first photosensitive layer. The charge transporting layer 11 is a second photosensitive layer. The charge generating layer 12 that is the first photosensitive layer is provided on the outermost surface side of the two layers of the photosensitive layer 3 (the charge generating layer 12 and the charge transporting layer 11). The charge transporting layer 11 is provided closer to the conductive base 2 than the charge generating layer 12. Since the charge generating layer 12 is positioned on the outermost surface side (on the side of the positively-charged stacked photoreceptor 10 opposite to the side where the conductive base 2 is provided), for example, the charge transporting layer 11 is provided on the conductive base 2 and the charge generating layer 12 is provided on the charge transporting layer 11. In the case where an image forming apparatus 100 (see FIG. 7) includes the positively-charged stacked photoreceptor 10, the positively-charged stacked photoreceptor 10 is charged to a positive polarity by a charging device 42 (see FIG. 7).

As shown in FIG. 5, the positively-charged stacked photoreceptor 10 may further include the intermediate layer 4 (undercoat layer) in addition to the conductive base 2 and the photosensitive layer 3. The intermediate layer 4 is provided between the conductive base 2 and the photosensitive layer 3 (e.g., the charge transporting layer 11). As shown in FIG. 4, the photosensitive layer 3 (e.g., the charge transporting layer 11) may be provided directly on the conductive base 2. Alternatively, as shown in FIG. 5, the photosensitive layer 3 (e.g., the charge transporting layer 11) may be provided on the conductive base 2 via the intermediate layer 4.

As shown in FIG. 6, the positively-charged stacked photoreceptor 10 may further include the protective layer 5 in addition to the conductive base 2 and the photosensitive layer 3. The protective layer 5 is provided on the photosensitive layer 3 (e.g., the charge generating layer 12). It is favorable that the photosensitive layer 3 is provided as the top surface layer of the positively-charged stacked photoreceptor 10 as shown in FIG. 4 and FIG. 5. Providing the photosensitive layer 3 (e.g., the charge generating layer 12) including a polyarylate resin (PA) described below as the top surface layer makes it easier to improve the wear resistance and fogging resistance of the positively-charged stacked photoreceptor 10. Note that, as shown in FIG. 6, the protective layer 5 may be provided as the top surface layer of the positively-charged stacked photoreceptor 10.

The thickness of the charge generating layer 12 is favorably 2 μm or more and 100 μm or less, more favorably 15 μm or more and 30 μm or less. The thickness of the charge transporting layer 11 is favorably 2 μm or more and 100 μm or less, more favorably 3 μm or more and 20 μm or less, still more favorably 5 μm or more and 15 μm or less.

The charge generating layer 12 that is the first photosensitive layer includes a charge generating agent, a binder resin, an electron transporting agent, and a hole transporting agent. Hereinafter, the “hole transporting agent included in the charge generating layer 12” will be referred to as a “hole transporting agent (CG)” in some cases. Further, the “binder resin included in the charge generating layer 12” will be referred to as a binder resin (CG) in some cases. The charge generating layer 12 may include an additive as necessary.

The charge transporting layer 11 that is the second photosensitive layer includes a hole transporting agent and a binder resin. Hereinafter, the “hole transporting agent included in the charge transporting layer 11” will be referred to as a hole transporting agent (CT) in some cases. Further, the “binder resin included in the charge transporting layer 11” will be referred to as a binder resin (CT) in some cases. The charge transporting layer 11 may include an additive as necessary. The positively-charged stacked photoreceptor 10 has been described above with reference to FIG. 4 to FIG. 6.

As described above, the photosensitive layer may include one layer, and the one layer of the photosensitive layer may be a single-layer photosensitive layer that is the first photosensitive layer. Alternatively, the photosensitive layer may include two layers, and the two layers of the photosensitive layer may be a charge generating layer that is the first photosensitive layer and a charge transporting layer that is the second photosensitive layer.

Hereinafter, each configuration of the photoreceptor will be described in more detail. Note that in the case where there is no particular need to distinguish between the binder resin (SL), the binder resin (CG), and the binder resin (CT), they will be referred to simply as a “binder resin”. In the case where there is no particular need to distinguish between the hole transporting agent (SL), the hole transporting agent (CG), and the hole transporting agent (CT), they will be referred to simply as a “hole transporting agent.”

### 2. Photosensitive Layer

### 2-1. Binder Resin

The photosensitive layer includes a charge generating agent, a binder resin, a hole transporting agent, and an electron transporting agent. The binder resins (SL) and (CG) included in the first photosensitive layer include a polyarylate resin (PA) and a polyester resin (PE). The polyarylate resin and the polyester resin function as binder resins of the photosensitive layer. The photosensitive layer may further include, as necessary, a binder resin other than the polyester resin and the polyarylate resin (hereinafter, referred to as a different binder resin in some cases) or an additive. The thickness of the photosensitive layer is not particularly limited as long as the function as the photosensitive layer can be sufficiently exhibited. The thickness of the photosensitive layer is favorably 5 μm or more and 100 μm or less, more favorably 10 μm or more and 50 μm or less.

### (1) Polyarylate Resin

The polyarylate resin includes repeating units represented by the following formulae (1), (2), (3), and (4). In the polyarylate resin, a third content ratio is more than 0% and less than 50%. The third content ratio is a content ratio of the repeating unit represented by the formula (3) with respect to the total number of repeating units represented by the formulae (1) and (3). In the polyarylate resin, a fourth content ratio is 35% or more and less than 70%. The fourth content ratio is a content ratio of the repeating unit represented by the formula (4) with respect to the total number of repeating units represented by the formulae (2) and (4). The repeating unit (1) or (3) and the repeating unit (2) or (4) are, for example, alternately arranged. In this case, it is favorable that the amount of the repeating units (1) and (3) and the amount of the repeating units (2) and (4), which are included in the polyarylate resin (PA), are substantially the same. For example, the polyarylate resin favorably includes four structural units, i.e., the repeating unit (1) and the repeating unit (2), the repeating unit (1) and the repeating unit (3), the repeating unit (3) and the repeating unit (2), and the repeating unit (3) and the repeating unit (4). Specifically, the ratio of the amount of the repeating units (2) and (4) to the amount of the repeating units (1) and (3) included in the polyarylate resin (PA) (the repeating units (2) and (4)/the repeating units (1) and (3)) is favorably 49/51 or more and 51/49 or less.

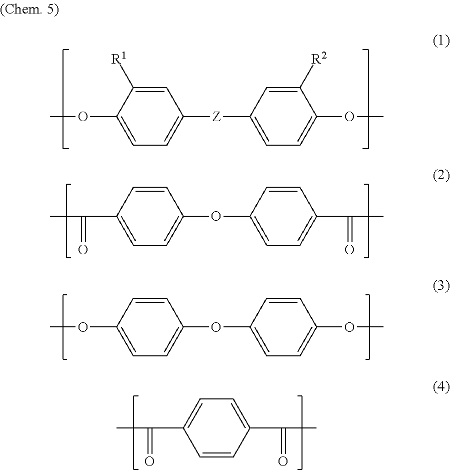

In the formula (1), R¹ and R² each represent a methyl group and Z represents a divalent group represented by the following formula (Z1). Alternatively, R¹ and R² each represent a hydrogen atom and Z represents a divalent group represented by the following formula (Z2).

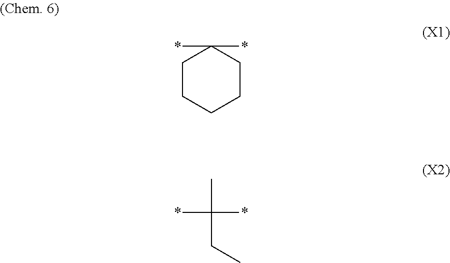

In the formulae (Z1) and (Z2), * represents atomic bonding. The atomic bonding represented by * in the formulae (Z1) and (Z2) is bonded to the carbon atom to which Z in the formula (1) is bonded.

Hereinafter, the “repeating units represented by the formulae (1), (2), (3), and (4)” will respectively be referred to as “repeating units (1), (2), (3), and (4)” in some cases. Further, a “polyarylate resin that includes the repeating units (1), (2), (3), and (4) and has a third content ratio of more than 0% and less than 50% and a fourth content ratio of 35% or more and less than 70%” will be referred to as a “polyarylate resin (PA)” in some cases.

As described above, each of the binder resins (SL) and (CG) included in the first photosensitive layer necessarily includes the polyarylate resin (PA). Note that the binder resin (CT) included in the charge transporting layer is not particularly limited, and may include the polyarylate resin (PA) or the different binder resin described below. Further, the binder resin (CG) and the binder resin (CT) may be the same as or different from each other.

The photosensitive layer (particularly, the first photosensitive layer) including the polyarylate resin (PA) is resistant to fine scratches. For this reason, the toner is less likely to penetrate into fine scratches, improving the wear resistance of the photoreceptor. Further, the scratch resistance of the photoreceptor is also improved. Further, since the polyarylate resin (PA) has excellent solubility in a solvent, the photosensitive layer (particularly, the first photosensitive layer) can be formed favorably.

In the formula (1), in the case where R¹ and R² each represent a methyl group and Z represents the divalent group represented by the formula (Z1), the repeating unit (1) is a repeating unit represented by the following formula (1-1) (hereinafter, referred to as a repeating unit (1-1) in some cases). In the formula (1) R¹ and R² each represent a hydrogen atom and Z represents the divalent group represented by the formula (Z2), the repeating unit (1) is a repeating unit represented by the following formula (1-2) (hereinafter, referred to as a repeating unit (1-2) in some cases). The polyarylate resin (PA) may include only one type of repeating unit (1) or may include two or more types of repeating units (1).

Note that the amount of each repeating unit in the polyarylate resin (PA) is not a value obtained from one molecular chain but an average of the values obtained from the entire polyarylate resin (PA) (a plurality of molecular chains) included in the photosensitive layer. Each ratio can be calculated from the 1H-NMR spectrum of the polyarylate resin (PA) measured using a proton nuclear magnetic resonance spectrometer.

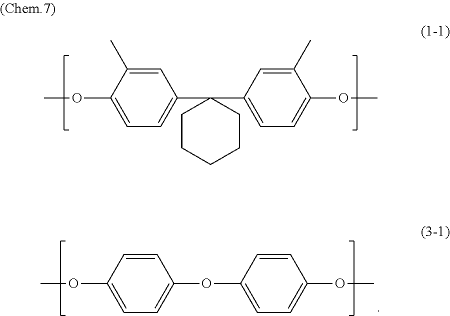

The content ratio of the repeating unit (1) with respect to the total number of repeating units (1) and (3) will be referred to as a first content ratio. The first content ratio corresponds to the percentage of the number M₁ of repeating units (1) with respect to the sum of the number M₁ of repeating units (1) and the number M₃ of repeating units (3) included in the polyarylate resin (PA) (i.e., 100×M₁/(M₁+M₃)). Note that in the case where the polyarylate resin (PA) includes two types of repeating units (1), the number M₁ of repeating units (1) is the total number of two types of repeating units (1).

The first content ratio is favorably less than 100%, more favorably 99% or less, still more favorably 90% or less, still more favorably 80% or less, still more favorably 70% or less, still more favorably less than 70%, particularly favorably 65% or less. Further, the first content ratio is favorably more than 50%, more favorably 51% or more, still more favorably 55% or more.

In order to improve the wear resistance and fogging resistance of the photoreceptor, the first content ratio is favorably 60% or more and 80% or less, more favorably more than 50% and 70% or less, still more favorably 50% or more and less than 70%.

The content ratio of the repeating unit (2) with respect to the total number of repeating units (2) and (4) will be referred to as a second content ratio. The second content ratio corresponds to the percentage of the number M₂ of repeating units (2) with respect to the sum of the number M₂ of repeating units (2) and the number M₄ of repeating units (4) included in the polyarylate resin (PA) (i.e., 100×M₂/(M₂+M₄)).

The second content ratio is favorably 65% or less, more favorably 60% or less. Further, the second content ratio is favorably more than 30%, more favorably 31% or more, still more favorably 35% or more, still more favorably 40% or more, particularly favorably 55% or more.

In order to improve the wear resistance and fogging resistance of the photoreceptor, the second content ratio is favorably 35% or more and 65% or less, more favorably 55% or more and 65% or less.

As described above, the third content ratio is more than 0% and less than 50%. The third content ratio corresponds to the percentage of the number M₃ of repeating units (3) with respect to the sum of the number M₁ of repeating units (1) and the number M₃ of repeating units (3) included in the polyarylate resin (PA) (i.e., 100×M₃/(M₁+M₃)).

By setting the third content ratio to less than 50%, the solubility of the polyarylate resin (PA) in a solvent is improved and the photosensitive layer can be formed favorably. By setting the third content ratio to more than 0, i.e., not to 0%, it is possible to improve the wear resistance and fogging resistance of the photoreceptor. The third content ratio is favorably 1% or more, more favorably 10% or more, still more favorably 20% or more. Further, the third content ratio is favorably 49% or less, more favorably 45% or less, still more favorably 40% or less.

In order to improve the wear resistance and fogging resistance of the photoreceptor, the third content ratio is favorably 20% or more and less than 50%, more favorably 20% or more and 40% or less.

As described above, the fourth content ratio is 35% or more and less than 70%. The fourth content ratio corresponds to the percentage of the number M₄ of the repeating unit (4) with respect to the sum of the number M₂ of repeating units (2) and the number M₄ of repeating units (4) included in the polyarylate resin (PA) (i.e., 100×M₄/(M₂+M₄)).

By setting the fourth content ratio to 35% or more, the wear resistance and fogging resistance of the photoreceptor are improved. Further, by setting the fourth content ratio to 35% or more, the solubility of the polyarylate resin (PA) in a solvent is improved and the photosensitive layer can be formed favorably. Meanwhile, by setting the fourth content ratio to less than 70%, the wear resistance and fogging resistance of the photoreceptor are improved. The fourth content ratio is favorably 40% or more. Further, the fourth content ratio is favorably 69% or less, more favorably 65% or less, still more favorably 60% or less, still more favorably 50% or less.

In order to improve the wear resistance and fogging resistance of the photoreceptor, the fourth content ratio is favorably 35% or more and less than 70%, more favorably 35% or more and 65% or less.

Each of the first content ratio, the second content ratio, the third content ratio, and the fourth content ratio can be calculated from the ratio of the peak characteristic of each repeating unit in the 1H-NMR spectrum of the polyarylate resin (PA) measured using a proton nuclear magnetic resonance spectrometer.

In order to improve the solubility in a solvent and improve the wear resistance and fogging resistance of the photoreceptor, it is favorable that the first content ratio is a value different from both the second content ratio and the fourth content ratio. For the same reason, it is favorable that the third content ratio is a value different from both the second content ratio and the fourth content ratio.

In order to improve the wear resistance and fogging resistance of the photoreceptor, it is favorable that in the formula (1), R¹ and R² each represent a methyl group and Z represents the divalent group represented by the formula (Z1).

In order to improve the wear resistance and fogging resistance of the photoreceptor, it is favorable that in the formula (1), R¹ and R² each represent a methyl group, Z represents the divalent group represented by the formula (Z1), and the fourth content ratio is 35% or more and 65% or less.

In order to improve the wear resistance and fogging resistance of the photoreceptor, it is favorable that in the formula (1), R¹ and R² each represent a methyl group, Z represents the divalent group represented by the formula (Z1), and the third content ratio is 20% or more and 40% or less.

In order to improve the wear resistance and fogging resistance of the photoreceptor, it is favorable that in the formula (1), R¹ and R² each represent a hydrogen atom, Z represents the divalent group represented by the formula (Z2), and the fourth content ratio is 35% or more and 50% or less.

The polyarylate resin (PA) may have a terminal group. Examples of the terminal group of the polyarylate resin (PA) include terminal groups represented by the following formulae (T-1) and (T-2). As the terminal group represented by the formula (T-1), a terminal group represented by the following formula (T-DMP) (hereinafter, referred to as a terminal group (T-DMP) in some cases) is favorable. As the terminal group represented by the formula (T-2), a terminal group represented by the following formula (T-PFH) (hereinafter, referred to as a terminal group (T-PFH) in some cases) is favorable. That is, it is favorable that the polyarylate resin (PA) further has the terminal group represented by the formula (T-DMP) or the terminal group represented by the formula (T-PFH).

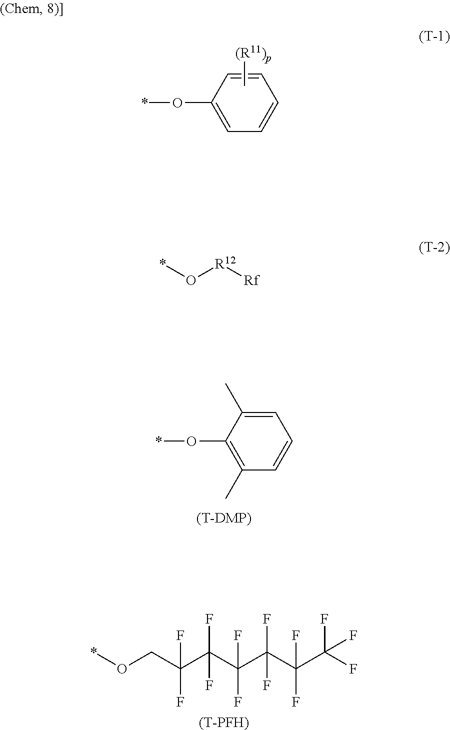

In the formula (T-1), R¹¹ represents an alkyl group having 1 to 6 carbon atoms or a halogen atom, and p represents an integer of 0 or more and 5 or less. R” represents favorably an alkyl group having 1 to 6 carbon atoms, more favorably an alkyl group having 1 to 3 carbon atoms, still more favorably a methyl group. p represents favorably an integer of 1 or more and 3 or less, more favorably 2.

In the formula (T-2), R¹² represents an alkanediyl group having 1 to 6 carbon atoms, and Rf represents a perfluoroalkyl group having 1 to 10 carbon atoms. R¹² represents favorably an alkanediyl group having 1 to 3 carbon atoms, more favorably a methylene group. Rf represents a perfluoroalkyl group having 3 to 10 carbon atoms, more favorably a perfluoroalkyl group having 5 to 7 carbon atoms, and still more favorably a perfluoroalkyl group having 6 carbon atoms.

The perfluoroalkyl group having 1 to 10 carbon atoms, the perfluoroalkyl group having 3 to 10 carbon atoms, the perfluoroalkyl group having 5 to 7 carbon atoms, and the perfluoroalkyl group having 6 carbon atoms are each linear or branched-chain and unsubstituted, unless otherwise specified. Examples of the perfluoroalkyl group having 1 to 10 carbon atoms include a trifluoromethyl group, a perfluoroethyl group, a perfluoro-n-propyl group, a perfluoroisopropyl group, a perfluoro-n-butyl group, a perfluoro-sec-butyl group, a perfluoro-tert-butyl group, a perfluoro-n-pentyl group, a perfluoro-1-methylbutyl group, a perfluoro-2-methylbutyl group, a perfluoro-3-methylbutyl group, a perfluoro-1-ethylpropyl group, a perfluoro-2-ethylpropyl group, a perfluoro-1,1-dimethylpropyl group, a perfluoro-1,2-dimethylpropyl group, a perfluoro-2,2-dimethylpropyl group, a perfluoro-n-hexyl group, a perfluoro-1-methylpentyl group, a perfluoro-2-methylpentyl group, a perfluoro-3-methylpentyl group, a perfluoro-4-methylpentyl group, a perfluoro-1,1-dimethylbutyl group, a perfluoro-1,2-dimethylbutyl group, a perfluoro-1,3-dimethylbutyl group, a perfluoro-2,2-dimethylbutyl group, a perfluoro-2,3-dimethylbutyl group, a perfluoro-3,3-dimethylbutyl group, a perfluoro-1,1,2-trimethylpropyl group, a perfluoro-1,2,2-trimethylpropyl group, a perfluoro-1-ethylbutyl group, a perfluoro-2-ethylbutyl group, a perfluoro-3-ethylbutyl group, linear and branched-chain perfluoroheptyl groups, linear and branched-chain perfluorooctyl groups, linear and branched-chain perfluorononyl groups, and linear and branched-chain perfluorodecyl groups. Examples of the perfluoroalkyl group having 3 to 10 carbon atoms, the perfluoroalkyl group having 5 to 7 carbon atoms, and the perfluoroalkyl group having 6 carbon atoms are groups having the corresponding number of carbon atoms, of the groups mentioned as the examples of the perfluoroalkyl group having 1 to 10 carbon atoms.

In the formulae (T-1), (T-2), (T-DMP), and (T-PFH), * represents atomic bonding. The atomic bonding represented by * in the formulae (T-1), (T-2), (T-DMP), and (T-PFH) is bonded to a repeating unit derived from dicarboxylic acid, which is located at the terminal of the polyarylate resin (PA) (more specifically, the repeating unit (2) or (4)).

In order to further improve the wear resistance and fogging resistance of the photoreceptor, it is favorable that the polyarylate resin (PA) has a terminal group containing a halogen atom. For the same reason, it is more favorable that in the formula (1), R¹ and R² each represent a methyl group, Z represents the divalent group represented by the formula (Z1), and the polyarylate resin (PA) has a terminal group containing a halogen atom.

An example of the terminal group containing a halogen atom is the terminal group (T-1) in the case where R¹¹ in the formula (T-1) represents a halogen atom. Another example of the terminal group containing a halogen atom is the terminal group (T-2).

Suitable examples of the polyarylate resin (PA) include polyarylate resins (PA-1) and (PA-2) shown in Table 1. Each of the polyarylate resins (PA-1) and (PA-2) includes repeating units represented in Table 1 as the repeating units (1) to (4). More suitable examples of the polyarylate resin (PA) include polyarylate resins (PA-a) to (PA-d) shown in Table 2. Each of the polyarylate resins (PA-a) to (PA-d) includes repeating units shown in Table 2 as the repeating units (1) and (4) and has terminal groups shown in Table 2. In Table 1 and Table 2, “Units (1) to (4)” respectively indicate the “repeating units (1) to (4).”

TABLE 1

| Polyarylate resin | Unit(1) | Unit(2) | Unit(3) | Unit(4) |
|---|---|---|---|---|
| PA-1 | 1-1 | 2 | 3 | 4 |
| PA-2 | 1-2 | 2 | 3 | 4 |

TABLE 2

| | | | | | Terminal |
|---|---|---|---|---|---|
| Polyarylate resin | Unit(1) | Unit(2) | Unit(3) | Unit(4) | group |
| PA-a | 1-1 | 2 | 3 | 4 | T-DMP |
| PA-b | 1-2 | 2 | 3 | 4 | T-DMP |
| PA-c | 1-1 | 2 | 3 | 4 | T-PFH |
| PA-d | 1-2 | 2 | 3 | 4 | T-PFH |

In the polyarylate resin (PA), the repeating unit derived from bisphenol (more specifically, the repeating unit (1) or (3)) and the repeating unit derived from dicarboxylic acid (more specifically, the repeating unit (2) or (4)) are adjacent and bonded to each other. That is, the repeating unit (1) may be bonded to the repeating unit (2) or may be bonded to the repeating unit (4). Further, the repeating unit (3) may be bonded to the repeating unit (2) or may be bonded to the repeating unit (4). The number of repeating units derived from bisphenol is substantially the same as the number of repeating units derived from dicarboxylic acid, and a calculation formula “the number of repeating units derived from dicarboxylic acid=the number of repeating units derived from bisphenol+1” is satisfied. The polyarylate resin (PA) may be, for example, a random copolymer, an alternating copolymer, a periodic copolymer, or a block copolymer.

The polyarylate resin (PA) may further include, as a repeating unit, a repeating unit other than the repeating units (1) to (4). However, in order to improve the wear resistance and fogging resistance of the photoreceptor, the content ratio of the repeating units (1) to (4) to the total number of repeating units included in the polyarylate resin (PA) is favorably 80% or more, more favorably 90% or more, still more favorably 95% or more, still more favorably 99% or more, particularly favorably 100%. That is, it is particularly favorable that the polyarylate resin (PA) includes only the repeating units (1) to (4) as repeating units.

The content ratio of the repeating unit (1) to the total number of repeating units derived from bisphenol included in the polyarylate resin (PA) is favorably 50% or more and less than 70%. The content ratio of the repeating unit (3) to the total number of repeating units derived from bisphenol included in the polyarylate resin (PA) is favorably 30% or more and less than 50%.

The content ratio of the repeating unit (2) to the total number of repeating units derived from dicarboxylic acid included in the polyarylate resin (PA) is favorably more than 30% and 65% or less, more favorably 35% or more and 65% or less, still more favorably 40% or more and 60% or less. The content ratio of the repeating unit (4) to the total number of repeating units derived from dicarboxylic acid included in the polyarylate resin (PA) is favorably 35% or more and less than 70%, more favorably 35% or more and 65% or less, still more favorably 40% or more and 60% or less.

The viscosity average molecular weight of the polyarylate resin (PA) is favorably 35,000 or more and 80,000 or less, more favorably 40,000 or more and 80,000 or less. When the viscosity average molecular weight of the polyarylate resin (PA) is 35,000 or more, the wear resistance of the photoreceptor is improved. Meanwhile, when the viscosity average molecular weight of the polyarylate resin (PA) is 80,000 or less, moderate wear resistance and excellent fogging resistance can be achieved. That is, it is conceivable that by making it prone to wear slightly, discharge products and the like on the photoreceptor surface that cause deterioration of electrical characteristics can be removed adequately and the occurrence of fogging can be suppressed. The viscosity average molecular weight of the polyarylate resin (PA) is measured in accordance with JIS (Japanese Industrial Standard) K7252-1:2016.

The ratio of the mass of the binder resin to the mass of the first photosensitive layer is favorably 0.35 or more and 0.50 or less. When the ratio of the mass of the binder resin to the mass of the first photosensitive layer is 0.35 or more and 0.50 or less, the wear resistance and fogging resistance of the photoreceptor are further improved. Further, when the ratio of the mass of the binder resin to the mass of the first photosensitive layer is 0.50 or less, the content ratios of the electron transporting agent and the hole transporting agent in the first photosensitive layer become relatively high, the sensitivity characteristics of the photoreceptor are improved. In the case where the photoreceptor is a single-layer photoreceptor, the ratio of the mass of the binder resin to the mass of the first photosensitive layer is a ratio of the mass of the binder resin (SL) to the mass of the single-layer photosensitive layer that is the first photosensitive layer. In the case where the photoreceptor is a positively-charged stacked photoreceptor, the ratio of the mass of the binder resin to the mass of the first photosensitive layer is a ratio of the mass of the binder resin (CG) to the mass of the charge generating layer that is the first photosensitive layer. In the case where the binder resin (SL) includes the different binder resin described below in addition to the polyarylate resin (PA) and the polyester resin (PE resin), the mass of the binder resin (SL) is the total mass of the polyarylate resin (PA), the polyester resin (PE resin), and the different binder resin. In the case where the binder resin (CG) includes the different binder resin described below in addition to the polyarylate resin (PA) and the polyester resin (PE resin), the mass of the binder resin (CG) is the total mass of the polyarylate resin (PA), the polyester resin (PE resin), and the different binder resin. In the case where the binder resin (SL) includes two or more types of resins, the mass of the binder resin (SL) is the total mass of the two or more types of resins. In the case where the binder resin (CG) includes two or more types of resins, the mass of the binder resin (CG) is the total mass of the two or more types of resins.

Next, a method of producing the polyarylate resin (PA) will be described. Examples of the method of producing the polyarylate resin (PA) include a method of polycondensing bisphenol for forming the repeating unit derived from bisphenol and dicarboxylic acid for forming the repeating unit derived from dicarboxylic acid. For polycondensation, a known synthesis method (e.g., solution polymerization, melt polymerization, or interfacial polymerization) can be adopted.

Examples of bisphenol for forming the repeating unit derived from bisphenol include compounds represented by the following formulae (BP-1) and (BP-3) (hereinafter, respectively referred to as compounds (BP-1) and (BP-3) in some cases). Examples of dicarboxylic acid for forming the repeating unit derived from dicarboxylic acid include compounds represented by the following formulae (DC-2) and (DC-4) (hereinafter, respectively referred to as compounds (DC-2) and (DC-4) in some cases). R¹, R², and Z in the formula (BP-1) are respectively synonymous with R¹, R², and Z in the formula (1).

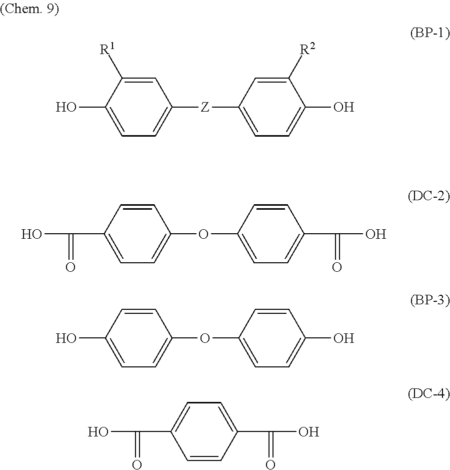

In the production of the polyarylate resin (PA), the first content ratio is adjusted by changing the addition amount (unit: mol) of the compound (BP-1) with respect to the total addition amounts (unit: mol) of the compounds (BP-1) and (BP-3). Further, the second content ratio is adjusted by changing the addition amount (unit: mol) of the compound (DC-2) with respect to the total addition amounts (unit: mol) of the compounds (DC-2) and (DC-4). The third content ratio is adjusted by changing the addition amount (unit: mol) of the compound (BP-3) with respect to the total addition amounts (unit: mol) of the compounds (BP-1) and (BP-3). The fourth content ratio is adjusted by changing the addition amount (unit: mol) of the compound (DC-4) with respect to the total addition amounts (unit: mol) of the compounds (DC-2) and (DC-4).

Bisphenol may be derivatized to an aromatic diacetate for use. Dicarboxylic acid may be derivatized for use. Examples of the derivative of dicarboxylic acid include a dicarboxylic acid dichloride, a dicarboxylic acid dimethyl ester, a dicarboxylic acid diethyl ester, and a dicarboxylic acid anhydride. The dicarboxylic acid dichloride is a compound obtained by substituting each of two “—C(═O)—OH” groups of dicarboxylic acid with a “—C(═O)—Cl” group.

In the polycondensation of bisphenol and dicarboxylic acid, a terminal stopper may be added. Examples of the terminal stopper include 2,6-dimethylphenol and 1H,1H-perfluoro-1-heptanol. Using 2,6-dimethylphenol as a terminal stopper form the terminal group (T-DMP). Using 1H,1H-perfluoro-1-heptanol as a terminal stopper forms the terminal group (T-PFH).

In the polycondensation of bisphenol and dicarboxylic acid, one or both of a base and a catalyst may be added. Examples of the base include sodium hydroxide. Examples of the catalyst include benzyltributylammonium chloride, ammonium chloride, ammonium bromide, a quaternary ammonium salt, triethylamine, and trimethylamine.

### (2) Polyester Resin

The polyester resin (PE) includes a repeating unit (a) and a repeating unit (b). In the polyester resin (PE), the repeating unit (a) and the repeating unit (b) are, for example, alternately arranged. In this case, it is favorable that the amount of the repeating unit (a) and the amount of the repeating unit (b), which are included in the polyester resin (PE), are substantially the same. Specifically, the ratio of the amount of the repeating unit (b) to the amount of the repeating unit (a) included in the polyester resin (PE) (the repeating unit (b)/the repeating unit (a)) is favorably 49/51 or more and 51/49 or less.

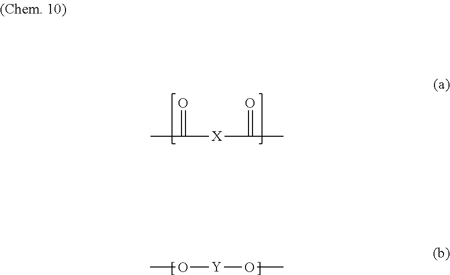

In the general formula (a), X represents a phenylene group that may be substituted with a first substituent group, and the first substituent group is a phenyl group, an alkyl group having 1 to 8 carbon atoms, or an alkoxy group having 1 to 8 carbon atoms.

In the general formula (b), Y represents a divalent aliphatic hydrocarbon group having 1 to 8 carbon atoms, which may be substituted with a second substituent group, and the second substituent group is a phenyl group, or an alkoxy group having 1 to 8 carbon atoms.

Note that the phrase “which may be substituted” includes a case where the hydrogen atom constituting the group immediately following it is unsubstituted and a case where some or all of the hydrogen atoms are substituted with substituent groups.

Note that the amount of each repeating unit in the polyester resin (PE) is not a value obtained from one molecular chain but an average of the values obtained from the polyester resin (PE) (a plurality of molecular chains) included in the photosensitive layer. The ratios of the repeating units (a) and (b) can be calculated from the 1H-NMR spectrum of the polyester resin (PE) measured using a proton nuclear magnetic resonance spectrometer. The same applies also to the amount of each repeating unit in the polyarylate resin (PA).

The content ratio of the polyester resin used in the present disclosure to all binder resins is 0.5 mass % or more and 8.5 mass % or less, favorably 0.5 mass % or more and 7.5 mass % or less. By setting the content ratio to 0.5 mass % or more, favorable charge stability can be achieved and the occurrence of fogging can be suppressed. By setting the content ratio to 8.5 mass % or less, wear resistance can be achieved.

### (Repeating Unit (a))

The repeating unit (a) is represented by the general formula (a). In the general formula (a), examples of the first substituent group in X include an alkyl group having 1 to 4 carbon atoms. The number of first substituent groups in X is favorably 0 or more and 2 or less, more favorably 0. As the phenylene group represented by X, an unsubstituted phenylene group is favorable. As the repeating unit (a), a repeating unit represented by the following chemical formula (a-1) or (a-2) (hereinafter, referred to as a repeating unit (a-1) or (a-2) in some cases) is favorable.

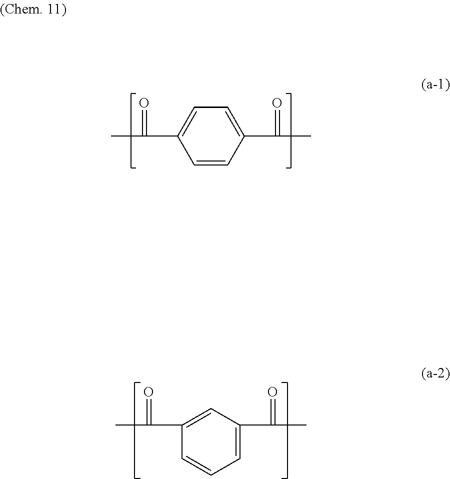

### (Repeating Unit (b))

The repeating unit (b) is represented by the general formula (b). In the general formula (b), examples of the divalent aliphatic hydrocarbon group having 1 to 8 carbon atoms represented by Y include a divalent saturated hydrocarbon group having 1 to 8 carbon atoms, a divalent unsaturated hydrocarbon group having 2 to 8 carbon atoms, a divalent alicyclic hydrocarbon group having 3 to 8 carbon atoms, and a divalent aromatic hydrocarbon group having 6 to 8 carbon atoms. Of these, the divalent saturated hydrocarbon group having 1 to 8 carbon atoms is favorable.

In detail, examples of the divalent aliphatic hydrocarbon group having 1 to 8 carbon atoms include an alkanediyl group having 1 to 8 carbon atoms, an alkenediyl group having 2 to 8 carbon atoms, and an alkynediyl group having 3 to 8 carbon atoms. Of these, the alkanediyl group having 1 to 8 carbon atoms is favorable. Examples of the alkanediyl group having 1 to 8 carbon atoms include groups obtained by removing one hydrogen atom from the groups exemplified above as the alkyl group having 1 to 8 carbon atoms. Specific example of the alkanediyl group having 1 to 8 carbon atoms include an ethylene group, a propanediyl group, a butanediyl group, and a pentanediyl group.

In the general formula (b), examples of the second substituent group in Y include a phenyl group. The number of second substituent groups in Y is favorably 0 or more and 2 or less, more favorably 0.

As the repeating unit (b), a repeating unit represented by the following chemical formula (b-1), (b-2), (b-3), or (b-4) (hereinafter, respectively referred to as repeating units (b-1) to (b-4) in some cases).

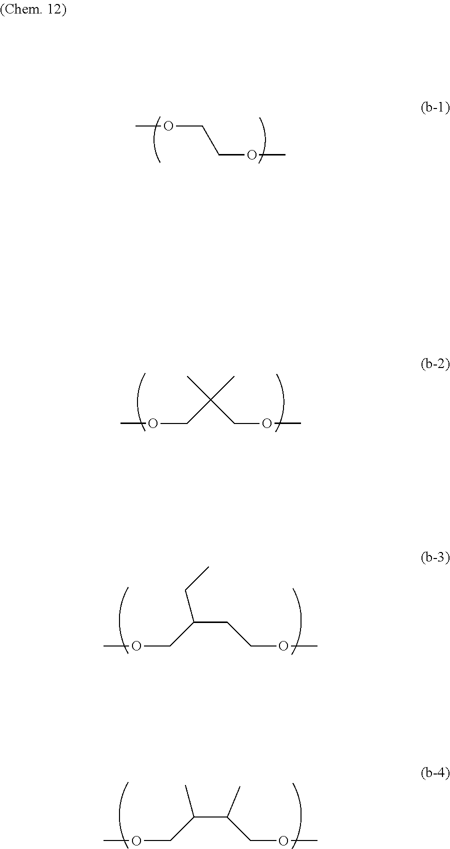

The polyester resin (PE) may further include a different repeating unit other than the repeating units (a) and (b). Examples of the different repeating unit include a repeating unit having a cycloalkane structure. The ratio of the total amount of the repeating units (a) and (b) to the amount of all repeating units included in the polyester resin (PE) is favorably 70% or more, more favorably 95% or more, still more favorably 100%.

As the combination of the repeating units (a) and (b) included in the polyester resin (PE), a first combination of the repeating units (a-1), (a-2), (b-1), and (b-2), a second combination of the repeating units (a-1), (a-2), (b-1), and (b-3), or a third combination of the repeating units (a-1), (a-2), (b-1), and (b-4) is favorable. Of these, the first combination is more favorable.

That is, it is more favorable that the polyester resin (PE) includes the repeating unit (a-1), the repeating unit (a-2), the repeating unit (b-1), and the repeating unit (b-2).

As the polyester resin (PE), a resin represented by the following chemical formula (PE-a), (PE-b), or (PE-c) (hereinafter, respectively referred to as a polyester resin (PE-a), (PE-b), or (PE-c) in some cases) is also favorable.

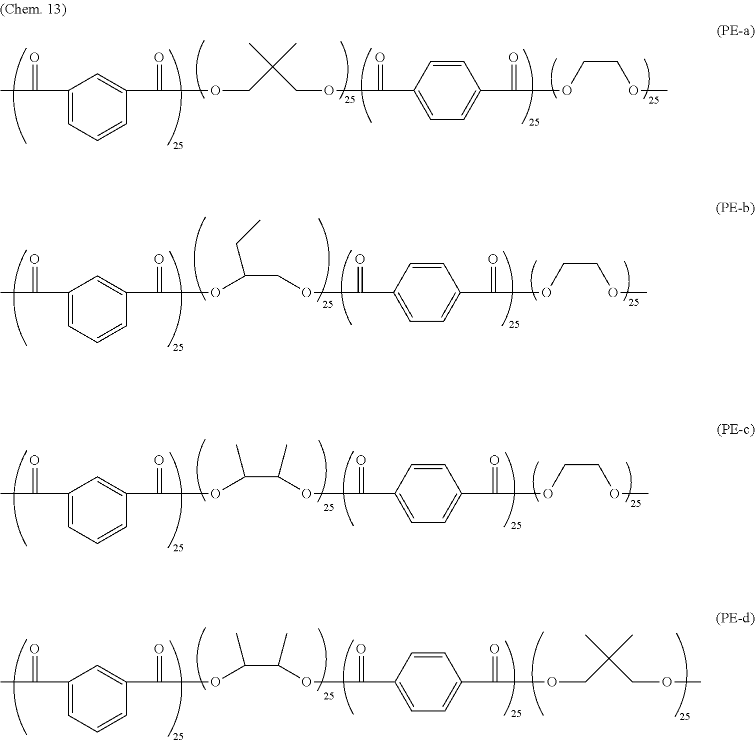

The viscosity average molecular weight of the polyester resin (PE) is favorably 5,000 or more and 100,000 or less, more favorably 15,000 or more and 30,000 or less.

The content ratio of the polyester resin (PE) in the photosensitive layer is 0.3 mass % or more and 7.0 mass % or less, favorably 1.0 mass % or more and 3.0 mass % or less, more favorably 1.0 mass % or more and 1.6 mass % or less. By setting the content ratio of the polyester resin (PE) to 0.3 mass % or more, it is possible to improve the voltage resistance of the photosensitive layer at high temperatures. By setting the content ratio of the polyester resin (PE) to 7.0 mass % or less, it is possible to improve the sensitivity of the photoreceptor.

An example of the method of synthesizing the polyester resin (PE) will be described. First, a diester compound (I) represented by the following general formula (I) and a diol compound (II) represented by the following general formula (II) are prepared. In the following general formulae (I) and (II), X and Y are respectively synonymous with X and Y in the above-mentioned general formulae (1) and (2). In the following general formula (I), RX each independently represent an alkyl group having 1 to 4 carbon atoms. As RX, a methyl group is favorable.

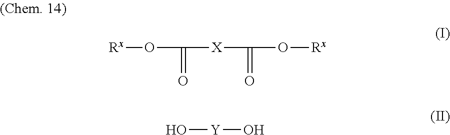

Next, the diester compound (I) and the diol compound (II) are caused to undergo a transesterification reaction, thereby obtaining the polyester resin (PE). In the transesterification reaction, for example, it is favorable to add an organic titanium compound (e.g., tetrabutyl orthotitanate) to the reaction system as a catalyst. The addition amount of the catalyst is, for example, 0.005 parts by mass or more and 0.100 parts by mass or less with respect to the total of 100 parts by mass of the diester compound (I) and the diol compound (II). The reaction conditions of the transesterification reaction can be, for example, a reaction temperature of 200° C. or more and 280° C. or less and a reaction time of 30 minutes or more and 3 hours or less. In the transesterification reaction, it is favorable to remove the generated alcohol compound (e.g., methanol) from the reaction system.

A specific example of the method of synthesizing the polyester resin (PE) by a transesterification reaction will be described below. First, the diester compound (I) (e.g., dimethyl terephthalate), the diol compound (II) (e.g., dimethyl isophthalate and ethylene glycol), and tetrabutyl orthotitanate are added to a reaction vessel equipped with a thermometer, a stirrer, and a distillation condenser. The molar ratio of the diester compound (I) to the diol compound (II) is set to approximately 1:1. The addition amount of tetrabutyl orthotitanate is 0.028 parts by mass with respect to the total of 100 parts by mass of the diester compound (I) and the diol compound (II). The contents of the reaction vessel are gradually heated to 200° C. over 4 hours. This heating initiates a transesterification reaction. Hereinafter, the time point when the temperature of the contents of the reaction vessel reached 200° C. will be referred to as a reaction start time. Note that the alcohol compound generated by the transesterification reaction is removed from the reaction system by distillation. After the start of the transesterification reaction, the pressure in the reaction vessel is reduced over 30 minutes and adjusted to 500 Pa (initial polymerization). After the reduction of pressure, the contents of the reaction vessel are heated to 250° C., then, the pressure in the reaction vessel is further reduced and adjusted to 130 Pa, and then, polymerization is performed for 60 minutes. In this way, the polyester resin (PE) is obtained.

However, the polyester resin (PE) may be synthesized by a different synthesis method other than the above-mentioned transesterification reaction. Examples of the different synthesis method include a dehydration condensation reaction. In the case where the polyester resin (PE) is synthesized by a dehydration condensation reaction, a dicarboxylic acid compound (III) represented by the following general formula (III) or a derivative thereof (e.g., a halide or an anhydride) and the diol compound (II) or a derivative thereof (e.g., diacetate) can be used as raw materials. In the following general formula (III), X is synonymous with X in the above-mentioned general formula (a).

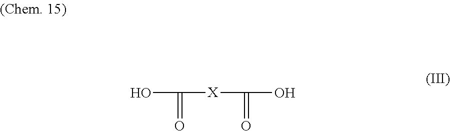

Note that in the synthesis of the polyester resin (PE), as necessary, a different component other than the diester compound (I), the diol compound (II), the dicarboxylic acid compound (III), and the catalyst (e.g., a different monomer or additive) may be further added to the reaction system.

### (Different Binder Resin)

Examples of the different binder resin include a thermoplastic resin, a thermosetting resin, and a photocurable resin. Examples of the thermoplastic resin include a polycarbonate resin, a polyarylate resin other than the polyarylate resin (PA), a styrene-butadiene copolymer, a styrene-acrylonitrile copolymer, a styrene-maleic acid copolymer, an acrylic acid polymer, a styrene-acrylic acid copolymer, a polyethylene resin, an ethylene-vinyl acetate copolymer, a chlorinated polyethylene resin, a polyvinyl chloride resin, a polypropylene resin, an ionomer resin, a vinyl chloride-vinyl acetate copolymer, an alkyd resin, a polyamide resin, a urethane resin, a polysulfone resin, a diallylphthalate resin, a ketone resin, a polyvinylbutyral resin, a polyester resin other than the polyester resin (PE), a polyvinylacetal resin, and a polyether resin. Examples of the thermosetting resin include a silicone resin, an epoxy resin, a phenolic resin, a urea resin, and a melamine resin. Examples of the photocurable resin include an acrylic acid adduct of an epoxy compound, and an acrylic acid adduct of a urethane compound.

### 2-2. Electron Transporting Agent

The electron transporting agent includes a compound represented by the following formula (11), (12), (13), (14), (15), (16), or (17) (hereinafter, respectively referred to as electron transporting agents (11), (12), (13), (14), (15), (16), and (17) in some cases).

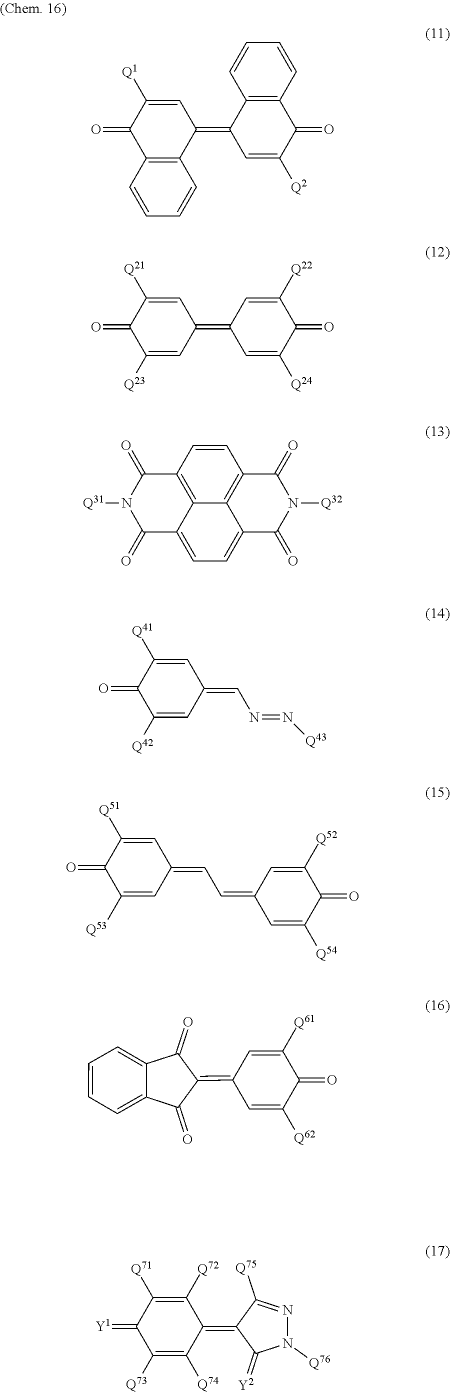

Q¹ and Q² in the formula (11), Q²¹, Q²², Q²³, and Q²⁴ in the formula (12), Q³¹ and Q³² in the formula (13), Q⁴¹, Q⁴², and Q⁴³ in the formula (14), Q⁵¹, Q⁵², Q⁵³, and Q⁵⁴ in the formula (15), Q⁶¹ and Q⁶² in the formula (16), and Q⁷¹, Q⁷², Q⁷³, Q⁷⁴, Q⁷⁵, and Q⁷⁶ in the formula (17) each independently represent a hydrogen atom, a halogen atom, a cyano group, an alkyl group having 1 to 6 carbon atoms, an alkenyl group having 2 to 6 carbon atoms, an alkoxy group having 1 to 6 carbon atoms, or an aryl group having 6 to 14 carbon atoms that may be substituted with at least one substituent group selected from the group consisting of an alkyl group having 1 to 6 carbon atoms and a halogen atom. Y¹ and Y² in the formula (17) each independently represent an oxygen atom or a sulfur atom.

Q¹ and Q² in the formula (11), Q²¹, Q²², Q²³, and Q²⁴ in the formula (12), Q³¹ and Q³² in the formula (13), Q⁴¹, Q⁴², and Q⁴³ in the formula (14), Q⁵¹, Q⁵², Q⁵³, and Q⁵⁴ in the formula (15), Q⁶¹ and Q⁶² in the formula (16), and Q⁷¹, Q⁷², Q⁷³, Q⁷⁴, Q⁷⁵, and Q⁷⁶ in the formula (17) each independently represent favorably a hydrogen atom, an alkyl group having 1 to 6 carbon atoms, or an aryl group having 6 to 14 carbon atoms that may be substituted with at least one substituent group selected from the group consisting of an alkyl group having 1 to 6 carbon atoms and a halogen atom. Y¹ and Y² each represent favorably an oxygen atom.

As the alkyl group having 1 to 6 carbon atoms represented by Q¹ and Q² in the formula (11), Q²¹, Q²², Q²³, and Q²⁴ in the formula (12), Q³¹ and Q³² in the formula (13), Q⁴¹, Q⁴², and Q⁴³ in the formula (14), Q⁵¹, Q⁵², Q⁵³, and Q⁵⁴ in the formula (15), Q⁶¹ and Q⁶² in the formula (16), and Q⁷¹, Q⁷², Q⁷³, Q⁷⁴, Q⁷⁵, and Q⁷⁶ in the formula (17), an alkyl group having 1 to 5 carbon atoms is favorable, a methyl group, an ethyl group, a propyl group, a butyl group, or a pentyl group is more favorable, a methyl group, an isopropyl group, a tert-butyl group, or a 1,1-dimethylpropyl group is particularly favorable.

As the aryl group having 6 to 14 carbon atoms represented by Q¹ and Q² in the formula (11), Q²¹, Q²², Q²³, and Q²⁴ in the formula (12), Q³¹ and Q³² in the formula (13), Q⁴¹, Q⁴², and Q⁴³ in the formula (14), Q⁵¹, Q⁵², Q⁵³, and Q⁵⁴ in the formula (15), Q⁶¹ and Q⁶² in the formula (16), and Q⁷¹, Q⁷², Q⁷³, Q⁷⁴, Q⁷⁵, and Q⁷⁶ in the formula (17), an aryl group having 6 to 10 carbon atoms is favorable and a phenyl group is more favorable. The aryl group having 6 to 14 carbon atoms may be substituted with at least one substituent group selected from the group consisting of an alkyl group having 1 to 6 carbon atoms and a halogen atom. As the alkyl group having 1 to 6 carbon atoms that is a substituent group, an alkyl group having 1 to 3 carbon atoms is favorable and a methyl group or an ethyl group is more favorable. As the halogen atom that is a substituent group, a fluorine atom, a chlorine atom, or a bromine atom is favorable and a chlorine atom is particularly favorable. In the case where the aryl group having 6 to 14 carbon atoms is substituted with a substituent group, the number of substituent groups is favorably 1 or more and 5 or less, more favorably 1 or 2. As the aryl group having 6 to 14 carbon atoms substituted with at least one substituent group selected from the group consisting of an alkyl group having 1 to 6 carbon atoms and a halogen atom, a chlorophenyl group, a dichlorophenyl group, or an ethylmethylphenyl group is favorable and a 4-chlorophenyl group, a 2,5-dichlorophenyl group, or a 2-ethyl-6-methylphenyl group is more favorable.

Suitable examples of the electron transporting agent include compounds represented by the following formulae (E-1) to (E-9) (hereinafter, respectively referred to as electron transporting agents (E-1) to (E-9) in some cases).

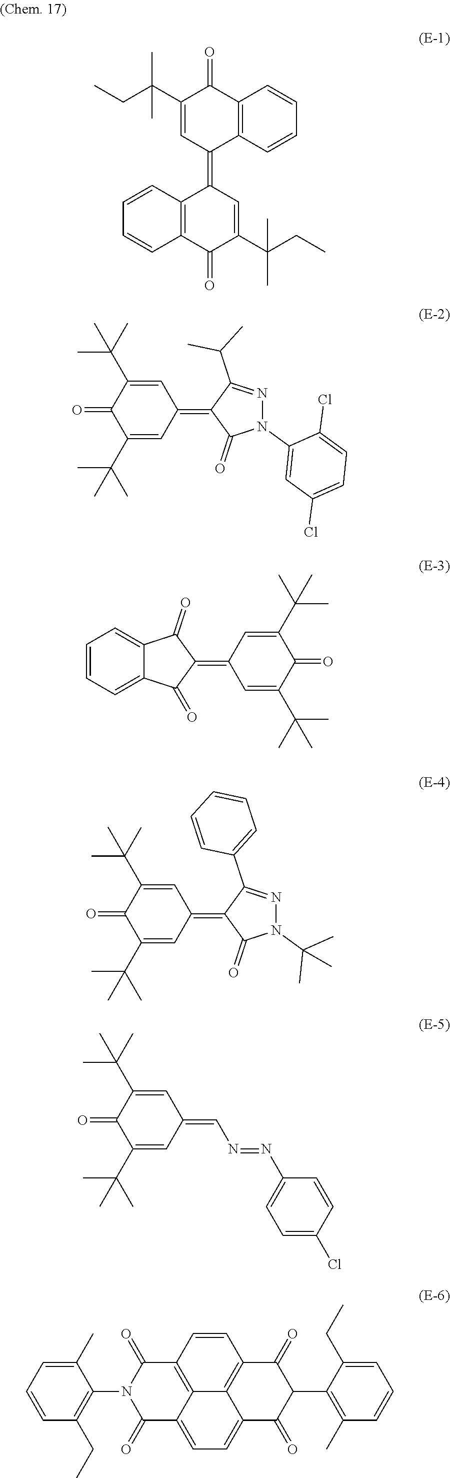

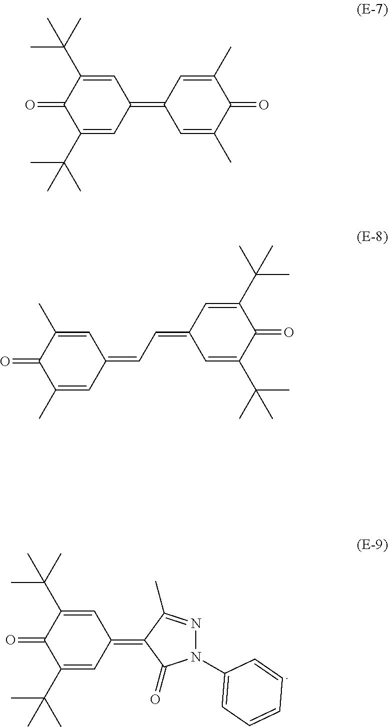 [SMILES: CC1=CC(=C2C=C(C(C)(C)C)C(=O)C(C(C)(C)C)=C2)C=C(C)C1=O ; CC1=CC(=CC=C2C=C(C(C)(C)C)C(=O)C(C(C)(C)C)=C2)C=C(C)C1=O ; CC1=NN(c2ccccc2)C(=O)C1=C1C=C(C(C)(C)C)C(=O)C(C(C)(C)C)=C1]

The content ratio of the mass of the electron transporting agent to the mass of the photosensitive layer is favorably 15 mass % or more and 35 mass % or less, more favorably 15 mass % or more and 33 mass % or less, still more favorably 20 mass % or more and 25 mass % or less.

The photosensitive layer may include, as the electron transporting agent, only one of the electron transporting agents (11), (12), (13), (14), (15), (16), and (17), or two or more of them. The photosensitive layer may include, as the electron transporting agent, only the electron transporting agents (11) to (17), or may further include an electron transporting agent other than the electron transporting agents (11) to (17) (hereinafter, referred to as a different electron transporting agent in some cases). The content ratio of the electron transporting agents (11) to (17) occupied in the electron transporting agent is favorably 80 mass % or more, more favorably 90 mass % or more, still more favorably 95 mass % or more, particularly favorably 100 mass %.

Examples of the different electron transporting agent include a quinone compound, a diimide compound, a hydrazone compound, a malononitrile compound, a thiopyran compound, a trinitrothioxanthone compound, a 3,4,5,7-tetranitro-9-fluorenone compound, a dinitroanthracene compound, a dinitroacridine compound, tetracyanoethylene, 2,4,8-trinitrothioxanthone, dinitrobenzene, dinitroacridine, succinic anhydride, maleic anhydride, and dibromomaleic anhydride. Examples of the quinone compound include a diphenoquinone compound, an azoquinone compound, an anthraquinone compound, a naphthoquinone compound, a nitroanthraquinone compound, and a dinitroanthraquinone compound.

The content of the electron transporting agent with respect to 100 parts by mass of the binder resin is favorably 5 parts by mass or more and 150 parts by mass or less, more favorably 10 parts by mass or more and 100 parts by mass or less, still more favorably 30 parts by mass or more and 70 parts by mass or less.

### 2-3. Hole Transporting Agent

Examples of the hole transporting agent include a triphenylamine derivative, a diamine derivative (e.g., an N,N,N′,N′-tetraphenylbenzidine derivative, an N,N,N′,N′-tetraphenylphenylenediamine derivative, an N,N,N′,N′-tetraphenylnaphthylenediamine derivative, an N,N,N′,N′-tetraphenylphenanthrylenediamine derivative, and a di(aminophenylethenyl)benzene derivative), an oxadiazole compound (e.g., 2,5-di(4-methylaminophenyl)-1,3,4-oxadiazole), a styryl compound (e.g., 9-(4-diethylaminostyryl)anthracene), a carbazole compound (e.g., polyvinylcarbazole), an organic polysilane compound, a pyrazoline compound (e.g., 1-phenyl-3-(p-dimethylaminophenyl)pyrazoline), a hydrazone compound, an indole compound, an oxazole compound, an isooxazole compound, a thiazole compound, a thiadiazole compound, an imidazole compound, a pyrazole compound, and a triazole compound. Each of the single-layer photosensitive layer, the charge generating layer, and the charge transporting layer may include only one type of hole transporting agent, or may include two or more types of hole transporting agents. Further, the hole transporting agent (CG) included in the charge generating layer and the hole transporting agent (CT) included in the charge transporting layer may be the same or different from each other.

Suitable examples of the hole transporting agent include compounds represented by the following formulae (20), (21), (22), (23), and (24) (hereinafter, respectively referred to as hole transporting agents (20), (21), (22), (23), and (24) in some cases). When the photosensitive layer includes the hole transporting agent (20), (21), (22), (23), or (24) in addition to the polyarylate resin (PA), the photosensitive layer can be formed more favorably and the fogging resistance of the photoreceptor is further improved. Since the hole transporting agent (20), (21), (22), (23), or (24) has particularly excellent compatibility with the polyarylate resin (PA), particularly excellent wear resistance and fogging resistance can be achieved.

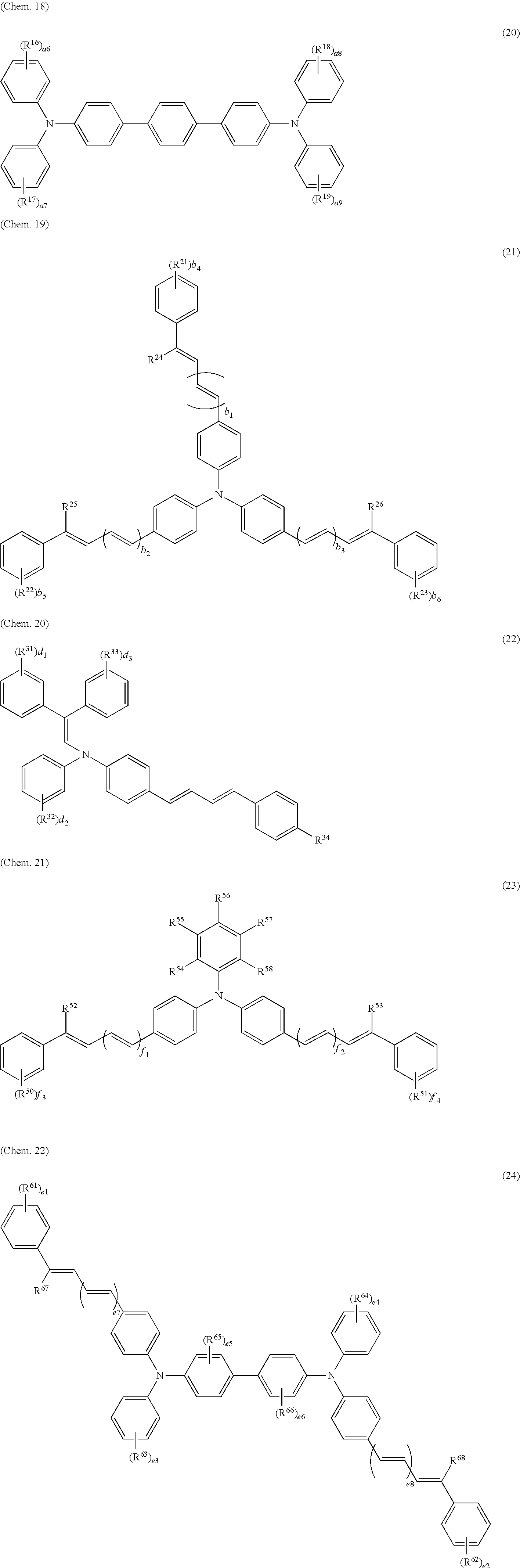

In the formula (20), R¹⁶, R¹⁷, R¹⁸, and R¹⁹ each independently represent an alkyl group having 1 to 6 carbon atoms. a6, a7, a8, and a9 each independently represent an integer of 0 or more and 5 or less.

In the formula (20), in the case where a6 represents an integer of 2 or more and 5 or less, a plurality of R¹⁶ may represent the same group or different groups. In the case where a7 represents an integer of 2 or more and 5 or less, a plurality of R¹⁷ may represent the same group or different groups. In the case where a8 represents an integer of 2 or more and 5 or less, a plurality of R” may represent the same group or different groups. In the case where a9 represents an integer of 2 or more and 5 or less, a plurality of R¹⁹ may represent the same group or different groups.

In the formula (20), R¹⁶, R¹⁷, R¹⁸, and R¹⁹ each independently represent favorably an alkyl group having 1 to 3 carbon atoms, more favorably a methyl group or an ethyl group. a6, a7, a8, and a9 each independently represent an integer of 1 or more and 3 or less, more favorably 1.

In the formula (21), R²¹, R²², and R²³ each independently represent an alkyl group having 1 to 6 carbon atoms. R²⁴, R²⁵, and R²⁶ each independently represent a hydrogen atom, an alkyl group having 1 to 6 carbon atoms, or an aryl group having 6 to 14 carbon atoms. b₁, b₂, and b₃ each independently represent 0 or 1. b₄, b₅, and b₆ each independently represent an integer of 0 or more and 5 or less.

In the formula (21), R²¹, R²², and R²³ each independently represent favorably an alkyl group having 1 to 3 carbon atoms, more favorably a methyl group. R²¹, R²², and R²³ are favorably bonded to an ethenyl group or a butadienyl group at the meta-position of the phenyl group. R²⁴, R²⁵, and R²⁶ each represent favorably a hydrogen atom. b₁, b₂, and b₃ each represent favorably 0 or 1. b₄, b₅, and b₆ each represent favorably 1.

In the formula (22), R³¹, R³², and R³³ each independently represent an alkyl group having 1 to 6 carbon atoms. R³⁴ represents an alkyl group having 1 to 6 carbon atoms or a hydrogen atom. d₁, d₂, and d₃ each independently represent an integer of 0 or more and 5 or less.

In the formula (22), in the case where d₁ represents an integer of 2 or more and 5 or less, a plurality of R³¹ may represent the same group or different groups. In the case where d₂ represents an integer of 2 or more and 5 or less, a plurality of R³² may represent the same group or different groups. In the case where d₃ represents an integer of 2 or more and 5 or less, a plurality of R³³ may represent the same group or different groups.

In the formula (22), R³⁴ favorably represents a hydrogen atom. di, d₂, and d₃ each represent favorably 0.

In the formula (23), R⁵⁰ and R⁵¹ each independently represent an alkyl group having 1 to 6 carbon atoms, an alkoxy group having 1 to 6 carbon atoms, or a phenyl group. R⁵², R⁵³, R⁵⁴, R⁵⁵, R⁵⁶, R⁵⁷, and R⁵⁸ each independently represent a hydrogen atom, an alkyl group having 1 to 6 carbon atoms, an alkoxy group having 1 to 6 carbon atoms, or a phenyl group that may be substituted with an alkyl group having 1 to 6 carbon atoms. f₁ and f₂ each independently represent an integer of 0 or more and 2 or less. f₃ and f₄ each independently represent an integer of 0 or more and 5 or less.

In the formula (23), in the case where f₃ represents an integer of 2 or more and 5 or less, a plurality of R⁵⁰ may represent the same group or different groups. In the case where f₄ represents an integer of 2 or more and 5 or less, a plurality of R⁵¹ may represent the same group or different groups.

In the formula (23), R⁵⁰ and R⁵¹ each independently represent favorably an alkyl group having 1 to 6 carbon atoms. R⁵² and R⁵³ each represent favorably a hydrogen atom or a phenyl group that may be substituted with an alkyl group having 1 to 6 carbon atoms. R⁵⁴ to R⁵⁸ each independently represent favorably a hydrogen atom, an alkyl group having 1 to 6 carbon atoms, or an alkoxy group having 1 to 6 carbon atoms. f₁ and f₂ each represent favorably 0, 1, or 2. f₃ and f₄ each independently represent favorably 0 or 1.

In the formula (23), as the alkyl group having 1 to 6 carbon atoms represented by R⁵⁰ and R⁵¹, an alkyl group having 1 to 3 carbon atoms is favorable and a methyl group is more favorable. As the phenyl group that may be substituted with an alkyl group having 1 to 6 carbon atoms represented by R⁵² and R⁵³, a phenyl group or a phenyl group substituted with an alkyl group having 1 to 3 carbon atoms is favorable. As the phenyl group substituted with an alkyl group having 1 to 3 carbon atoms, a methylphenyl group is favorable and a 4-methylphenyl group is more favorable. As the alkyl group having 1 to 6 carbon atoms represented by R⁵⁴ to R⁵⁸, an alkyl group having 1 to 4 carbon atoms is favorable and a methyl group, an ethyl group, or an n-butyl group is more favorable. As the alkoxy group having 1 to 6 carbon atoms represented by R⁵⁴ to R⁵⁸, an alkoxy group having 1 to 3 carbon atoms is favorable and an ethoxy group is more favorable.

In the formula (24), R⁶¹, R⁶², R⁶³, R⁶⁴, R⁶⁵, and R⁶⁶ each independently represent an alkyl group having 1 to 8 carbon atoms or a phenyl group. R⁶⁷ and R⁶⁸ each independently represent a hydrogen atom, an alkyl group having 1 to 8 carbon atoms, or a phenyl group. e1, e2, e3, and e4 each independently represent an integer of 0 or more and 5 or less. e5 and e6 each independently represent an integer of 0 or more and 4 or less. e7 and e8 each independently represent 0 or 1.

In the formula (24), in the case where e1 represents an integer of 2 or more and 5 or less, a plurality of R⁶¹ may represent the same group or different groups. In the case where e2 represents an integer of 2 or more and 5 or less, a plurality of R⁶² may represent the same group or different groups. In the case where e3 represents an integer of 2 or more and 5 or less, a plurality of R⁶³ may represent the same group or different groups. In the case where e4 represents an integer of 2 or more and 5 or less, a plurality of R⁶⁴ may represent the same group or different groups. In the case where e5 represents an integer of 2 or more and 4 or less, a plurality of R⁶⁵ may represent the same group or different groups. In the case where e6 represents an integer of 2 or more and 4 or less, a plurality of R⁶⁶ may represent the same group or different groups.

In the formula (24), R⁶¹ to R⁶⁶ each independently represent favorably an alkyl group having 1 to 8 carbon atoms, more favorably an alkyl group having 1 to 3 carbon atoms, still more favorably a methyl group or an ethyl group. R⁶⁷ and R⁶⁸ favorably represent a hydrogen atom. e1, e2, e3, and e4 each independently represent favorably an integer of 0 or more and 2 or less. e5 and e6 each represent favorably 0.

The hole transporting agent particularly favorably includes a compound represented by the following formula (H-1), (H-2), (H-3), (H-4), (H-5), (H-6), (H-7), (H-8), (H-9), or (H-10) (hereinafter, referred to as hole transporting agents (H-1) to (H-10) in some cases) as a suitable example.

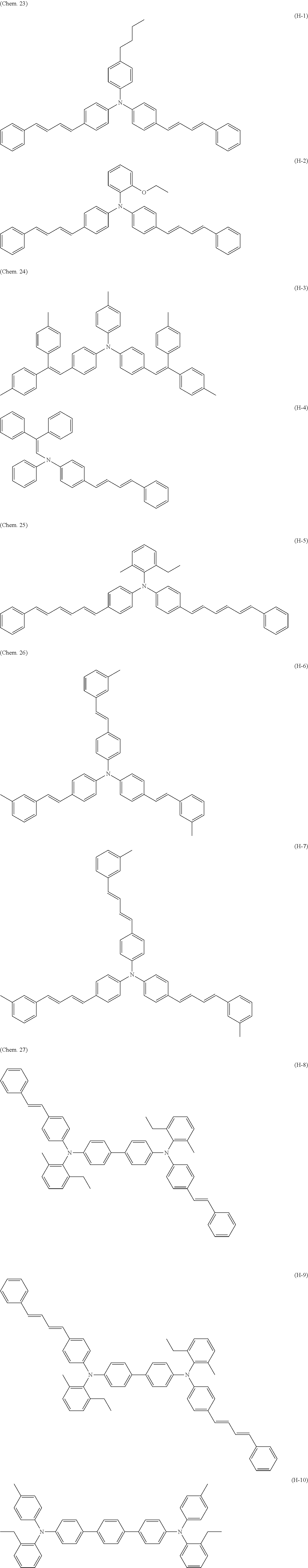

The content of the hole transporting agent (SL) with respect to 100 parts by mass of the binder resin (SL), the content of the hole transporting agent (CG) with respect to 100 parts by mass of the binder resin (CG), and the content of the hole transporting agent (CT) with respect to 100 parts by mass of the binder resin (CT) are each favorably 10 parts by mass or more and 200 parts by mass or less, more favorably 50 parts by mass or more and 150 parts by mass or less, still more favorably 70 parts by mass or more and 130 parts by mass or less.

### 2-4. Charge Generating Agent

Examples of the charge generating agent include a phthalocyanine pigment, a perylene pigment, a bisazo pigment, a trisazo pigment, a dithioketopyrrolopyrrole pigment, a metal-free naphthalocyanine pigment, a metal naphthalocyanine pigment, a squaraine pigment, an indigo pigment, an azulenium pigment, a cyanine pigment, a powder of an inorganic photoconductive material (e.g., selenium, selenium-tellurium, selenium-arsenic, cadmium sulfide, and amorphous silicon), a pyrylium pigment, an anthanthron pigment, a triphenylmethane pigment, a threne pigment, a toluidine pigment, a pyrazoline pigment, and a quinacridone pigment. The photosensitive layer may include only one type of charge generating agent, or may include two or more types of charge generating agents.

The phthalocyanine pigment has a phthalocyanine structure. Examples of the phthalocyanine pigment include metal phthalocyanine and metal-free phthalocyanine. Examples of the metal phthalocyanine include titanyl phthalocyanine, hydroxygallium phthalocyanine, and chlorogallium phthalocyanine. As the metal phthalocyanine, titanyl phthalocyanine is favorable. The titanyl phthalocyanine is represented by the following formula (CG-1). The metal-free phthalocyanine is represented by the following formula (CG-2).

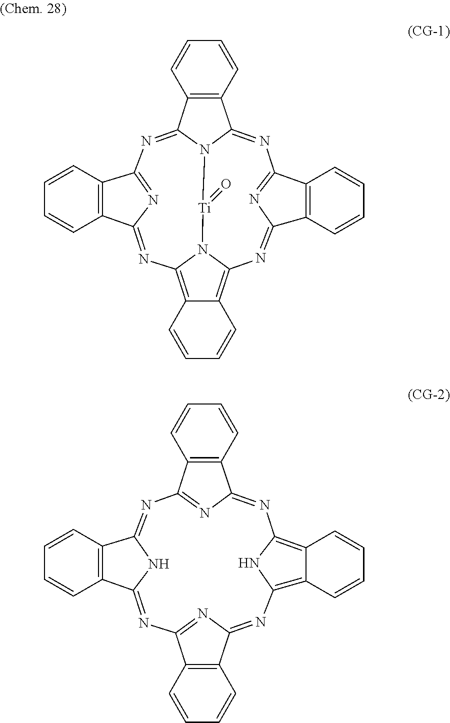

The phthalocyanine pigment may be crystalline or non-crystalline. Examples of the crystal of the metal-free phthalocyanine include an X-type crystal of the metal-free phthalocyanine (hereinafter, referred to as an X-type metal-free phthalocyanine in some cases). Examples of the crystal of the titanyl phthalocyanine include α-type, β-type, and Y-type crystals of the titanyl phthalocyanine (hereinafter, respectively referred to as α-type, β-type, and Y-type titanyl phthalocyanines in some cases).

For example, for a digital optical image forming apparatus (e.g., a laser beam printer or a facsimile machine using a light source such as semiconductor laser light), it is favorable to use a photoreceptor having sensitivity in a wavelength region of 700 nm or more. As the charge generating agent, a phthalocyanine pigment is favorable, metal-free phthalocyanine or titanyl phthalocyanine is more favorable, and an X-type metal-free phthalocyanine or Y-type titanyl phthalocyanine is particularly favorable because they have a high quantum yield in the wavelength region of 700 nm or more.

The Y-type titanyl phthalocyanine has a main peak at, for example, 27.2° of the Bragg angle (2θ±0.2°) in the CuKα characteristic X-ray diffraction spectrum. The main peak in the CuKα characteristic X-ray diffraction spectrum is a peak having the first or second highest intensity in the range of the Bragg angle (2θ±0.2°) of 3° or more and 400 or less. The Y-type titanyl phthalocyanine does not have a peak at 26.2° in the CuKα characteristic X-ray diffraction spectrum.

The CuKα characteristic X-ray diffraction spectrum can be measured by, for example, the following method. First, a sample holder of an X-ray diffractometer (e.g., “RINT (registered trademark) 1100” manufactured by Rigaku Holdings Corporation and its Global Subsidiaries) is filled with a sample (titanyl phthalocyanine) to measure the X-ray diffraction spectrum under the conditions of an X-ray tube Cu, a tube voltage of 40 kV, a tube current of 30 mA, and a wavelength of CuKα characteristic X-rays of 1.542 Å. The measurement range (2θ) is, for example, 3° or more and 400 or less (start angle of 3°, stop angle of 40°), and the scanning speed is, for example, 10°/min. The main peak is determined from the obtained X-ray diffraction spectrum, and the Bragg angle of the main peak is read.

The content of the charge generating agent is favorably 0.1 parts by mass or more and 50 parts by mass or less, more favorably 0.5 parts by mass or more and 5 parts by mass or less, with respect to 100 parts by mass of the binder resin.

### 2-5. Additive

Examples of the additive include an ultraviolet absorber, an antioxidant, a radical scavenger, a singlet quencher, a softener, a surface modifier, a bulking agent, a thickener, a dispersion stabilizer, a wax, a toner, a surfactant, a plasticizer, a sensitizer, an electron acceptor compound, and a leveling agent.

### 2-6. Scratch Resistance Depth

The scratch resistance depth of the first photosensitive layer is more favorably 0.50 μm or less. The scratch resistance depth of the first photosensitive layer is a value indicating the hardness of the first photosensitive layer. The scratch resistance depth of the first photosensitive layer being 0.50 μm or less refers to that the first photosensitive layer has a hardness such that a scratch having a scratch resistance depth of 0.50 μm or less is formed on the surface of the first photosensitive layer by the method of measuring a scratch resistance depth described below. When the scratch resistance depth of the first photosensitive layer is 0.50 μm or less, fines scratches are less likely to occur on the surface of the photoreceptor. As a result, the toner is less likely to penetrate into the scratches that have occurred on the surface of the photoreceptor, making it less likely for fogging to occur on the formed image. Further, when the scratch resistance depth of the first photosensitive layer is 0.50 μm or less, the wear resistance of the photoreceptor is improved. In order to improve fogging resistance, the scratch resistance depth of the first photosensitive layer is favorably 0.00 μm or more and 0.50 μm or less.

The scratch resistance depth of the first photosensitive layer is measured by the following method. The scratch resistance depth of the first photosensitive layer is measured by performing a first step, a second step, a third step, and a fourth step using a scratching device specified in JIS (Japanese Industrial Standard) K5600-5-5. The scratching device includes a fixing base and a scratching needle. The scratching needle has a hemispherical sapphire tip having a diameter of 1 mm. In the first step, the photoreceptor is fixed onto the upper surface of the fixing base such that the longitudinal direction of the photoreceptor is parallel to the longitudinal direction of the fixing base. In the second step, the scratching needle is caused to vertically abut on the surface of the first photosensitive layer. In the third step, with the scratching needle vertically abutting on the surface of the first photosensitive layer, the fixing base and the photoreceptor fixed onto the upper surface of the fixing base are caused to move 30 mm at a speed of 30 mm/min in the longitudinal direction of the fixing base while applying a load of 10 g from the scratching needle to the first photosensitive layer, thereby forming a scratch on the surface of the first photosensitive layer by the scratching needle. In the fourth step, the scratch resistance depth that is the maximum depth of the scratch is measured. The overview of the method of measuring a scratch resistance depth has been described above. The method of measuring a scratch resistance depth will be described in detail in Example.

The scratch resistance depth of the first photosensitive layer can be adjusted by, for example, changing the type of binder resin. Further, the scratch resistance depth of the first photosensitive layer can also be changed by, for example, adjusting the ratio of the mass of the binder resin to the mass of the first photosensitive layer.

### 2-7. Breaking Strain

The breaking strain of the first photosensitive layer is favorably 7.5% or more and 21.0% or less, more favorably 10.0% or more and 21.0% or less. When the breaking strain of the first photosensitive layer is 7.5% or more, the fogging resistance and wear resistance of the photoreceptor are improved. When the breaking strain of the first photosensitive layer is 21.0% or less, the fogging resistance of the photoreceptor is improved. The breaking strain of the first photosensitive layer is a value obtained from a stress-strain curve obtained when the first photosensitive layer is pulled at a tensile speed of 5 mm/min using a tensile tester. The breaking strain of the first photosensitive layer is measured by, for example, the method described in Example described below. The breaking strain is adjusted by, for example, changing the type and viscosity average molecular weight of the binder resin.

### 2-8. Vickers Hardness

The Vickers hardness of the first photosensitive layer is favorably 19.0 HV or more, more favorably 20.0 HV or more. When the Vickers hardness of the first photosensitive layer is 19.0 HV or more, the fogging resistance of the photoreceptor is improved. The upper limit of the Vickers hardness of the first photosensitive layer is not particularly limited but is, for example, 25.0 HV or less. The Vickers hardness of the first photosensitive layer is measured by a method conforming to JIS (Japanese Industrial Standard) Z2244. The Vickers hardness of the first photosensitive layer is adjusted by, for example, changing the type of binder resin and the type of hole transporting agent.

### 3. Conductive Base

The conductive base is not particularly limited, and at least the surface portion thereof only needs to be formed of a material having conductivity. One example of the conductive base is a conductive base formed of a material having conductivity. Another example of the conductive base is a conductive base covered with a material having conductivity. Examples of the material having conductivity include aluminum, iron, copper, tin, platinum, silver, vanadium, molybdenum, chromium, cadmium, titanium, nickel, palladium, indium, stainless steel, and brass. Of these materials having conductivity, aluminum and an aluminum alloy are favorable because they allows charges to favorably transfer from the photosensitive layer to the conductive base.

The shape of the conductive base is appropriately selected in accordance with the structure of the image forming apparatus. Examples of the shape of the conductive base include a sheet shape and a drum shape. Further, the thickness of the conductive base is appropriately selected in accordance with the shape of the conductive base.

### 4. Intermediate Layer

The intermediate layer (undercoat layer) includes, for example, an inorganic particle and a resin used for an intermediate layer (intermediate layer resin). The presence of the intermediate layer makes the flow of currents generated when the photoreceptor is exposed smooth and makes it possible to suppress an increase in resistance, while maintaining the insulated state to the extent that leakage can be suppressed.

Examples of the inorganic particle include a particle of metal (e.g., aluminum, iron, and copper), a particle of a metal oxide (e.g., titanium oxide, alumina, zirconium oxide, tin oxide, and zinc oxide), and a particle of a non-metal oxide (e.g., silica).

Examples of the intermediate layer resin are the same as the examples of the different binder resin described above. In order to favorably form an intermediate layer and a photosensitive layer, it is favorable that the intermediate layer resin is different from the binder resin included in the photosensitive layer. The intermediate layer may include an additive. Examples of the additive included in the intermediate layer are the same as the examples of the additive included in the photosensitive layer.

### 5. Method of Producing Photoreceptor

As a method of producing a photoreceptor, an example of a method of producing a single-layer photoreceptor and an example of a method of producing a positively-charged stacked photoreceptor will be described.

The method of producing a single-layer photoreceptor includes, for example, a single-layer photosensitive layer forming step. In the single-layer photosensitive layer forming step, a coating liquid for forming a single-layer photosensitive layer (hereinafter, referred to as a coating liquid for a single-layer photosensitive layer in some cases) is prepared. The coating liquid for a single-layer photosensitive layer is applied onto a conductive base. Subsequently, at least part of the solvent included in the applied coating liquid for a single-layer photosensitive layer is removed to form a single-layer photosensitive layer. The coating liquid for a single-layer photosensitive layer includes, for example, a charge generating agent, the binder resin (SL), an electron transporting agent, the hole transporting agent (SL), and a solvent. The coating liquid for a single-layer photosensitive layer is prepared by dissolving or dispersing the charge generating agent, the binder resin (SL), the electron transporting agent, and the hole transporting agent (SL) in the solvent. The coating liquid for a single-layer photosensitive layer may further include an additive as necessary.

The method of producing a positively-charged stacked photoreceptor includes, for example, a charge transporting layer forming step and a charge generating layer forming step.

In the charge transporting layer forming step, a coating liquid for a charge transporting layer is applied onto a conductive base. Subsequently, at least part of the solvent included in the applied coating liquid for a charge transporting layer is removed to form a charge transporting layer. The coating liquid for a charge transporting layer includes the hole transporting agent (CT), the binder resin (CT), and a solvent. The coating liquid for a charge transporting layer can be prepared by dissolving or dispersing the hole transporting agent (CT) and the binder resin (CT) in the solvent. The coating liquid for a charge transporting layer may further include an additive as necessary.

In the charge generating layer forming step, a coating liquid for a charge generating layer is applied onto the charge transporting layer. Subsequently, at least part of the solvent included in the applied coating liquid for a charge generating layer is removed to form a charge generating layer. The coating liquid for a charge generating layer includes, for example, a charge generating agent, the binder resin (CG), an electron transporting agent, the hole transporting agent (CG), and a solvent. The coating liquid for a charge generating layer is prepared by dissolving or dispersing the charge generating agent, the binder resin (CG), the electron transporting agent, and the hole transporting agent (CG) in the solvent. The coating liquid for a charge generating layer may further include an additive as necessary.

The solvent included in the coating liquid for a single-layer photosensitive layer, the coating liquid for a charge generating layer, and the coating liquid for a charge transporting layer (hereinafter, collectively referred to as a coating liquid in some cases) is not particularly limited as long as it is capable of dissolving or dispersing each component included in the coating liquid. Examples of the solvent include an alcohol (more specifically, methanol, ethanol, isopropanol, butanol, and the like), an aliphatic hydrocarbon (more specifically, n-hexane, octane, cyclohexane, and the like), an aromatic hydrocarbon (more specifically, benzene, toluene, xylene, and the like), a halogenated hydrocarbon (more specifically, dichloromethane, dichloroethane, carbon tetrachloride, chlorobenzene, and the like), an ether (more specifically, dimethyl ether, diethyl ether, tetrahydrofuran, ethylene glycol dimethyl ether, diethylene glycol dimethyl ether, and the like), a ketone (more specifically, acetone, methyl ethyl ketone, cyclohexanone, and the like), an ester (more specifically, ethyl acetate, methyl acetate, and the like), dimethylformaldehyde, dimethylformamide, and dimethylsulfoxide.

The solvent included in the coating liquid for a charge transporting layer is favorably different from the solvent included in the coating liquid for a charge generating layer. This is because it is favorable that when applying the coating liquid for a charge generating layer onto the charge transporting layer, the charge transporting layer is not dissolved in the coating liquid for a charge generating layer.

The coating liquid is prepared by mixing the respective components and dispersing them in the solvent. For the mixing or dispersion, for example, a bead mill, a roll mill, a ball mill, an attrition mil, a paint shaker, or an ultrasonic disperser can be used.

The method of applying the coating liquid is not particularly limited as long as the coating liquid can be uniformly applied. Examples of the application method include a dip coating method, a spray coating method, a spin coating method, and a bar coating method.

Examples of the method of removing at least part of the solvent included in the coating liquid include heating, reduction of pressure, and a combination of heating and reduction of pressure. More specifically, a method of performing heat treatment (hot air drying) using a high-temperature dryer or a reduced-pressure dryer may be used. The temperature of the heat treatment is, for example, 40° C. or more and 150° C. or less. The time for the heat treatment is, for example, 3 minutes or more and 120 minutes or less.

Note that the method of producing a photoreceptor may further include one or both of a step of forming an intermediate layer and a step of forming a protective layer, as necessary. As the step of forming an intermediate layer and the step of forming a protective layer, known methods can be appropriately selected.

### Second Embodiment: Image Forming Apparatus

An image forming apparatus according to a second embodiment of the present disclosure will be described. A tandem type image forming apparatus will be described below as an example with reference to FIG. 7. FIG. 7 is a cross-sectional view showing an example of the image forming apparatus.

The image forming apparatus 100 shown in FIG. 7 includes image forming units 40a, 40b, 40c, and 40d, a transfer belt 50, and a fixing device 54. Hereinafter, the image forming units 40a, 40b, 40c, and 40d will be referred to as an image forming unit 40 in the case where there is no need to distinguish between them.

The image forming unit 40 includes an image carrier 30, a charging device 42, an exposure device 44, a development device 46, and a transfer device 48. The image carrier 30 is the photoreceptor according to the first embodiment (specifically, the single-layer photoreceptor 1 and the positively-charged stacked photoreceptor 10).

As described above, according to the photoreceptor according to the first embodiment, it is possible to improve fogging resistance. Therefore, by including the photoreceptor according to the first embodiment as the image carrier 30, the image forming apparatus 100 is capable of forming an image with less fogging on a recording medium P.

The image carrier 30 is provided at the center position of the image forming unit 40. The image carrier 30 is provided to be rotatable in a direction indicated by an arrow (counterclockwise direction in FIG. 7). The charging device 42, the exposure device 44, the development device 46, and the transfer device 48 are provided around the image carrier 30 in the stated order from the upstream side of the rotation direction of the image carrier 30.

Toner images of a plurality of colors (e.g., four colors, i.e., black, cyan, magenta, and yellow) are superimposed on the recording medium P on the transfer belt 50 in order by the respective image forming units 40a to 40d.

The charging device 42 charges the surface of the image carrier 30 (e.g., a circumferential surface) to a positive polarity. In both cases where the image carrier 30 is the single-layer photoreceptor 1 and where the image carrier 30 is the positively-charged stacked photoreceptor 10, the surface of the image carrier 30 is charged to a positive polarity. The charging device 42 is, for example, a charging roller.

The exposure device 44 applies exposure light to the charged surface of the image carrier 30. That is, the exposure device 44 exposes the charged surface of the image carrier 30. This forms an electrostatic latent image on the surface of the image carrier 30. The electrostatic latent image is formed on the basis of the image data input to the image forming apparatus 100.

The development device 46 supplies a toner to the surface of the image carrier 30 to develop the electrostatic latent image as a toner image. The development device 46 (e.g., the surface of the development device 46, more specifically, the circumferential surface of the development device 46) is in contact with the surface of the image carrier 30. That is, the image forming apparatus 100 adopts a contact development method. The development device 46 is, for example, a development roller. In the case where the developer is a one-component developer, the development device 46 supplies the toner that is a one-component developer to the electrostatic latent image formed on the image carrier 30. In the case where the developer is a two-component developer, the development device 46 supplies the toner, of the toner and the carrier included in the two-component developer, to the electrostatic latent image formed on the image carrier 30. In this way, the image carrier 30 carries the toner image.

The transfer belt 50 conveys the recording medium P between the image carrier 30 and the transfer device 48. The transfer belt 50 is an endless belt. The transfer belt 50 is provided to be rotatable in a direction indicated by an arrow (clockwise direction in FIG. 7).

The transfer device 48 transfers the toner image developed by the development device 46 from the surface of the image carrier 30 to a to-be-transferred body. The to-be-transferred body is the recording medium P. When the toner image is transferred, the image carrier 30 is in contact with the recording medium P. That is, the image forming apparatus 100 adopts a direct transfer method. The transfer device 48 is, for example, a transfer roller.

The recording medium P on which the toner image has been transferred by the transfer device 48 is conveyed to the fixing device 54 by the transfer belt 50. The fixing device 54 is, for example, a heating roller and/or a pressure roller. The unfixed toner image transferred by the transfer device 48 is heated and/or pressurized by the fixing device 54. When the toner image is heated and/or pressurized, the toner image is fixed to the recording medium P. As a result, an image is formed on the recording medium P.

Although an example of the image forming apparatus has been described above, the image forming apparatus is not limited to the image forming apparatus 100 described above. Although the image forming apparatus 100 described above has been a color image forming apparatus, the image forming apparatus may be a monochrome image forming apparatus. In this case, the image forming apparatus only needs to include, for example, one image forming unit. Further, although the image forming apparatus 100 described above has adopted a tandem method, the image forming apparatus may adopt, for example, a rotary method. Although a charging roller has been described as an example of the charging device 42, the charging device may be a charging device other than the charging roller (e.g., a scorotron charger, a charging brush, or a corotron charger). Although the image forming apparatus 100 described above has adopted a contact development method, the image forming apparatus may adopt a non-contact development method. Although the image forming apparatus 100 described above has adopted a direct transfer method, the image forming apparatus may adopt an intermediate transfer method. In the case where the image forming apparatus adopts an intermediate transfer method, the to-be-transferred body corresponds to an intermediate transfer belt. Although the image forming unit 40 described above has included no cleaning member in the image forming apparatus, the image forming unit may further include a cleaning member (e.g., a cleaning blade). Note that although the image forming unit 40 described above has included no static elimination device, the image forming unit may further include a static elimination device.

### Third Embodiment: Process Cartridge

Next, an example of a process cartridge according to a third embodiment of the present disclosure will be described with continued reference to FIG. 7. The process cartridge corresponds to each of the image forming units 40a to 40d. The process cartridge includes the image carrier 30. The image carrier 30 is the photoreceptor according to the first embodiment. As described above, according to the photoreceptor according to the first embodiment, it is possible to improve wear resistance and fogging resistance. Therefore, by including the photoreceptor according to the first embodiment as the image carrier 30, the process cartridge is capable of forming an image with less fogging on the recording medium P. The process cartridge further includes at least one selected from the group consisting of the charging device 42, the exposure device 44, the development device 46, and the transfer device 48, in addition to the image carrier 30. The process cartridge may further include a cleaning member (not shown) and a static elimination device (not shown). The process cartridge is designed to be attachable/detachable to/from the image forming apparatus 100. For this reason, the process cartridge is easy to handle, and can be easily and quickly replaced together with the image carrier 30 in the case where the sensitivity characteristics of the image carrier 30 or the like deteriorate. The process cartridge including the photoreceptor according to the first embodiment has been described above with reference to FIG. 7.

The process cartridge according to the third embodiment described above has improved wear resistance and is capable of suppressing the occurrence of fogging in the case where repeated printing is performed under a high-temperature and high-humidity environment, by including the photoreceptor according to the first embodiment as an image carrier.

### Example

The present disclosure will be more specifically described below byway of Examples. Note that the present disclosure is not limited to the scope of Examples.

### <Materials Used in Examples and Comparative Examples>

As materials for producing a single-layer photoreceptor and a stacked photoreceptor, the following charge generating agent, hole transporting agent, electron transporting agent, and binder resin were prepared.

### [Charge Generating Agent]

The charge generating agent (CG-1) described in the first embodiment was prepared. As the charge generating agent (CG-1), Y-type phthalocyanine represented by the chemical formula (CG-1) was used.

### [Hole Transporting Agent]

The hole transporting agents (H-1) to (H-10) described in the first embodiment were prepared.

### [Electron Transporting Agent]

The electron transporting agents (E-1) to (E-9) described in the first embodiment were prepared.

### [Binder Resin]

Polyarylate resins (R-1) to (R-7) to be used in Examples were synthesized by the method described below. Further, as Comparative Examples, resins (R-8) to (R-11) were prepared. The resins (R-8) to (R-11) are respectively resins represented by the following chemical formulae (R-8) to (R-11).

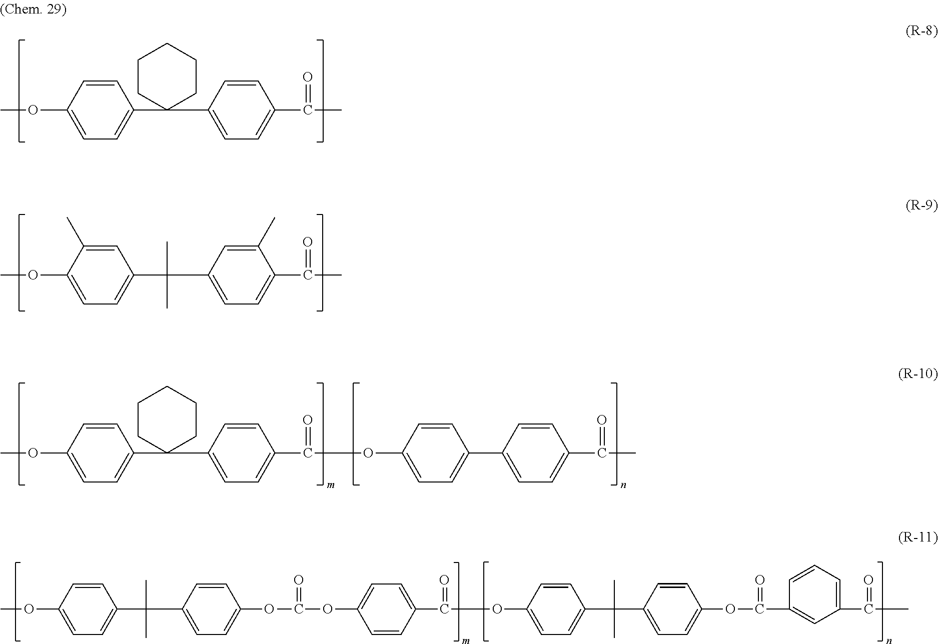

### [Synthesis of Polyarylate Resins (R-1) to (R-7)]

The polyarylate resins (R-1) to (R-7) according to Examples and the polyarylate resins (R-8) to (R-11) according to Comparative Examples were synthesized by the method described below. The compositions of the polyarylate resins (R-1) to (R-7) are shown in the following Table 3. In the chemical formulae (R-10) and (R-11), m and n each represent a molar ratio.

TABLE 3

| | Monomer | | | | | |
|---|---|---|---|---|---|---|
| | | | | Dicarboxylic acid | | |
| | Bisphenol addition rate [%] | | | addition rate [%] | | |
| | BisCZ | BisB | DHPE | DPEC | TPC | |
| Forming | Unit | Unit | Unit | Unit | Unit | Terminal |
| unit | (1-1) | (1-2) | (3) | (2) | (4) | stopper |
| R-1 | 80 | — | 20 | 65 | 35 | DMP |
| R-2 | — | 80 | 20 | 65 | 35 | DMP |
| R-3 | 80 | — | 20 | 50 | 50 | DMP |
| R-4 | 80 | — | 20 | 35 | 65 | DMP |
| R-5 | — | 80 | 20 | 50 | 50 | DMP |
| R-6 | 60 | — | 40 | 65 | 35 | DMP |
| R-7 | 80 | — | 20 | 65 | 35 | PFH |

In Table 3, “BisCZ”, “BisB”, “DHPE”, “DPEC”, and “TPC” that are monomers respectively indicate compounds represented by the following formulae (BisCZ), (BisB), (DHPE), (DPEC), and (TPC) (hereinafter, respectively referred to as compounds (BisCZ), (BisB), (DHPE), (DPEC), and (TPC) in some cases).

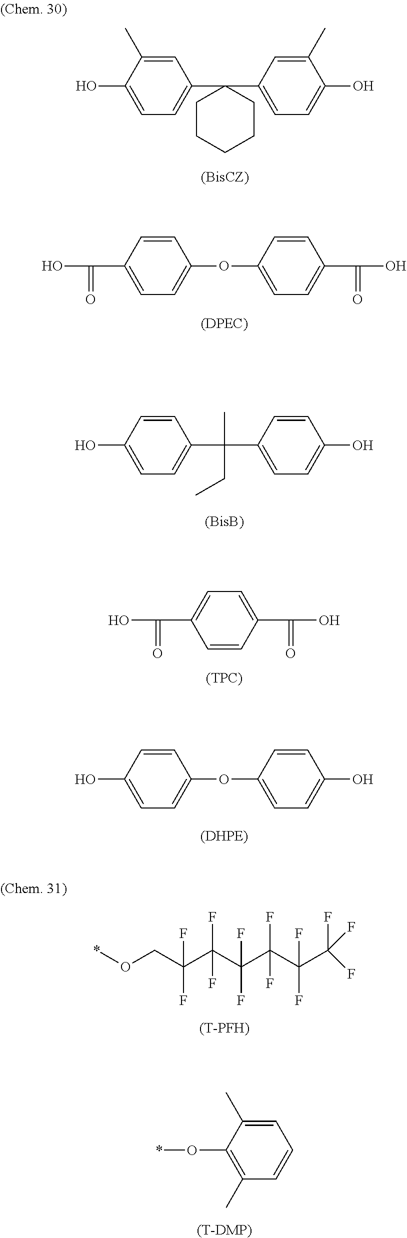

Further, the meanings of the terms used in Table 3 are as follows.
Monomer: monomer used in the synthesis of the polyarylate resin
Forming unit: repeating unit formed from the corresponding monomer
Resin: polyarylate resin
Bisphenol addition rate: percentage (unit: %) of the amount (unit: mol) of the corresponding bisphenol monomer with respect to the total amount (unit: mol) of bisphenol monomers added in the synthesis of the polyarylate resin
Dicarboxylic acid addition rate: percentage (unit: %) of the amount (unit: mol) of the corresponding dicarboxylic acid monomer with respect to the total amount (unit: mol) of dicarboxylic acid monomers added in the synthesis of the polyarylate resin
Molecular weight: viscosity average molecular weight
Unit: repeating unit
Unit (BisCZ): repeating unit derived from the compound (BisCZ)
Unit (BisB): repeating unit derived from the compound (BisB)
Unit (DHPE): repeating unit derived from the compound (DHPE)
Unit (DPEC): repeating unit derived from the compound (DPEC)
Unit (TPC): repeating unit derived from the compound (TPC)
DMP (2,6-dimethylphenol): terminal stopper for synthesizing the polyarylate resin having the terminal group (T-DMP)
PFH (1H,1H-perfluoro-1-heptanol): terminal stopper for synthesizing the polyarylate resin having the terminal group (T-PFH)
-: the corresponding monomer was not used

Unmeasurable: viscosity average molecular weight could not be measured because the polyarylate resin was not dissolved in the solvent for measuring a viscosity molecular weight

### (Synthesis of Polyarylate Resins (R-1-1) to (R-1-14))

A three-neck flask including a thermometer, a three-way cock, and a dropping funnel was used as a reaction vessel. A compound (BisCZ) (32.8 mmol) that is a monomer, a compound (DHPE) (8.2 mmol) that is a monomer, 2,6-dimethylphenol (0.413 mmol) that is a terminal stopper, sodium hydroxide (98 mmol), and benzyltributylammonium chloride (0.384 mmol) were added to the reaction vessel. The air in the reaction vessel was replaced with argon gas. Water (300 mL) was added to the contents of the reaction vessel. The contents of the reaction vessel were stirred at 50° C. for one hour. The contents of the reaction vessel were cooled to 10° C., thereby obtaining an alkaline aqueous solution S-A.

Next, a dicarboxylic acid dichloride (20.8 mmol) of a compound (DPEC) that is a monomer and a dicarboxylic acid dichloride (11.2 mmol) of a compound (TPC) that is a monomer were dissolved in chloroform (150 mL). In this way, a chloroform solution S-B was obtained.

The chloroform solution S-B was slowly added dropwise to the alkaline aqueous solution S-A over 110 minutes using a dropping funnel. While adjusting the temperature (liquid temperature) of the contents of the reaction vessel to 15±5° C., the contents of the reaction vessel were stirred to allow the polymerization reaction to proceed. The upper layer (aqueous layer) of the contents of the reaction vessel was removed using a decant to obtain an organic layer. Subsequently, ion exchanged water (400 mL) was added to an Erlenmeyer flask. The obtained organic layer was further added to the Erlenmeyer flask. Chloroform (400 mL) and acetic acid (2 mL) were further added to the Erlenmeyer flask. The contents of the Erlenmeyer flask were stirred at room temperature (25° C.) for 30 minutes. The upper layer (aqueous layer) of the contents of the Erlenmeyer flask was removed using a decant to obtain an organic layer. The obtained organic layer was washed with ion exchanged water (1 L) using a separating funnel. The washing with ion exchanged water was repeated five times to obtain the washed organic layer. Next, the washed organic layer was filtered to obtain a filtrate. The obtained filtrate was slowly added dropwise to methanol (1L) to obtain a precipitate. The precipitate was collected by filtration. The collected precipitate was vacuum dried at a temperature of 70° C. for 12 hours. As a result, a polyarylate resin (R-1) was obtained. At this time, by adjusting the polymerization time, polyarylate resins (R-1-1) to (R-1-14) having different molecular weights were prepared. For example, the polymerization times of the polyarylate resins (R-1-1) to (R-1-4) were respectively set to 2 hours, 4 hours, 5 hours, and 6 hours.

### (Synthesis of Polyarylate Resins (R-2) to (R-7))

Each of polyarylate resins (R-2) to (R-7) was synthesized by the same method as that for the synthesis of the polyarylate resins (R-1-1) to (R-1-15) except that the monomers shown in Table 3 were used at the addition rates shown in Table 3. Note that the addition amount of each bisphenol monomer was set such that the total amount of the bisphenol monomers was 41.0 mmol and the bisphenol addition rate shown in Table 3 was achieved. For example, in the synthesis of the polyarylate resin (R-5), the addition amount of the compound (BisB) was 32.8 mmol (=41.0×80/100) and the addition amount of the compound (DHPE) was 8.2 mmol (=41.0×20/100). Further, the addition amount of each dicarboxylic acid monomer was set such that the total amount of the dicarboxylic acid monomers was 32.0 mmol and the dicarboxylic acid addition rate shown in Table 3 was achieved. For example, in the synthesis of the polyarylate resin (R-5), the addition amount of the compound (DPEC) was 16.0 mmol (=32.0×50/100) and the addition amount of the compound (TPC) was 16.0 mmol (=32.0×50/100).

### <Measurement of Viscosity Average Molecular Weight>

The viscosity average molecular weight of the polyarylate resin was measured in accordance with JIS (Japanese Industrial Standard) K7252-1:2016. The measured viscosity average molecular weights are shown in Tables 4A, 4B, 5A, 5B, 6A, 6B, 7 Å, and 7B. The “Molecular weight” in Table indicates a viscosity average molecular weight.

### <Polyester Resins (PE-a) to (PE-d) and (PE-z)>

The polyester resins represented by the formulae (PE-a) to (PE-d) described in the first embodiment were prepared as binder resins to be used for producing photoreceptors according to Examples. Hereinafter, the “polyester resins represented by the formulae (PE-a) to (PE-d)” will respectively be referred to as “resins (PE-a) to (PE-d)” in some cases. The viscosity average molecular weights of the resins (PE-a), (PE-b), (PE-c), and (PE-d) were respectively 22,000, 22,500, 21,300, and 22,000. A polyester resin represented by the following formula (PE-z) was prepared as a binder resin to be used for producing photoreceptors according to Comparative Examples. Hereinafter, the “polyester resin represented by the formula (PE-z)” will be referred to as a resin (PE-z) in some cases. The viscosity average molecular weight of the resin (PE-z) was 22,000.

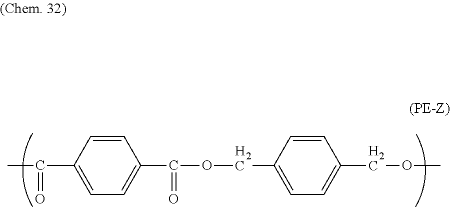

### <Production of Single-Layer Photoreceptor>

### (Production of Single-Layer Photoreceptor (A-1))

2 parts by mass of Y-type titanyl phthalocyanine that is a charge generating agent, 70 parts by mass of the hole transporting agent (H-1) as the hole transporting agent (SL), 40 parts by mass of the electron transporting agent (E-1), 95 parts by mass of the PA resin (R-1-1) and 5 parts by mass of the PE resin (PE-a) as 100 parts by mass of the binder resin (SL), and 500 parts by mass of tetrahydrofuran as a solvent were mixed for 20 minutes using a rod-shaped sonic oscillator to obtain a dispersion liquid. The dispersion liquid was filtered using a filter with an opening of 5 μm to obtain a coating liquid for a single-layer photosensitive layer. The coating liquid for a single-layer photosensitive layer was applied onto a conductive base (drum-shaped support formed of aluminum) by a dip coating method and hot-air dried at 120° C. for 50 minutes. In this way, a single-layer photosensitive layer (film thickness of 30 μm) was formed on the conductive base, thereby obtaining a single-layer photoreceptor (A-1). In the single-layer photoreceptor (A-1), the single-layer photosensitive layer was provided directly on the conductive base.

### (Production of Single-Layer Photoreceptors (A-2) to (A-13), (A-16) to (A-24), (B-1) to (B-4), and (B-7) to (B-9))

Each of single-layer photoreceptors (A-2) to (A-13), (A-16) to (A-24), (B-1) to (B-4), and (B-7) to (B-9) was produced by the same method as that for the production of the single-layer photoreceptor (A-1) except that the charge generating agent, the hole transporting agent (SL), the electron transporting agent, and the PA resin and PE resin (binder resin (SL)) shown in tables 4A, 4B, 5A, and 5B were used.

### (Production of Single-Layer Photoreceptors (A-14), (A-15), (B-5), and (B-6))

Single-layer photoreceptors (A-14) and (A-15) were produced by the same method as that for the production of the single-layer photoreceptor (A-1) except that the same charge generating agent, hole transporting agent (SL), electron transporting agent, and PA resin and PE resin (binder resin (SL)) as those in the single-layer photoreceptor (A-13) were used and the blending amounts of the PA resin and the PE resin were changed.

Single-layer photoreceptors (B-5) and (B-6) were produced by the same method as that for the production of the single-layer photoreceptor (A-1) except that the same charge generating agent, hole transporting agent (SL), electron transporting agent, and PA resin and PE resin (binder resin (SL)) as those in the single-layer photoreceptor (A-1) were used and the blending amounts of the PA resin and the PE resin were changed.

TABLE 4A

Charge generating layer
Polyarylate resin

| | Photo- | | Molecular | Parts by |
|---|---|---|---|---|
| | receptor | Type | weight | mass |
| Example 1-1 | A-1 | R-1-1 | 35200 | 95 |
| Example 1-2 | A-2 | R-1-2 | 53100 | 95 |
| Example 1-3 | A-3 | R-1-3 | 66000 | 95 |
| Example 1-4 | A-4 | R-1-4 | 79000 | 95 |
| Example 1-5 | A-5 | R-1-5 | 55000 | 95 |
| Example 1-6 | A-6 | R-1-6 | 56000 | 95 |
| Example 1-7 | A-7 | R-1-7 | 61000 | 95 |
| Example 1-8 | A-8 | R-1-8 | 51000 | 95 |
| Example 1-9 | A-9 | R-1-3 | 66000 | 95 |
| Example 1-10 | A-10 | R-1-9 | 69000 | 95 |
| Example 1-11 | A-11 | R-1-10 | 53000 | 95 |
| Example 1-12 | A-12 | R-1-11 | 44000 | 95 |
| Example 1-13 | A-13 | R-1-12 | 62000 | 95 |
| Example 1-14 | A-14 | R-1-12 | 62000 | 92 |
| Example 1-15 | A-15 | R-1-12 | 62000 | 99 |
| Example 1-16 | A-16 | R-1-12 | 62000 | 95 |
| Example 1-17 | A-17 | R-1-12 | 62000 | 95 |
| Example 1-18 | A-18 | R-1-12 | 62000 | 95 |
| Example 1-19 | A-19 | R-2 | 64200 | 95 |
| Example 1-20 | A-20 | R-3 | 54500 | 95 |
| Example 1-21 | A-21 | R-4 | 52700 | 95 |
| Example 1-22 | A-22 | R-5 | 62300 | 95 |
| Example 1-23 | A-23 | R-6 | 58000 | 95 |
| Example 1-24 | A-24 | R-7 | 54300 | 95 |

TABLE 4B

| | Charge generating layer | | | | |
|---|---|---|---|---|---|
| | Polyester resin | | | | |
| | | Molecular | Parts by | | |
| | Type | weight | mass | HTM | ETM |
| Example 1-1 | PE-a | 22000 | 5 | H-1 | E-1 |
| Example 1-2 | PE-a | 22000 | 5 | | |
| Example 1-3 | PE-a | 22000 | 5 | | |
| Example 1-4 | PE-a | 22000 | 5 | | |
| Example 1-5 | PE-a | 22000 | 5 | H-2 | |
| Example 1-6 | PE-a | 22000 | 5 | H-3 | |
| Example 1-7 | PE-a | 22000 | 5 | H-4 | |
| Example 1-8 | PE-a | 22000 | 5 | H-5 | |
| Example 1-9 | PE-a | 22000 | 5 | H-6 | |
| Example 1-10 | PE-a | 22000 | 5 | H-7 | |
| Example 1-11 | PE-a | 22000 | 5 | H-8 | |
| Example 1-12 | PE-a | 22000 | 5 | H-9 | |
| Example 1-13 | PE-a | 22000 | 5 | H-10 | |
| Example 1-14 | PE-a | 22000 | 8 | H-10 | |
| Example 1-15 | PE-a | 22000 | 1 | H-10 | |
| Example 1-16 | PE-b | 22500 | 5 | H-10 | |
| Example 1-17 | PE-c | 21300 | 5 | H-10 | |
| Example 1-18 | PE-d | 22000 | 5 | H-10 | |
| Example 1-19 | PE-a | 22000 | 5 | H-1 | |
| Example 1-20 | PE-a | 22000 | 5 | | |
| Example 1-21 | PE-a | 22000 | 5 | | |
| Example 1-22 | PE-a | 22000 | 5 | | |
| Example 1-23 | PE-a | 22000 | 5 | | |
| Example 1-24 | PE-a | 22000 | 5 | | |

TABLE 5A

Charge generating layer
Polyarylate resin

| | Photo- | | Molecular | Parts by |
|---|---|---|---|---|
| | receptor | Type | weight | mass |
| Comparative | B-1 | R-8 | 65000 | 95 |
| Example 1-1 | | | | |
| Comparative | B-2 | R-9 | 52000 | 95 |
| Example 1-2 | | | | |
| Comparative | B-3 | R-10 | 58000 | 95 |
| Example 1-3 | | | | |
| Comparative | B-4 | R-11 | 51000 | 95 |
| Example 1-4 | | | | |
| Comparative | B-5 | R-1-1 | 35200 | 100 |
| Example 1-5 | | | | |
| Comparative | B-6 | R-1-1 | 35200 | 90 |
| Example 1-6 | | | | |
| Comparative | B-7 | R-1-13 | 24000 | 95 |
| Example 1-7 | | | | |
| Comparative | B-8 | R-1-14 | 83000 | 95 |
| Example 1-8 | | | | |
| Comparative | B-9 | R-1-1 | 35200 | 95 |
| Example 1-9 | | | | |

TABLE 5B

Charge generating layer

Polyester resin

| | | Molecular | Parts by | | |
|---|---|---|---|---|---|
| | Type | weight | mass | HTM | ETM |
| Comparative | PE-a | 22000 | 5 | H-2 | E-1 |
| Example 1-1 | | | | | |
| Comparative | PE-a | 22000 | 5 | | |
| Example 1-2 | | | | | |
| Comparative | PE-a | 22000 | 5 | | |
| Example 1-3 | | | | | |
| Comparative | PE-a | 22000 | 5 | | |
| Example 1-4 | | | | | |
| Comparative | PE-a | 22000 | 0 | | |
| Example 1-5 | | | | | |
| Comparative | PE-a | 22000 | 10 | | |
| Example 1-6 | | | | | |
| Comparative | PE-a | 22000 | 5 | H-1 | |
| Example 1-7 | | | | | |
| Comparative | PE-a | 22000 | 5 | | |
| Example 1-8 | | | | | |
| Comparative | PE-Z | 22000 | 5 | H-10 | |
| Example 1-9 | | | | | |

### <Production of Positively-Charged Stacked Photoreceptor>

### (Production of Positively-Charged Stacked Photoreceptor (C-1))

First, a charge transporting layer was formed. In detail, 100 parts by mass of the hole transporting agent (H-10) as the hole transporting agent (CT), 100 parts by mass of the resin (R-1-12) as the binder resin (CT), and 500 parts by mass of tetrahydrofuran as a solvent were mixed for 20 minutes using a rod-shaped sonic oscillator to obtain a dispersion liquid. The dispersion liquid was filtered using a filter with an opening of 5 μm to obtain a coating liquid for a charge transporting layer. The coating liquid for a charge transporting layer was applied onto a conductive base (drum-shaped support formed of aluminum) by a dip coating method and hot-air dried at 120° C. for 50 minutes. In this way, the charge transporting layer (film thickness of 15 μm) was formed on the conductive base.

Next, a charge generating layer was formed. In detail, 2 parts by mass of Y-type titanyl phthalocyanine as a charge generating agent, 70 parts by mass of the hole transporting agent (H-1) as the hole transporting agent (CG), 40 parts by mass of the electron transporting agent (E-1), 95 parts by mass of the PA resin (R-1-1) and 5 parts by mass of the PE resin (PE-a) as 100 parts by mass of the binder resin (CG), and 500 parts by mass of 1,2-dichloroethane as a solvent were mixed for 20 minutes using a rod-shaped sonic oscillator to obtain a dispersion liquid. The dispersion liquid was filtered using a filter with an opening of 5 μm to obtain a coating liquid for a charge generating layer. The coating liquid for a charge generating layer was applied onto the formed charge transporting layer by a dip coating method and hot-air dried at 120° C. for 50 minutes. In this way, a charge generating layer (film thickness of 15 μm) was formed on the charge transporting layer, thereby obtaining a positively-charged stacked photoreceptor (C-1). In the positively-charged stacked photoreceptor (C-1), the charge transporting layer was provided directly on the conductive base and the charge generating layer was provided directly on the charge transporting layer.

### (Production of Positively-Charged Stacked Photoreceptors (C-2) to (C-19), (C-22) to (C-24), (D-1) to (D-4), and (D-7) to (D-9))

Each of positively-charged stacked photoreceptors (C-2) to (C-19), (C-22) to (C-24), (D-1) to (D-4), and (D-7) to (D-9) was produced by the same method as that for the production of the positively-charged stacked photoreceptor (C-1) except that the charge generating agent, the hole transporting agent (CG), the electron transporting agent, and the PA resin and PE resin (binder resin (CG)) shown in the column of “Charge generating layer” in Tables 6A-6B and Tables 7A-7B were used.

### (Production of Positively-Charged Stacked Photoreceptors (C-20), (C-21), (D-5), and (D-6))

Stacked-layer photoreceptors (C-20) and (C-21) were produced by the same method as that for the production of the stacked-layer photoreceptor (C-1) except that the same charge generating agent, hole transporting agent (SL), electron transporting agent, and PA resin and PE resin (binder resin (SL)) as those in the stacked-layer photoreceptor (C-13) were used and the blending amounts of the PA resin and the PE resin were changed.

Stacked-layer photoreceptors (D-5) and (D-6) were produced by the same method as that for the production of the stacked-layer photoreceptor (C-1) except that the same charge generating agent, hole transporting agent (SL), electron transporting agent, and PA resin and PE resin (binder resin (SL)) were used and the blending amounts of the PA resin and PE resin were changed.

TABLE 6A

Charge generating layer
Polyarylate resin

| | Photo- | | Molecular | Parts by |
|---|---|---|---|---|
| | receptor | Type | weight | mass |
| Example 2-1 | C-1 | R-1-1 | 35200 | 95 |
| Example 2-2 | C-2 | R-1-2 | 53100 | 95 |
| Example 2-3 | C-3 | R-1-3 | 66000 | 95 |
| Example 2-4 | C-4 | R-1-4 | 79000 | 95 |
| Example 2-5 | C-5 | R-1-5 | 55000 | 95 |
| Example 2-6 | C-6 | R-1-6 | 56000 | 95 |
| Example 2-7 | C-7 | R-1-7 | 61000 | 95 |
| Example 2-8 | C-8 | R-1-8 | 51000 | 95 |
| Example 2-9 | C-9 | R-1-3 | 66000 | 95 |
| Example 2-10 | C-10 | R-1-9 | 69000 | 95 |
| Example 2-11 | C-11 | R-1-10 | 53000 | 95 |
| Example 2-12 | C-12 | R-1-11 | 44000 | 95 |
| Example 2-13 | C-13 | R-1-12 | 62000 | 95 |
| Example 2-14 | C-14 | R-2 | 64200 | 95 |
| Example 2-15 | C-15 | R-3 | 54500 | 95 |
| Example 2-16 | C-16 | R-4 | 52700 | 95 |
| Example 2-17 | C-17 | R-5 | 62300 | 95 |
| Example 2-18 | C-18 | R-6 | 58000 | 95 |
| Example 2-19 | C-19 | R-7 | 54300 | 95 |
| Example 2-20 | C-20 | R-1-12 | 62000 | 92 |
| Example 2-21 | C-21 | R-1-12 | 62000 | 99 |
| Example 2-22 | C-22 | R-1-12 | 62000 | 95 |
| Example 2-23 | C-23 | R-1-12 | 62000 | 95 |
| Example 2-24 | C-24 | R-1-12 | 62000 | 95 |

TABLE 6B

| | Charge generating layer | | | | |
|---|---|---|---|---|---|
| | Polyester resin | | | | |
| | | Molecular | Parts by | | |
| | Type | weight | mass | HTM | ETM |
| Example 2-1 | PE-a | 22000 | 5 | H-1 | E-1 |
| Example 2-2 | PE-a | 22000 | 5 | | |
| Example 2-3 | PE-a | 22000 | 5 | | |
| Example 2-4 | PE-a | 22000 | 5 | | |
| Example 2-5 | PE-a | 22000 | 5 | H-2 | |
| Example 2-6 | PE-a | 22000 | 5 | H-3 | |
| Example 2-7 | PE-a | 22000 | 5 | H-4 | |
| Example 2-8 | PE-a | 22000 | 5 | H-5 | |
| Example 2-9 | PE-a | 22000 | 5 | H-6 | |
| Example 2-10 | PE-a | 22000 | 5 | H-7 | |
| Example 2-11 | PE-a | 22000 | 5 | H-8 | |
| Example 2-12 | PE-a | 22000 | 5 | H-9 | |
| Example 2-13 | PE-a | 22000 | 5 | H-10 | |
| Example 2-14 | PE-a | 22000 | 5 | H-10 | |
| Example 2-15 | PE-a | 22000 | 5 | | |
| Example 2-16 | PE-a | 22000 | 5 | | |
| Example 2-17 | PE-a | 22000 | 5 | | |
| Example 2-18 | PE-a | 22000 | 5 | | |
| Example 2-19 | PE-a | 22000 | 5 | | |
| Example 2-20 | PE-a | 22000 | 8 | H-10 | |
| Example 2-21 | PE-a | 22000 | 1 | H-10 | |
| Example 2-22 | PE-b | 22500 | 5 | H-10 | |
| Example 2-23 | PE-c | 21300 | 5 | H-10 | |
| Example 2-24 | PE-d | 22000 | 5 | H-10 | |

TABLE 7A

Charge generating layer
Polyarylate resin

| | Photo- | | Molecular | Parts by |
|---|---|---|---|---|
| | receptor | Type | weight | mass |
| Comparative | D-1 | R-8 | 65000 | 95 |
| Example 2-1 | | | | |
| Comparative | D-2 | R-9 | 52000 | 95 |
| Example 2-2 | | | | |
| Comparative | D-3 | R-10 | 58000 | 95 |
| Example 2-3 | | | | |
| Comparative | D-4 | R-11 | 51000 | 95 |
| Example 2-4 | | | | |
| Comparative | D-5 | R-1-1 | 35200 | 100 |
| Example 2-5 | | | | |
| Comparative | D-6 | R-1-1 | 35200 | 90 |
| Example 2-6 | | | | |
| Comparative | D-7 | R-1-13 | 24000 | 95 |
| Example 2-7 | | | | |
| Comparative | D-8 | R-1-14 | 83000 | 95 |
| Example 2-8 | | | | |
| Comparative | D-9 | R-1-5 | 55000 | 95 |
| Example 2-9 | | | | |

TABLE 7B

Charge generating layer

Polyester resin

| | | Molecular | Parts by | | |
|---|---|---|---|---|---|
| | Type | weight | mass | HTM | ETM |
| Comparative | PE-a | 22000 | 5 | H-2 | E-1 |
| Example 2-1 | | | | | |
| Comparative | PE-a | 22000 | 5 | | |
| Example 2-2 | | | | | |
| Comparative | PE-a | 22000 | 5 | | |
| Example 2-3 | | | | | |
| Comparative | PE-a | 22000 | 5 | | |
| Example 2-4 | | | | | |
| Comparative | PE-a | 22000 | 0 | | |
| Example 2-5 | | | | | |
| Comparative | PE-a | 22000 | 10 | | |
| Example 2-6 | | | | | |
| Comparative | PE-a | 22000 | 5 | H-1 | |
| Example 2-7 | | | | | |
| Comparative | PE-a | 22000 | 5 | | |
| Example 2-8 | | | | | |
| Comparative | PE-Z | 22000 | 5 | H-10 | |
| Example 2-9 | | | | | |

### <Evaluation>

The wear resistance and fogging resistance of each of the obtained photoreceptor (single-layer photoreceptor and positively-charged stacked photoreceptor) were evaluated by the method described below. Specifically, for each of the single-layer photoreceptors (A-1) to (A-24), the single-layer photoreceptors (B-1) to (B-9), the stacked photoreceptors (C-1) to (C-24), and the stacked photoreceptors (D-1) to (D-9), the breaking strain, the scratch resistance depth, the amount of wear, the charging potential after recharging, the end-portion fogging density, and the withstand voltage were measured by the following method and the wear resistance and fogging resistance were evaluated. The results are shown in the following Tables 8A-8C, 9A-9C, 10A-10C and 11A-11C.

The scratch resistance depth, the amount of wear, and the charging potential after recharging were measured primarily to evaluate the wear resistance. The end-portion fogging density and the withstand voltage were measured as evaluation relating to the fogging resistance (particularly, suppression of the occurrence of end-portion fogging). The breaking strain was measured as evaluation relating to the fogging resistance and the wear resistance.

### [(1) Measurement of Breaking Strain]

For each of the obtained single-layer photoreceptors (A-1) to (A-24), single-layer photoreceptors (B-1) to (B-9), stacked photoreceptors (C-1) to (C-24), and stacked photoreceptors (D-1) to (D-9), the breaking strain of the photosensitive layer (charge transporting layer in the stacked photoreceptor) was measured. The method of measuring a breaking strain will be described. First, each photoreceptor was produced by the above-mentioned method, and the photosensitive layer was peeled off from the drum-shaped support of each photoreceptor. Subsequently, the photosensitive layer was cut into a size of 3 mm×30 mm to obtain a sample. Subsequently, the sample was mounted on a tensile tester (“Autograph (registered trademark) AGS-J 5 kN” manufactured by SHIMADZU CORPORATION). When mounting the sample, the distance between gripping tools of the tensile tester was adjusted to 8 mm. Subsequently, the sample was pulled at a tensile speed of 5 mm/min under an environment of a temperature of 23° C. and a humidity of 50% RH, thereby obtaining a stress-strain curve. A breaking strain was obtained from the obtained stress-strain curve. The obtained breaking strain was determined in accordance with the following determination criteria. That is, it was judged that excellent wear resistance and fogging resistance tend to be achieved in the case where the grade is A, and it was judged that excellent wear resistance and fogging resistance tend not to be achieved in the case where the grade is C. The breaking strain and the determination results are shown in Tables 8A-8C, 9A-9C, 10A-10C and 11A-11C.

### (Determination Criteria for Breaking Strain)

Grade A (Good): the breaking strain is 7.5% or more and 21.0% or less
Grade C (Poor): 0% or more and less than 7.5%; or more than 21.0%

### [(2) Measurement of Scratch Depth]

For each of the obtained single-layer photoreceptors (A-1) to (A-24), single-layer photoreceptors (B-1) to (B-9), stacked photoreceptors (C-1) to (C-24), and stacked photoreceptors (D-1) to (D-9), the scratch depth of the photosensitive layer was measured. The scratch depth was measured by the method described below using a scratching device 200 (see FIG. 8) specified in JIS K5600-5-5 (Japanese Industrial Standard K5600: Testing methods for paints-Part 5: Mechanical property of film-Section 5: Scratch hardness (Stylus method)).

The scratching device 200 specified in JIS K5600-5-5 will be described below with reference to FIG. 8. FIG. 8 is a diagram showing an example of the configuration of the scratching device 200. The scratching device 200 includes a fixing base 201, a fixture 202, a scratching needle 203, a support arm portion 204, two shaft support portions 205, a base 206, two rail portions 207, a weight pan 208, and a constant-speed motor (not shown). A weight 209 is placed on the weight pan 208.

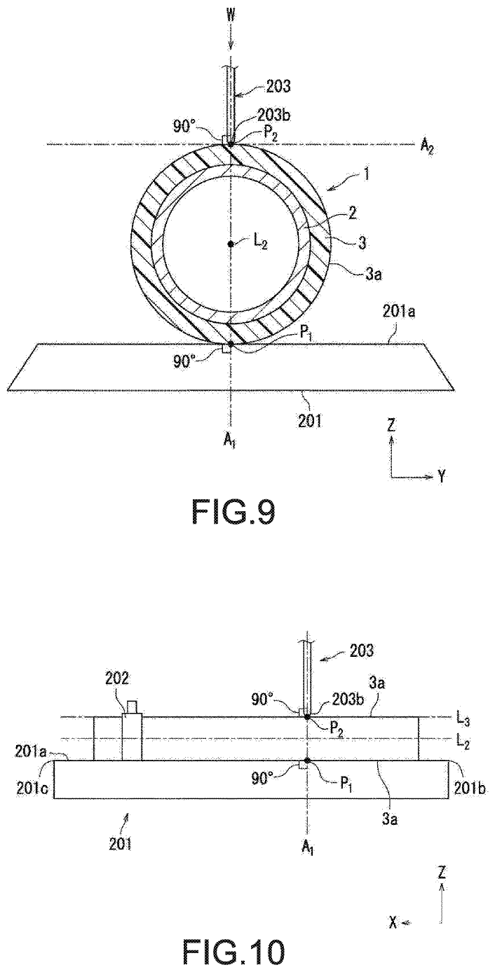

In FIG. 8, the X-axis direction and the Y-axis direction are horizontal directions, and the Z-axis direction is a vertical direction. The X-axis direction indicates the longitudinal direction of the fixing base 201. The Y-axis direction indicates a direction orthogonal to the X-axis direction in a plane parallel to the upper surface 201a (placement surface) of the fixing base 201. Note that the X-axis direction, Y-axis direction, and Z-axis direction in FIGS. 9 to 11 described below are also the same as those in FIG. 8.

The fixing base 201 corresponds to the test plate fixing base in JIS K5600-5-5. The fixing base 201 has the upper surface 201a, one end 201b, and the other end 201c. The upper surface 201a of the fixing base 201 is the horizontal plane. The one end 201b faces the two shaft support portions 205.

The fixture 202 is provided closer to the other end 201c on the upper surface 201a of the fixing base 201. The fixture 202 fixes a measurement target (photoreceptor 1) to the upper surface 201a of the fixing base 201.

The scratching needle 203 has a tip 203b (see FIG. 9). The structure of the tip 203b is a hemispherical shape with a diameter of 1 mm. The material of the tip 203b is sapphire.

The support arm portion 204 supports the scratching needle 203. The support arm portion 204 pivots about a spindle 204a in a direction in which the scratching needle 203 approaches the photoreceptor 1 and a direction in which the scratching needle 203 is away from the photoreceptor 1.

The two shaft support portions 205 pivotably supports the support arm portion 204.

The base 206 has an upper surface 206a. The two shaft support portions 205 are provided on the one end side of the upper surface 206a.

The two rail portions 207 are provided on the other end side of the upper surface 206a. The two rail portions 207 are provided to face each other in parallel. The two rail portions 207 are each provided in parallel to the longitudinal direction (X-axis direction) of the fixing base 201. The fixing base 201 is mounted between the two rail portions 207. The fixing base 201 is capable of moving horizontally along the rail portions 207 in the longitudinal direction (X-axis direction) of the fixing base 201.

The weight pan 208 is provided above the scratching needle 203 via the support arm portion 204. The weight 209 is placed on the weight pan 208.

The constant-speed motor causes the fixing base 201 to move in the X-axis direction along the rail portions 207.

A method of measuring a scratch depth will be described below. The method of measuring a scratch depth includes a first step, a second step, a third step, and a fourth step. As the scratching device 200, a surface property tester (“HEIDON TYPE14” manufactured by Shinto Scientific Co., Ltd.) was used. The scratch depth was measured under an environment of a temperature of 23° C. and a humidity of 50% RH. The shape of the photoreceptor 1 was a drum shape (cylindrical).

### (First Step)

In the first step, the photoreceptor 1 was fixed to the upper surface 201a of the fixing base 201 such that the longitudinal direction of the photoreceptor 1 is parallel to the longitudinal direction of the fixing base 201. At this time, the photoreceptor 1 was mounted such that the direction of a central axis L2 (rotation axis) of the photoreceptor 1 is parallel to the longitudinal direction of the fixing base 201.

### (Second Step)

In the second step, the scratching needle 203 was caused to vertically abut on a surface 3a of the photosensitive layer 3. A method of causing the scratching needle 203 to vertically abut on the surface 3a of the photosensitive layer 3 of the drum-shaped photoreceptor 1 will be described with reference to FIG. 9 and FIG. 10 in addition to FIG. 8.

FIG. 9 is a cross-sectional view taken along the line IV-IV in FIG. 8 and is a cross-sectional view when the scratching needle 203 is caused to abut on the photoreceptor 1. FIG. 10 is a side view of the fixing base 201, the scratching needle 203, and the photoreceptor 1 shown in FIG. 8.

The scratching needle 203 was brought close to the photoreceptor 1 such that the extension line of a central axis A1 of the scratching needle 203 is perpendicular to the upper surface 201a of the fixing base 201. Subsequently, the tip 203b of the scratching needle 203 was caused to abut on the point (abutting point P2) on the surface 3a of the photosensitive layer 3 of the photoreceptor 1, which was farthest from the upper surface 201a of the fixing base 201 in the vertical direction (Z-axis direction). As a result, the tip 203b of the scratching needle 203 abutted on the photoreceptor 1 such that the central axis A1 of the scratching needle 203 was perpendicular to a tangent A2. At this time, the line segment connecting a contact point P1 of the upper surface 201a and the abutting point P2 of the tip 203b was orthogonal to the central axis L2 of the photoreceptor 1. Note that the tangent A2 is a tangent at the abutting point P2 of the outer circumference formed by the cross section of the photoreceptor 1 perpendicular to the central axis L2.

### (Third Step)

Next, the third step will be described with reference to FIG. 5 and FIG. 6. In the third step, with the scratching needle 203 vertically abutting on the surface 3a of the photosensitive layer 3, a load W of 10 g was applied from the scratching needle 203 to the photosensitive layer 3. Specifically, the weight 209 of 10 g was placed on the weight pan 208. In this state, the fixing base 201 was caused to move. Specifically, the constant-speed motor was driven to cause the fixing base 201 to move horizontally in the X-axis direction along the rail portions 207. That is, the one end 201b of the fixing base 201 was caused to move from a first position N1 to a second position N2. Note that the second position N2 was located on the downstream side of the first position N1. The downstream side refers to the side located in the longitudinal direction of the fixing base 201 in which the fixing base 201 are away from the two shaft support portions 205. As the fixing base 201 moved in the longitudinal direction, the photoreceptor 1 also moved horizontally in the longitudinal direction of the fixing base 201. The movement speed of the fixing base 201 and the photoreceptor 1 was 30 mm/min. Further, the movement distance of the fixing base 201 and the photoreceptor 1 was 30 mm. Note that the movement distance of the fixing base 201 and the photoreceptor 1 corresponded to a distance D1-2 between the first position N1 and the second position N2. As a result of the movement of the fixing base 201 and the photoreceptor 1, a scratch S was formed on the surface 3a of the photosensitive layer 3 of the photoreceptor 1 by the scratching needle 203.

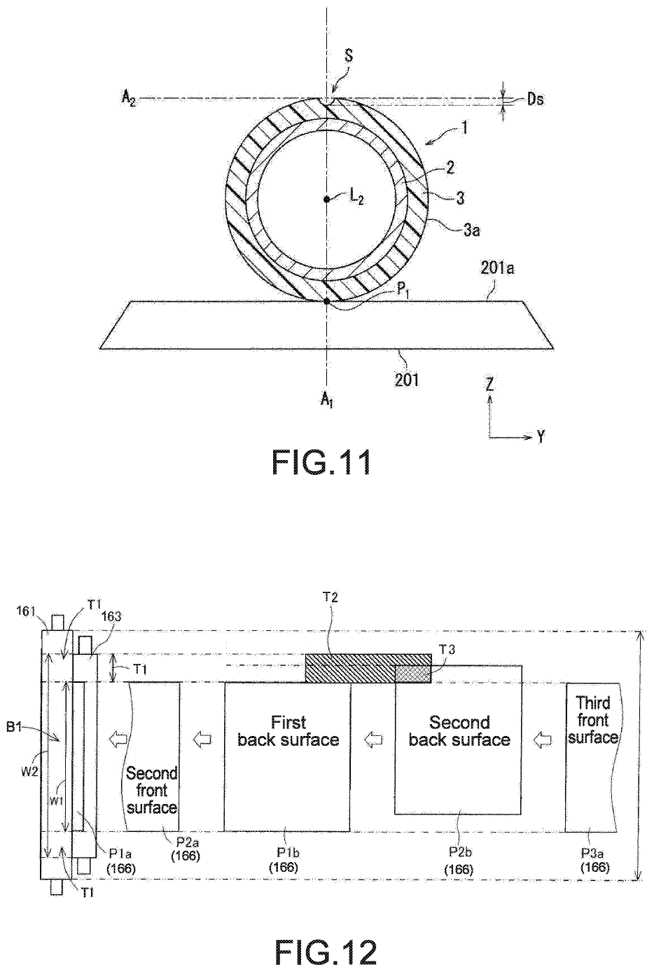

Next, the scratch S will be described with reference to FIG. 11 in addition to FIG. 8 to FIG. 10. FIG. 11 shows the scratch S formed on the surface 3a of the photosensitive layer 3. The scratch S was formed perpendicular to the upper surface 201a of the fixing base 201 and the tangent A2. Further, the scratch S was formed so as to pass a line L3 shown in FIG. 10. The line L3 is a line including a plurality of abutting points P2. The line L3 was parallel to the upper surface 201a of the fixing base 201 and the central axis L2 of the photoreceptor 1. The line L3 was perpendicular to the central axis A1 of the scratching needle 203.

### (Fourth Step)

In the fourth step, the scratch depth that was the maximum value of a depth Ds of the scratch S was measured. Specifically, the photoreceptor 1 was removed from the fixing base 201. The scratch S formed in the photosensitive layer 3 of the photoreceptor 1 was observed at a magnification of five using a three-dimensional interference microscope (“WYKO NT-1100” manufactured by Bruker) to measure the depth Ds of the scratch S. The depth Ds of the scratch S was defined as the distance from the tangent A2 to the trough portion of the scratch S. The maximum value (Dsmaximum value) of the depths Ds of the scratch S was used as the scratch depth. The measured scratch depth was determined in accordance with the following determination criteria. Photoreceptors with the grade A or B were evaluated as having good scratch resistance. Further, photoreceptors with the grade C were evaluated as having poor scratch resistance. That is, it was judged that excellent wear resistance tends to be achieved in the case where the grade is A, and it was judged that excellent wear resistance tends not to be achieved in the case where the grade is B or C. The scratch depth and the determination results are shown in Tables 8A-8C, 9A-9C, 10A-10C and 11A-11C.

w(Evaluation criteria for scratch resistance depth)
Grade A (very good): the Dsmaximum value is within 0.50 μm.
Grade B (Good): the Dsmaximum value exceeds 0.50 μm and is less than 0.60 μm.
Grade C (Poor): the Dsmaximum value is 0.6 μm or more.

### [(4) Measurement of End-Portion Fogging Density]

For each of the obtained single-layer photoreceptors (A-1) to (A-24), single-layer photoreceptors (B-1) to (B-9), stacked photoreceptors (C-1) to (C-24), and stacked photoreceptors (D-1) to (D-9), the fogging resistance in the formed image was evaluated. An image forming apparatus (“Monochrome printer ECOSYS P2040dw” manufactured by KYOCERA Document Solutions Inc.) was used as an evaluation device. This image forming apparatus adopts a direct transfer method, a contact development method, and a cleanerless method. In this image forming apparatus, the development unit cleans the toner remaining on the photoreceptor. Further, the charging unit of this image forming apparatus is a charging roller. “KYOCERA Document Solutions Inc. Brand Paper VM-A4” (A4 size) sold by KYOCERA Document Solutions Inc. was used as a sheet of paper. A one-component developer (prototype) was used for evaluation by the evaluation device.

An image I was continuously printed on 12,000 sheets of paper at a rotational speed of the photoreceptor of 240 mm/sec and the charging potential of +600 V using this evaluation device. The image I was an image with a coverage rate of 1%. Subsequently, a blank image was printed on one sheet of paper. The printing was performed under an environment of a temperature of 32.5° C. and a humidity of 80% RH. For the obtained blank image, the image densities at three positions in the blank image were measured using a reflection densitometer (“RD914” manufactured by X-rite, Inc.). The sum of the image densities at the three positions in the blank image was divided by the number of measurement points. In this way, a number average value of the image densities of the blank image was obtained. The value obtained by subtracting the image density of the base paper from the number average value of the image densities of the blank image was used as end-portion fogging density. The measured end-portion fogging density was determined in accordance with the following determination criteria. Photoreceptors with the grade A or B were evaluated as having good fogging resistance. Further, photoreceptors with the grade c were evaluated as having poor fogging resistance. The end-portion fogging density (FD value) and the determination results are shown in Tables 8A-8C, 9A-9C, 10A-10C and 11A-11C. It was judged that it is possible to suppress end-portion fogging effectively in the case where the grade is A, and it was judged that it is not possible to suppress end-portion fogging sufficiently in the case where the grade is B or C.

### (Determination Criteria for End-Portion Fogging Density)

Grade A (Very Good): the end-portion fogging density is 0.010 or less.
Grade B (Good): the end-portion fogging density is more than 0.010 and 0.020 or less.
Grade C (Poor): the end-portion fogging density is 0.020 or more.

### [(5) Measurement of Amount of Wear]

Before the above-mentioned evaluation of fogging resistance, the thickness of the photosensitive layer of each photoreceptor was measured by an Eddy current film thickness meter. Subsequently, after performing the above-mentioned evaluation of fogging resistance, the thickness of the photosensitive layer of each photoreceptor was measured by the Eddy current film thickness meter. Subsequently, the amount of reduction in thickness of the photosensitive layer before and after the evaluation of fogging resistance of each photoreceptor was calculated, and this was used as an amount of wear (unit: μm). The results are shown in Tables 8A-8C, 9A-9C, 10A-10C and 11A-11C. The lower the amount of wear, the more excellent the wear resistance is evaluated. The measured amount of wear was determined in accordance with the following determination criteria. The measured amount of wear and the determination results are shown in Tables 8A-8C, 9A-9C, 10A-10C and 11A-11C. It was judged that excellent wear resistance tends to be achieved in the case where the grade is A, and it was judged that excellent wear resistance tends to be difficult to achieve in the case where the grade is B or C.

### (Determination Criteria for Amount of Wear)

Grade A (Very Good): the amount of wear is within 4 μm.
Grade B (Good): the amount of wear exceeds 4 μm and is less than 5 μm.
Grade C (Poor): the amount of wear is 5 μm or more.
   [(6) Measurement of Charging Potential after Recharging]

A copier AR-450M was used as an evaluation device. The copier AR-450M is a copier capable of forming images in a double-sided image formation mode in which an image is formed on one surface of a recording medium (sheet of paper) through the processes of charging, exposure, development, and transfer, and then an image is formed on the other surface of the recording medium (sheet of paper) through the same processes again. Further, in the case where images are formed in the double-sided image formation mode in the copier, transfer is performed in the order of the front surface Pla of the first sheet of paper 166, the front surface P2a of the second sheet of paper 166, the back surface P1b of the first sheet of paper 166, and the back surface P2b of the second sheet of paper 166, as shown in FIG. 12.

The development device was removed from the above-mentioned copier and replaced with a surface potential meter (product name: Model 344, manufactured by TREK, INC.) at the development portion. Images were continuously formed on both sides of two sheets of recording paper under a normal temperature and normal humidity (N/N) environment of a temperature: 25° C. and a relative humidity: 65%. In this image formation process, a charging potential V01 [−V] of the photoreceptor in the portion where the sheet of paper was interposed between the photoreceptor and the transfer roller (hereinafter, referred to as a paper-passing portion) and a charging potential V02 [−V] of the photoreceptor in the portion where the photoreceptor is in direct contact with the transfer roller (hereinafter, referred to as a non-paper-passing portion) after recharging the photoreceptor after transfer to form an image on the back surface of the second sheet of recording paper were measured. Further, an absolute value (|V01−V02|) of the difference between the measured charging potential V01 of the paper-passing portion and the measured charging potential V02 of the non-paper-passing portion was obtained as a potential reduction amount ΔV0 [V]. It was judged that charge stability is obtained even after continuous printing and excellent wear resistance tends to be achieved in the case where the grade is A, and it was judged that charge stability after continuous printing is not obtained and excellent wear resistance tends to be difficult to achieve in the case where the grade is B or C.

(Determination Criteria for Charging Potential after Recharging)
Grade A (Very Good): ΔV0 [V](V01−V02) is less than 50 V.
Grade B (Good): ΔV0 [V](V01−V02) is 50 V or more and less than 80 V.
Grade C (Poor): ΔV0 [V](V01−V02) is 80 V or more.

### [(7) Measurement of Withstand Voltage]

The voltage resistance (specifically, the voltage resistance of the photosensitive layer at high temperatures) was evaluated under an environment of a temperature of 55° C. and a humidity of 50% RH. First, a heater was mounted on the inner surface of the conductive base (drum-shaped support) of the photoreceptor, and the temperature of the photoreceptor was kept at 55° C. Next, a needle-shaped electrode was disposed at a position 1 mm from the surface of the photoreceptor, and a direct current voltage was applied to the electrode. The voltage to be applied to the electrode was increased at a constant rate (−300 V/sec) until dielectric breakdown of the photosensitive layer occurred. The voltage applied to the electrode at the time point of dielectric breakdown of the photosensitive layer was used as an evaluation value for voltage resistance. Then, the voltage resistance was evaluated in accordance with the following determination criteria. It was judged that the reduction in voltage resistance can be suppressed and end-portion fogging can be suppressed in the case where the grade is A, and it was judged that the reduction in voltage resistance cannot be sufficiently suppressed and thus end-portion fogging cannot be sufficiently suppressed in the case where the grade is C.

### (Determination Criteria for Withstand Voltage)

Grade A (Good): the evaluation value is −8 kV or less.
Grade C (Poor): the evaluation value exceeds −8 kV.

### <Overall Determination>

Those with all the grade A in the evaluation of the breaking strain, the scratch resistance depth, the amount of wear, the charging potential after recharging, the end-portion fogging density, and the withstand voltage were determined as having excellent wear resistance and fogging resistance, and those with the grade B or c were determined as having poor wear resistance and fogging resistance.

TABLE 8A

| | | | | Scratch | | | |
|---|---|---|---|---|---|---|---|
| | | Breaking | | resistance | | Amount | |
| | Photo- | strain | | depth | | of wear | |
| | receptor | % | Grade | μm | Grade | μm | Grade |
| Example 1-1 | A-1 | 10.8 | A | 0.32 | A | 2.2 | A |
| Example 1-2 | A-2 | 14.3 | A | 0.38 | A | 2.0 | A |
| Example 1-3 | A-3 | 17.6 | A | 0.37 | A | 1.5 | A |
| Example 1-4 | A-4 | 20.6 | A | 0.39 | A | 1.1 | A |
| Example 1-5 | A-5 | 13.5 | A | 0.31 | A | 1.7 | A |
| Example 1-6 | A-6 | 15.0 | A | 0.32 | A | 1.6 | A |
| Example 1-7 | A-7 | 16.3 | A | 0.40 | A | 1.8 | A |
| Example 1-8 | A-8 | 13.8 | A | 0.45 | A | 2.4 | A |
| Example 1-9 | A-9 | 16.1 | A | 0.36 | A | 1.6 | A |
| Example 1-10 | A-10 | 18.4 | A | 0.31 | A | 1.2 | A |
| Example 1-11 | A-11 | 14.3 | A | 0.40 | A | 2.1 | A |
| Example 1-12 | A-12 | 12.0 | A | 0.39 | A | 2.3 | A |
| Example 1-13 | A-13 | 16.6 | A | 0.34 | A | 1.5 | A |
| Example 1-14 | A-14 | 15.3 | A | 0.43 | A | 1.4 | A |
| Example 1-15 | A-15 | 17.2 | A | 0.45 | A | 1.5 | A |
| Example 1-16 | A-16 | 15.0 | A | 0.33 | A | 1.4 | A |
| Example 1-17 | A-17 | 14.8 | A | 0.41 | A | 2.0 | A |
| Example 1-18 | A-18 | 16.0 | A | 0.38 | A | 1.8 | A |
| Example 1-19 | A-19 | 17.1 | A | 0.48 | A | 2.3 | A |
| Example 1-20 | A-20 | 14.5 | A | 0.35 | A | 1.8 | A |
| Example 1-21 | A-21 | 13.9 | A | 0.37 | A | 2.0 | A |
| Example 1-22 | A-22 | 16.7 | A | 0.48 | A | 2.6 | A |
| Example 1-23 | A-23 | 15.6 | A | 0.43 | A | 2.0 | A |
| Example 1-24 | A-24 | 14.6 | A | 0.40 | A | 2.0 | A |

TABLE 8B

| | Charging potential after recharging | | | |
|---|---|---|---|---|
| | Paper- | Non-paper- | Potential | |
| | passing | passing | reduction | |
| | portion | portion | amount | |
| | (V01) | (V02) | (V01 − V02) | Grade |
| Example 1-1 | 750 | 708 | 42 | A |
| Example 1-2 | 765 | 719 | 46 | A |
| Example 1-3 | 755 | 710 | 45 | A |
| Example 1-4 | 745 | 712 | 33 | A |
| Example 1-5 | 744 | 706 | 38 | A |
| Example 1-6 | 746 | 699 | 47 | A |
| Example 1-7 | 734 | 688 | 46 | A |
| Example 1-8 | 755 | 720 | 35 | A |
| Example 1-9 | 745 | 710 | 35 | A |
| Example 1-10 | 766 | 720 | 46 | A |
| Example 1-11 | 743 | 710 | 33 | A |
| Example 1-12 | 753 | 706 | 47 | A |
| Example 1-13 | 752 | 710 | 42 | A |
| Example 1-14 | 746 | 711 | 35 | A |
| Example 1-15 | 738 | 705 | 33 | A |
| Example 1-16 | 754 | 710 | 44 | A |
| Example 1-17 | 746 | 700 | 46 | A |
| Example 1-18 | 753 | 711 | 42 | A |
| Example 1-19 | 751 | 730 | 21 | A |
| Example 1-20 | 746 | 710 | 36 | A |
| Example 1-21 | 755 | 710 | 45 | A |
| Example 1-22 | 766 | 720 | 46 | A |
| Example 1-23 | 752 | 707 | 45 | A |
| Example 1-24 | 745 | 700 | 45 | A |

TABLE 8C

| | End-portion | | | | |
|---|---|---|---|---|---|
| | fogging | | Withstand | | |
| | resistance | | voltage | | Overall |
| | FD value | Grade | kV | Grade | determination |
| Example 1-1 | 0.002 | A | −8.5 | A | A |
| Example 1-2 | 0.005 | A | −8.6 | A | A |
| Example 1-3 | 0.006 | A | −8.7 | A | A |
| Example 1-4 | 0.002 | A | −8.7 | A | A |
| Example 1-5 | 0.002 | A | −8.6 | A | A |
| Example 1-6 | 0.002 | A | −8.6 | A | A |
| Example 1-7 | 0.003 | A | −8.6 | A | A |
| Example 1-8 | 0.006 | A | −8.5 | A | A |
| Example 1-9 | 0.008 | A | −8.7 | A | A |
| Example 1-10 | 0.008 | A | −8.7 | A | A |
| Example 1-11 | 0.004 | A | −8.6 | A | A |
| Example 1-12 | 0.006 | A | −8.4 | A | A |
| Example 1-13 | 0.002 | A | −8.6 | A | A |
| Example 1-14 | 0.002 | A | −9.3 | A | A |
| Example 1-15 | 0.002 | A | −8.2 | A | A |
| Example 1-16 | 0.005 | A | −8.6 | A | A |
| Example 1-17 | 0.006 | A | −8.6 | A | A |
| Example 1-18 | 0.006 | A | −8.5 | A | A |
| Example 1-19 | 0.002 | A | −8.6 | A | A |
| Example 1-20 | 0.003 | A | −8.5 | A | A |
| Example 1-21 | 0.004 | A | −8.5 | A | A |
| Example 1-22 | 0.008 | A | −8.6 | A | A |
| Example 1-23 | 0.008 | A | −8.6 | A | A |
| Example 1-24 | 0.009 | A | −8.6 | A | A |

TABLE 9A

| | | | | Scratch | | | |
|---|---|---|---|---|---|---|---|
| | | Breaking | | resistance | | Amount | |
| | Photo- | strain | | depth | | of wear | |
| | receptor | % | Grade | μm | Grade | μm | Grade |
| Comparative Example 1-1 | B-1 | 8.0 | A | 1.55 | C | 9.6 | C |
| Comparative Example 1-2 | B-2 | 9.0 | A | 1.21 | C | 8.4 | C |
| Comparative Example 1-3 | B-3 | 9.8 | A | 1.07 | C | 7.1 | C |
| Comparative Example 1-4 | B-4 | 11.8 | A | 0.97 | C | 5.8 | C |
| Comparative Example 1-5 | B-5 | 14.4 | A | 0.45 | A | 3.3 | A |
| Comparative Example 1-6 | B-6 | 7.3 | C | 0.78 | C | 4.6 | B |
| Comparative Example 1-7 | B-7 | 6.8 | C | 0.33 | A | 4.9 | B |
| Comparative Example 1-8 | B-8 | 22.0 | C | 0.35 | A | 0.9 | A |
| Comparative Example 1-9 | B-9 | 15.0 | C | 0.66 | C | 4.1 | B |

TABLE 9B

| | Charging potential after recharging | | | |
|---|---|---|---|---|
| | | | Potential | |
| | Paper- | Non-paper- | reduction | |
| | passing | passing | amount | |
| | portion | portion | (V01 − | |
| | (V01) | (V02) | V02) | Grade |
| Comparative Example 1-1 | 676 | 576 | 100 | C |
| Comparative Example 1-2 | 654 | 563 | 91 | C |
| Comparative Example 1-3 | 666 | 543 | 123 | C |
| Comparative Example 1-4 | 632 | 533 | 99 | C |
| Comparative Example 1-5 | 703 | 633 | 70 | B |
| Comparative Example 1-6 | 689 | 622 | 67 | B |
| Comparative Example 1-7 | 745 | 677 | 68 | B |
| Comparative Example 1-8 | 777 | 704 | 73 | B |
| Comparative Example 1-9 | 642 | 555 | 87 | C |

TABLE 9C

| | End-portion | | | | |
|---|---|---|---|---|---|
| | fogging | | | | |
| | resistance | | Withstand | | Overall |
| | FD | | voltage | | determi- |
| | value | Grade | kV | Grade | nation |
| Comparative Example 1-1 | 0.106 | C | −7.7 | C | B |
| Comparative Example 1-2 | 0.085 | C | −7.5 | C | B |
| Comparative Example 1-3 | 0.071 | C | −7.5 | C | B |
| Comparative Example 1-4 | 0.045 | C | −7.0 | C | B |
| Comparative Example 1-5 | 0.233 | C | −6.7 | C | B |
| Comparative Example 1-6 | 0.026 | C | −7.4 | C | B |
| Comparative Example 1-7 | 0.041 | C | −7.3 | C | B |
| Comparative Example 1-8 | 0.025 | C | −7.6 | C | B |
| Comparative Example 1-9 | 0.045 | C | −7.6 | C | B |

TABLE 10A

| | | | | Scratch | | | |
|---|---|---|---|---|---|---|---|
| | | Breaking | | resistance | | Amount | |
| | Photo- | strain | | depth | | of wear | |
| | receptor | % | Grade | μm | Grade | μm | Grade |
| Example 2-1 | C-1 | 10.0 | A | 0.31 | A | 2.1 | A |
| Example 2-2 | C-2 | 14.5 | A | 0.35 | A | 1.9 | A |
| Example 2-3 | C-3 | 17.9 | A | 0.35 | A | 1.6 | A |
| Example 2-4 | C-4 | 20.5 | A | 0.40 | A | 1.3 | A |
| Example 2-5 | C-5 | 13.6 | A | 0.30 | A | 1.6 | A |
| Example 2-6 | C-6 | 15.3 | A | 0.31 | A | 1.5 | A |
| Example 2-7 | C-7 | 16.5 | A | 0.39 | A | 1.8 | A |
| Example 2-8 | C-8 | 13.9 | A | 0.42 | A | 2.3 | A |
| Example 2-9 | C-9 | 16.2 | A | 0.35 | A | 1.5 | A |
| Example 2-10 | C-10 | 18.7 | A | 0.30 | A | 1.3 | A |
| Example 2-11 | C-11 | 14.7 | A | 0.39 | A | 2.0 | A |
| Example 2-12 | C-12 | 12.1 | A | 0.38 | A | 2.2 | A |
| Example 2-13 | C-13 | 16.7 | A | 0.34 | A | 2.4 | A |
| Example 2-14 | C-14 | 17.1 | A | 0.41 | A | 2.2 | A |
| Example 2-15 | C-15 | 14.4 | A | 0.44 | A | 2.4 | A |
| Example 2-16 | C-16 | 13.7 | A | 0.46 | A | 2.3 | A |
| Example 2-17 | C-17 | 16.7 | A | 0.37 | A | 1.6 | A |
| Example 2-18 | C-18 | 15.7 | A | 0.39 | A | 1.8 | A |
| Example 2-19 | C-19 | 14.8 | A | 0.40 | A | 1.9 | A |
| Example 2-20 | C-20 | 13.3 | A | 0.48 | A | 3.8 | A |
| Example 2-21 | C-21 | 15.5 | A | 0.38 | A | 1.9 | A |
| Example 2-22 | C-22 | 14.5 | A | 0.43 | A | 2.1 | A |
| Example 2-23 | C-23 | 16.6 | A | 0.43 | A | 2.2 | A |
| Example 2-24 | C-24 | 14.8 | A | 0.41 | A | 2.1 | A |

TABLE 10B

| | Charging potential after recharging | | | |
|---|---|---|---|---|
| | Paper- | Non-paper- | Potential | |
| | passing | passing | reduction | |
| | portion | portion | amount | |
| | (V01) | (V02) | (V01 − V02) | Grade |
| Example 2-1 | 768 | 731 | 37 | A |
| Example 2-2 | 783 | 742 | 41 | A |
| Example 2-3 | 773 | 733 | 40 | A |
| Example 2-4 | 763 | 735 | 28 | A |
| Example 2-5 | 762 | 729 | 33 | A |
| Example 2-6 | 764 | 722 | 42 | A |
| Example 2-7 | 752 | 711 | 41 | A |
| Example 2-8 | 773 | 743 | 30 | A |
| Example 2-9 | 763 | 733 | 30 | A |
| Example 2-10 | 784 | 743 | 41 | A |
| Example 2-11 | 761 | 733 | 28 | A |
| Example 2-12 | 771 | 729 | 42 | A |
| Example 2-13 | 770 | 733 | 37 | A |
| Example 2-14 | 764 | 734 | 30 | A |
| Example 2-15 | 756 | 728 | 28 | A |
| Example 2-16 | 772 | 733 | 39 | A |
| Example 2-17 | 764 | 723 | 41 | A |
| Example 2-18 | 771 | 734 | 37 | A |
| Example 2-19 | 769 | 723 | 46 | A |
| Example 2-20 | 764 | 733 | 31 | A |
| Example 2-21 | 773 | 733 | 40 | A |
| Example 2-22 | 784 | 743 | 41 | A |
| Example 2-23 | 770 | 730 | 40 | A |
| Example 2-24 | 763 | 723 | 40 | A |

TABLE 10C

| | End-portion | | | | |
|---|---|---|---|---|---|
| | fogging | | Withstand | | |
| | resistance | | voltage | | Overall |
| | FD value | Grade | kV | Grade | determination |
| Example 2-1 | 0.003 | A | −9.0 | A | A |
| Example 2-2 | 0.006 | A | −9.1 | A | A |
| Example 2-3 | 0.005 | A | −9.2 | A | A |
| Example 2-4 | 0.007 | A | −9.2 | A | A |
| Example 2-5 | 0.003 | A | −9.1 | A | A |
| Example 2-6 | 0.002 | A | −9.1 | A | A |
| Example 2-7 | 0.003 | A | −9.1 | A | A |
| Example 2-8 | 0.005 | A | −9.0 | A | A |
| Example 2-9 | 0.007 | A | −9.2 | A | A |
| Example 2-10 | 0.000 | A | −9.2 | A | A |
| Example 2-11 | 0.007 | A | −9.1 | A | A |
| Example 2-12 | 0.006 | A | −8.9 | A | A |
| Example 2-13 | 0.004 | A | −9.1 | A | A |
| Example 2-14 | 0.005 | A | −9.6 | A | A |
| Example 2-15 | 0.005 | A | −8.7 | A | A |
| Example 2-16 | 0.004 | A | −9.1 | A | A |
| Example 2-17 | 0.003 | A | −9.1 | A | A |
| Example 2-18 | 0.005 | A | −9.0 | A | A |
| Example 2-19 | 0.006 | A | −9.1 | A | A |
| Example 2-20 | 0.005 | A | −9.7 | A | A |
| Example 2-21 | 0.006 | A | −8.5 | A | A |
| Example 2-22 | 0.005 | A | −9.1 | A | A |
| Example 2-23 | 0.005 | A | −9.1 | A | A |
| Example 2-24 | 0.004 | A | −9.1 | A | A |

TABLE 11A

| | | | | Scratch | | | |
|---|---|---|---|---|---|---|---|
| | | Breaking | | resistance | | Amount | |
| | Photo- | strain | | depth | | of wear | |
| | receptor | % | Grade | μm | Grade | μm | Grade |
| Comparative Example 1-1 | D-1 | 7.8 | A | 1.53 | C | 9.5 | C |
| Comparative Example 1-2 | D-2 | 9.1 | A | 1.17 | C | 8.2 | C |
| Comparative Example 1-3 | D-3 | 10.4 | A | 1.02 | C | 7.0 | C |
| Comparative Example 1-4 | D-4 | 12.4 | A | 0.96 | C | 5.7 | C |
| Comparative Example 1-5 | D-5 | 14.4 | A | 0.44 | A | 3.3 | A |
| Comparative Example 1-6 | D-6 | 7.3 | C | 0.78 | C | 4.5 | B |
| Comparative Example 1-7 | D-7 | 7.1 | C | 0.32 | A | 4.7 | B |
| Comparative Example 1-8 | D-8 | 22.5 | C | 0.34 | A | 0.8 | A |
| Comparative Example 1-9 | D-9 | 15.0 | C | 0.66 | C | 4.2 | B |

TABLE 11B

| | Charging potential after recharging | | | |
|---|---|---|---|---|
| | | | Potential | |
| | Paper- | Non-paper- | reduction | |
| | passing | passing | amount | |
| | portion | portion | (V01 − | |
| | (V01) | (V02) | V02) | Grade |
| Comparative Example 1-1 | 672 | 588 | 84 | C |
| Comparative Example 1-2 | 657 | 575 | 82 | C |
| Comparative Example 1-3 | 665 | 555 | 110 | C |
| Comparative Example 1-4 | 630 | 545 | 85 | C |
| Comparative Example 1-5 | 703 | 624 | 79 | B |
| Comparative Example 1-6 | 689 | 632 | 57 | B |
| Comparative Example 1-7 | 745 | 673 | 72 | B |
| Comparative Example 1-8 | 775 | 706 | 69 | B |
| Comparative Example 1-9 | 642 | 555 | 87 | C |

TABLE 11C

| | End-portion | | | | |
|---|---|---|---|---|---|
| | fogging | | | | |
| | resistance | | Withstand | | Overall |
| | FD | | voltage | | determi- |
| | value | Grade | kV | Grade | nation |
| Comparative Example 1-1 | 0.104 | C | −7.9 | C | B |
| Comparative Example 1-2 | 0.082 | C | −7.8 | C | B |
| Comparative Example 1-3 | 0.070 | C | −7.8 | C | B |
| Comparative Example 1-4 | 0.042 | C | −7.3 | C | B |
| Comparative Example 1-5 | 0.042 | C | −6.1 | C | B |
| Comparative Example 1-6 | 0.023 | C | −7.7 | C | B |
| Comparative Example 1-7 | 0.040 | C | −7.6 | C | B |
| Comparative Example 1-8 | 0.028 | C | −7.9 | C | B |
| Comparative Example 1-9 | 0.023 | C | −7.1 | C | B |

In the single-layer photoreceptors (A-1) to (A-24) according to Example 1-1 to Example 1-24 and the stacked photoreceptors (C-1) to (C-24) according to Example 2-1 to Example 2-24, the breaking strain, the scratch resistance depth, the amount of wear, the charging potential after recharging, the end-portion fogging density, and the withstand voltage were determined as A, and they were evaluated as A for their excellent wear resistance and fogging resistance (suppression of the occurrence of end-portion fogging).

In the single-layer photoreceptors (B-1) to (B-9) according to Comparative Example 1-1 to Comparative Example 1-9 and the stacked photoreceptors (D-1) to (D-9) according to Comparative Example 2-1 to Comparative Example 2-9, any of the breaking strain, the scratch resistance depth, the amount of wear, the charging potential after recharging, the end-portion fogging density, and the withstand voltage was determined as C, and they were evaluated as B for their wear resistance and fogging resistance.

Specifically, in the photoreceptors (B-1) to (B-4) and the photoreceptors (D-1) to (D-4), the resins (R-8) to (R-11) other than the polyarylate resin according to the present disclosure are used. For this reason, in Comparative Examples (1-1) to (1-4) and Comparative Examples (2-1) to (2-4), the scratch resistance depth, the amount of wear, the charging potential after recharging, end-portion fogging density, and the withstand voltage were determined as C.

In the photoreceptors (B-5) and (B-6) and the photoreceptors (D-5) and (D-6), the content ratio of the polyester resin (PE-a) in the binder resin is 0 or 10 parts by mass. For this reason, in Comparative Example 1-5 and Comparative Example 2-5 in which the content ratio of the polyester resin (PE-a) in the binder resin is 0, the end-portion fogging density and the withstand voltage were determined as C, the end-portion fogging density was determined as C, and the wear resistance and fogging resistance decreased. In Comparative Example 1-6 and Comparative Example 2-6 in which the content ratio of the polyester resin (PE-a) in the binder resin is large, i.e., 10 parts by mass, the breaking strain and the scratch resistance depth were determined as C, the charging potential after recharging was determined as B, and the wear resistance decreased. Further, the end-portion fogging density and the withstand voltage were also determined as C, and the fogging resistance was not improved.

In the photoreceptors (B-7) and (B-8) and the photoreceptors (D-7) and (D-8), the viscosity average molecular weight was outside the range of 35,000 or more and 80,000 or less. For this reason, in Comparative Example 1-7 and Comparative Example 2-7 in which the viscosity average molecular weight is low, the breaking strain, the end-portion fogging density, and the withstand voltage were determined as C. Further, in Comparative Example 1-8 and Comparative Example 2—in which the viscosity average molecular weight is high, the breaking strain, the end-portion fogging density, and the withstand voltage were determined as C.

In the photoreceptor (B-9) and the photoreceptor (D-9), the resin (PE-z) was used instead of the polyester resin according to the present disclosure. For this reason, the scratch resistance depth, the charging potential after recharging, the end-portion fogging density, and the withstand voltage were determined as C.

It should be understood by those skilled in the art that various modifications, combinations, sub-combinations and alterations may occur depending on design requirements and other factors insofar as they are within the scope of the appended claims or the equivalents thereof.

What is claimed is:

1. An electrophotographic photoreceptor, comprising:
a conductive base; and
a photosensitive layer that includes at least one layer,
the photosensitive layer that includes at least one layer including a first photosensitive layer, the first photosensitive layer being provided on an outermost surface side of the photosensitive layer that includes at least one layer,
the first photosensitive layer including a charge generating agent, a binder resin that includes a polyarylate resin and a polyester resin, an electron transporting agent, and a hole transporting agent,
the polyester resin including a first repeating unit represented by the following formula (a) and a second repeating unit represented by the following formula (b),
a content ratio of the polyester resin being 0.5 mass % or more and 8.5 mass % or less with respect to all binder resins included in the first photosensitive layer,
the polyarylate resin including repeating units represented by the following formulae (1), (2), (3), and (4),
the polyarylate resin having a viscosity average molecular weight of 35,000 or more and 80,000 or less,
a third content ratio being more than 0% and less than 50%, the third content ratio being a content ratio of the repeating unit represented by the formula (3) with respect to a total number of repeating units represented by the formulae (1) and (3),
a fourth content ratio being 35% or more and less than 70%, the fourth content ratio being a content ratio of the repeating unit represented by the formula (4) with respect to a total number of repeating units represented by the formulae (2) and (4),
the electron transporting agent including a compound represented by the following formula (11), (12), (13), (14), (15), (16), or (17): 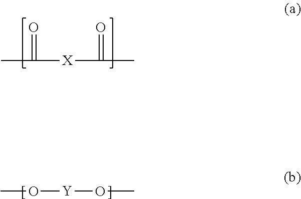
wherein, in the general formula (a), X represents a phenylene group that may be substituted with a first substituent group, the first substituent group being a phenyl group, an alkyl group having 1 to 8 carbon atoms, or an alkoxy group having 1 to 8 carbon atoms,
in the general formula (b), Y represents a divalent aliphatic hydrocarbon group having 1 to 8 carbon atoms, which may be substituted with a second substituent group, the second substituent group being a phenyl group or an alkoxy group having 1 to 8 carbon atoms, 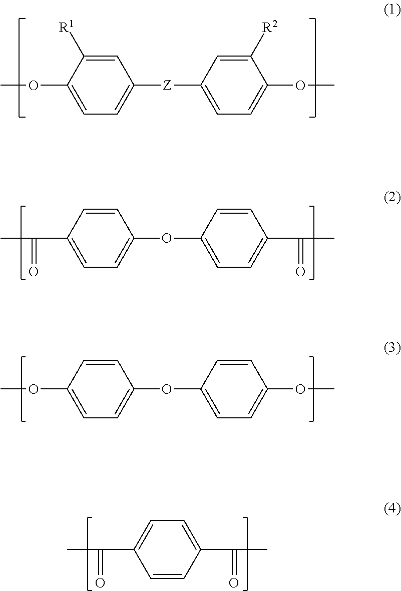
wherein, in the formula (1), R¹ and R² each represent a methyl group and Z represents a divalent group represented by the following formula (Z1), or
R¹ and R² each represent a hydrogen atom and Z represents a divalent group represented by the following formula (Z2), 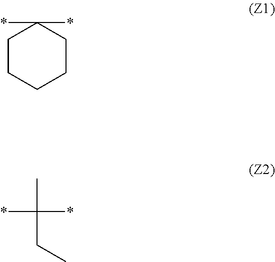
wherein, in the formulae (Z1) and (Z2), * represents atomic bonding, 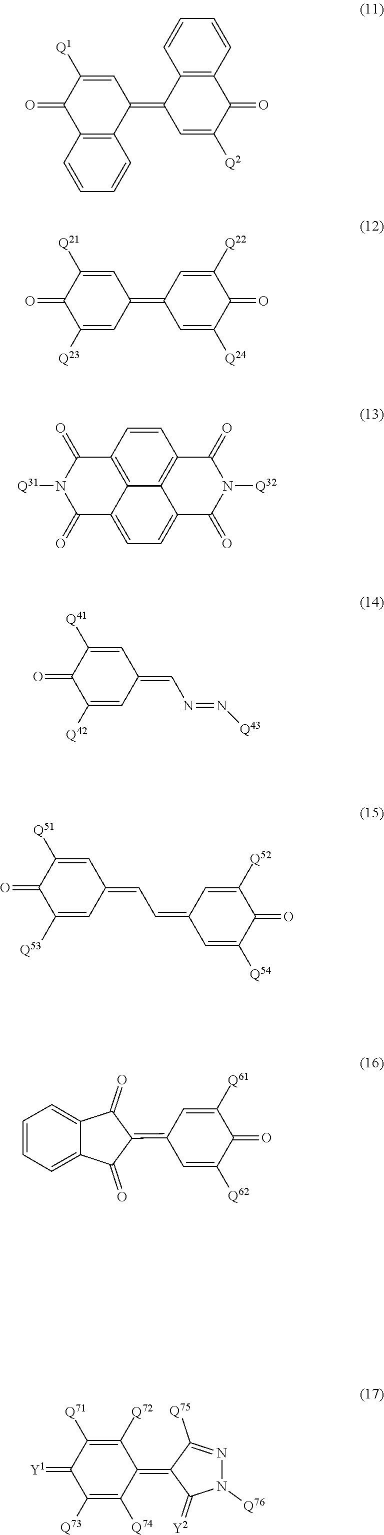
wherein Q¹ and Q² in the formula (11), Q²¹, Q²², Q²³, and Q²⁴ in the formula (12), Q³¹ and Q³² in the formula (13), Q⁴¹, Q⁴², and Q⁴³ in the formula (14), Q⁵¹, Q⁵², Q⁵³, and Q⁵⁴ in the formula (15), Q⁶¹ and Q⁶² in the formula (16), and Q⁷¹, Q⁷², Q⁷³, Q⁷⁴, Q⁷⁵, and Q⁷⁶ in the formula (17) each independently represent a hydrogen atom, a halogen atom, a cyano group, an alkyl group having 1 to 6 carbon atoms, an alkenyl group having 2 to 6 carbon atoms, an alkoxy group having 1 to 6 carbon atoms, or an aryl group having 6 to 14 carbon atoms that may be substituted with at least one substituent group selected from the group consisting of an alkyl group having 1 to 6 carbon atoms and a halogen atom, and
Y¹ and Y² in the formula (17) each independently represent an oxygen atom or a sulfur atom.

2. The electrophotographic photoreceptor according to claim 1, wherein
the repeating unit represented by the formula (a) is represented by the following chemical formula (a-1) or (a-2), and
the repeating unit represented by the formula (b) is represented by the following chemical formula (b-1), (b-2), (b-3), or (b-4):

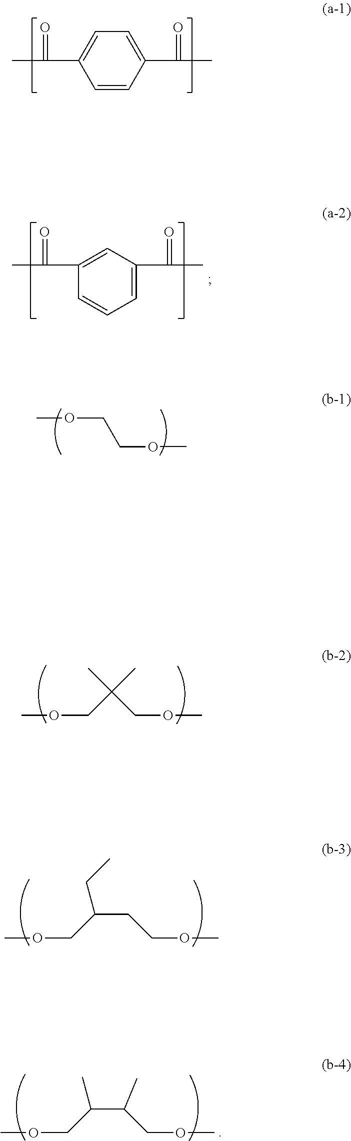

3. The electrophotographic photoreceptor according to claim 1, wherein
a ratio of a mass of the binder resin to a mass of the first photosensitive layer is 0.35 or more and 0.50 or less.

4. The electrophotographic photoreceptor according to claim 1, wherein
the first photosensitive layer has a scratch resistance depth of 0.50 μm or less.

5. The electrophotographic photoreceptor according to claim 1, wherein
the first photosensitive layer has a breaking strain of 7.5% or more and 21.0% or less.

6. The electrophotographic photoreceptor according to claim 1, wherein
the first photosensitive layer has a Vickers hardness of 19.0 HV or more.

7. The electrophotographic photoreceptor according to claim 1, wherein
in the formula (1), R¹ and R² each represent a methyl group and Z represents the divalent group represented by the formula (Z1).

8. The electrophotographic photoreceptor according to claim 1, wherein
in the formula (1), R¹ and R² each represent a methyl group and Z represents the divalent group represented by the formula (Z1), and
the fourth content ratio is 35% or more and 65% or less.

9. The electrophotographic photoreceptor according to claim 1, wherein
in the formula (1), R¹ and R² each represent a methyl group and Z represents the divalent group represented by the formula (Z1), and
the third content ratio is 20% or more and 40% or less.

10. The electrophotographic photoreceptor according to claim 1, wherein
in the formula (1), R¹ and R² each represent a methyl group and Z represents the divalent group represented by the formula (Z1), and
the polyarylate resin further has a terminal group represented by the following formula (T-DMP) or a terminal group represented by the following formula (T-PFH)

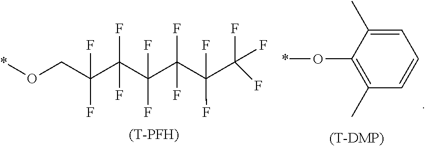

11. The electrophotographic photoreceptor according to claim 1, wherein
in the formula (1), R¹ and R² each represent a hydrogen atom and Z represents the divalent group represented by the formula (Z2), and
the fourth content ratio is 35% or more and 50% or less.

12. The electrophotographic photoreceptor according to claim 1, wherein
a first content ratio is a value different from both a second content ratio and the fourth content ratio, the first content ratio being a content ratio of the repeating unit represented by the formula (1) with respect to a total number of repeating units represented by the formulae (1) and (3), the second content ratio being a content ratio of the repeating unit represented by the formula (2) with respect to a total number of repeating units represented by the formulae (2) and (4), and
the third content ratio is a value different from both the second content ratio and the fourth content ratio.

13. The electrophotographic photoreceptor according to claim 1, wherein
the third content ratio is 20% or more and 40% or less.

14. The electrophotographic photoreceptor according to claim 1, wherein
the electron transporting agent is a compound represented by the following formula (E-1), (E-2), (E-3), (E-4), (E-5), (E-6), (E-7), (E-8), or (E-9):

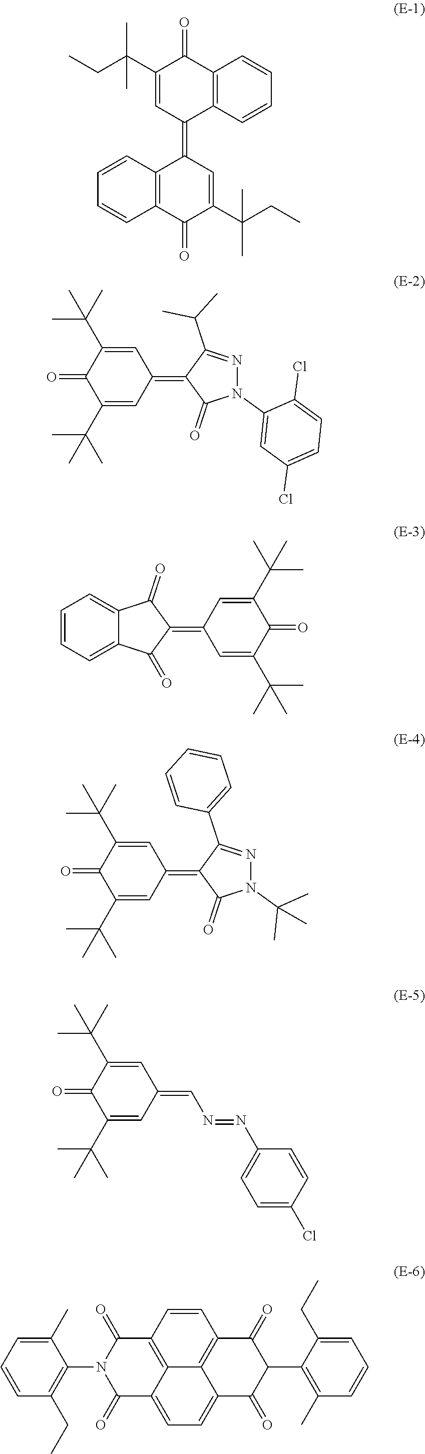

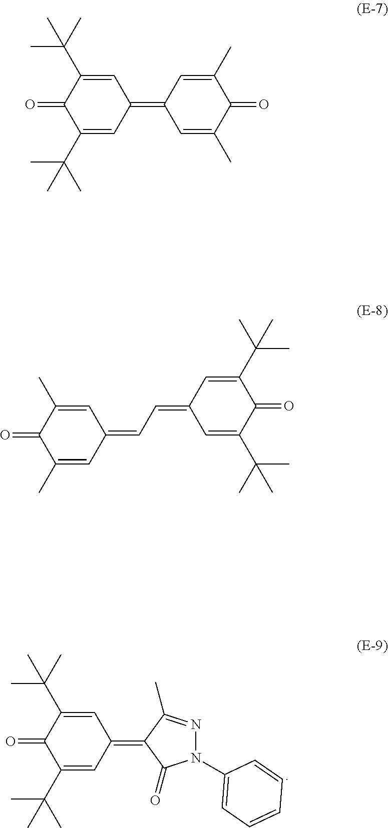 [SMILES: CC1=CC(=C2C=C(C(C)(C)C)C(=O)C(C(C)(C)C)=C2)C=C(C)C1=O ; CC1=CC(=CC=C2C=C(C(C)(C)C)C(=O)C(C(C)(C)C)=C2)C=C(C)C1=O ; CC1=NN(c2ccccc2)C(=O)C1=C1C=C(C(C)(C)C)C(=O)C(C(C)(C)C)=C1]

15. The electrophotographic photoreceptor according to claim 1, wherein
the hole transporting agent includes a compound represented by the following formula (20), (21), (22), (23), or (24): 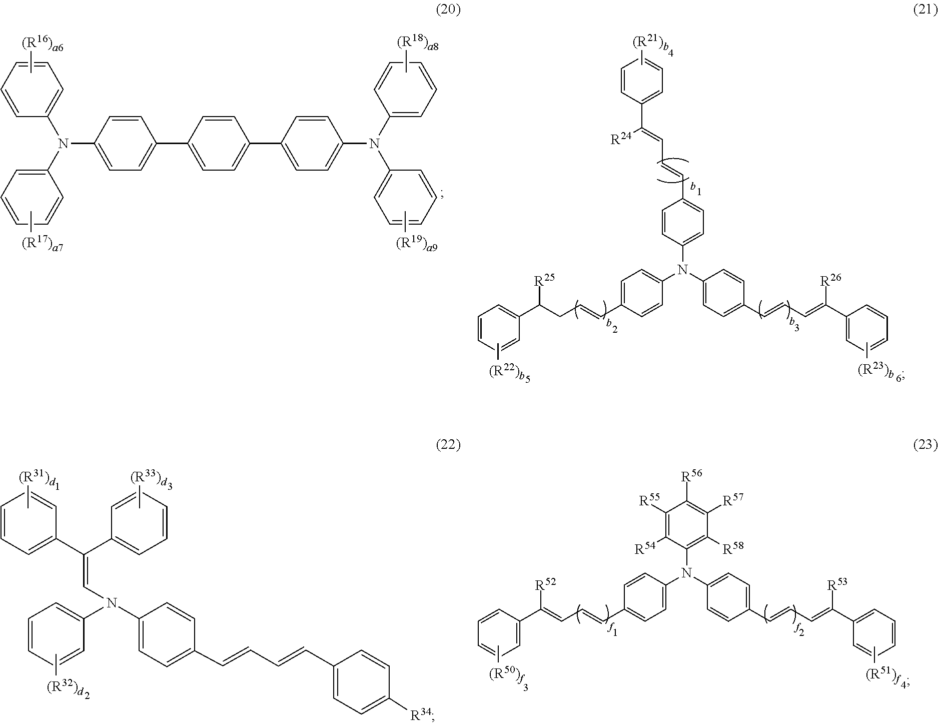 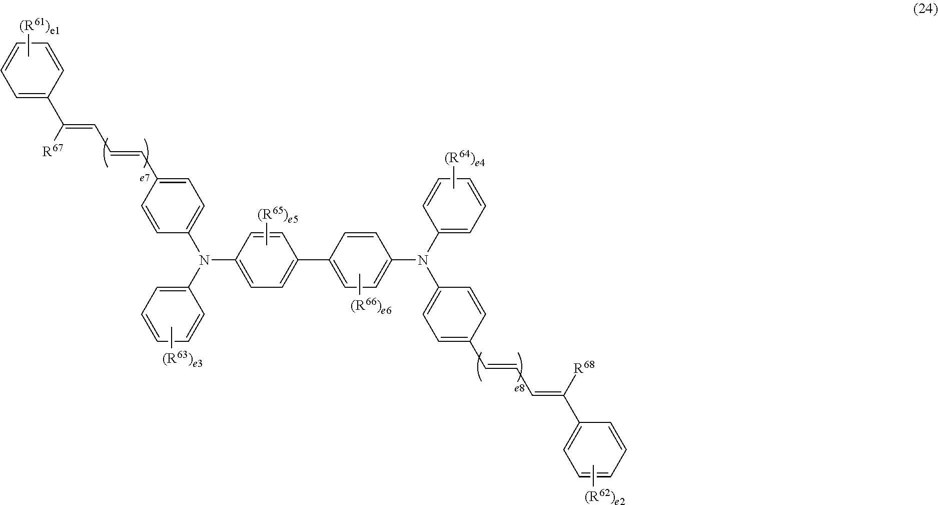
wherein, in the formula (20), R¹⁶, R¹⁷, R¹⁸, and R¹⁹ each independently represent an alkyl group having 1 to 6 carbon atoms, and a6, a7, a8, and a9 each independently represent an integer of 0 or more and 5 or less,
in the formula (21), R²¹, R²², and R²³ each independently represent an alkyl group having 1 to 6 carbon atoms, R²⁴, R²⁵, and R²⁶ each independently represent a hydrogen atom, an alkyl group having 1 to 6 carbon atoms, or an aryl group having 6 to 14 carbon atoms, b₁, b₂, and b₃ each independently represent 0 or 1, and b₄, b₅, and b₆ each independently represent an integer of 0 or more and 5 or less,
in the formula (22), R³¹, R³², and R³³ each independently represent an alkyl group having 1 to 6 carbon atoms, R³⁴ represents an alkyl group having 1 to 6 carbon atoms or a hydrogen atom, and d₁, d₂, and d₃ each independently represent an integer of 0 or more and 5 or less,
in the formula (23), R⁵⁰ and R⁵¹ each independently represent an alkyl group having 1 to 6 carbon atoms, an alkoxy group having 1 to 6 carbon atoms, or a phenyl group, R⁵², R⁵³, R⁵⁴, R⁵⁵, R⁵⁶, R⁵⁷, and R^{5s} each independently represent a hydrogen atom, an alkyl group having 1 to 6 carbon atoms, an alkoxy group having 1 to 6 carbon atoms, or a phenyl group that may be substituted with an alkyl group having 1 to 6 carbon atoms, f₁ and f₂ each independently represent an integer of 0 or more and 2 or less, and f₃ and f₄ each independently represent an integer of 0 or more and 5 or less, and
in the formula (24), R⁶¹, R⁶², R⁶³, R⁶⁴, R⁶⁵, and R⁶⁶ each independently represent an alkyl group having 1 to 8 carbon atoms or a phenyl group, R⁶⁷ and R⁶⁸ each independently represent a hydrogen atom, an alkyl group having 1 to 8 carbon atoms, or a phenyl group, e1, e2, e3, and e4 each independently represent an integer of 0 or more and 5 or less, e5 and e6 each independently represent an integer of 0 or more and 4 or less, and e7 and e8 each independently represent 0 or 1.

16. The electrophotographic photoreceptor according to claim 1, wherein
the hole transporting agent includes a compound represented by the following formula (H-1), (H-2), (H-3), (H-4), (H-5), (H-6), (H-7), (H-8), (H-9), or (H-10):

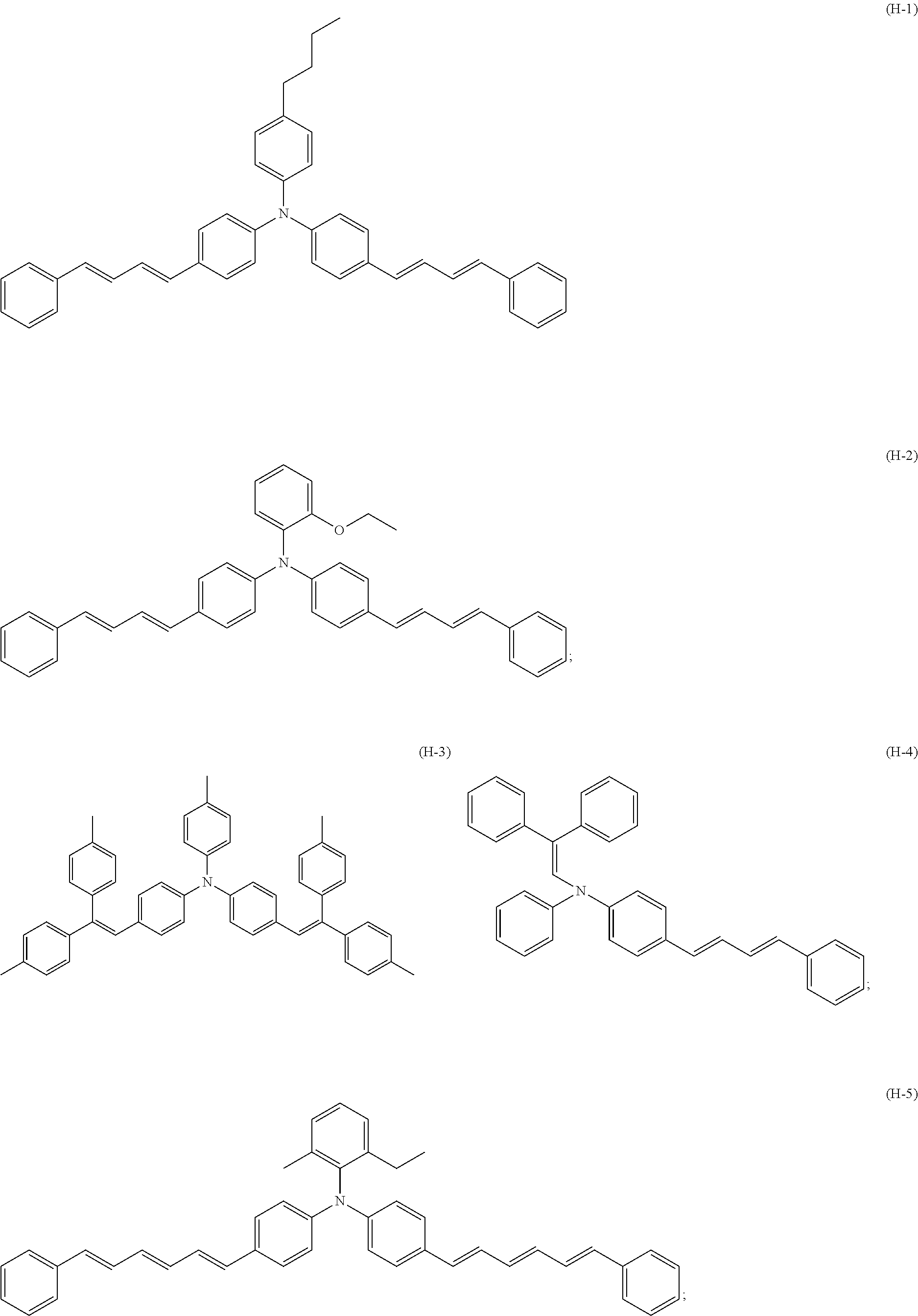

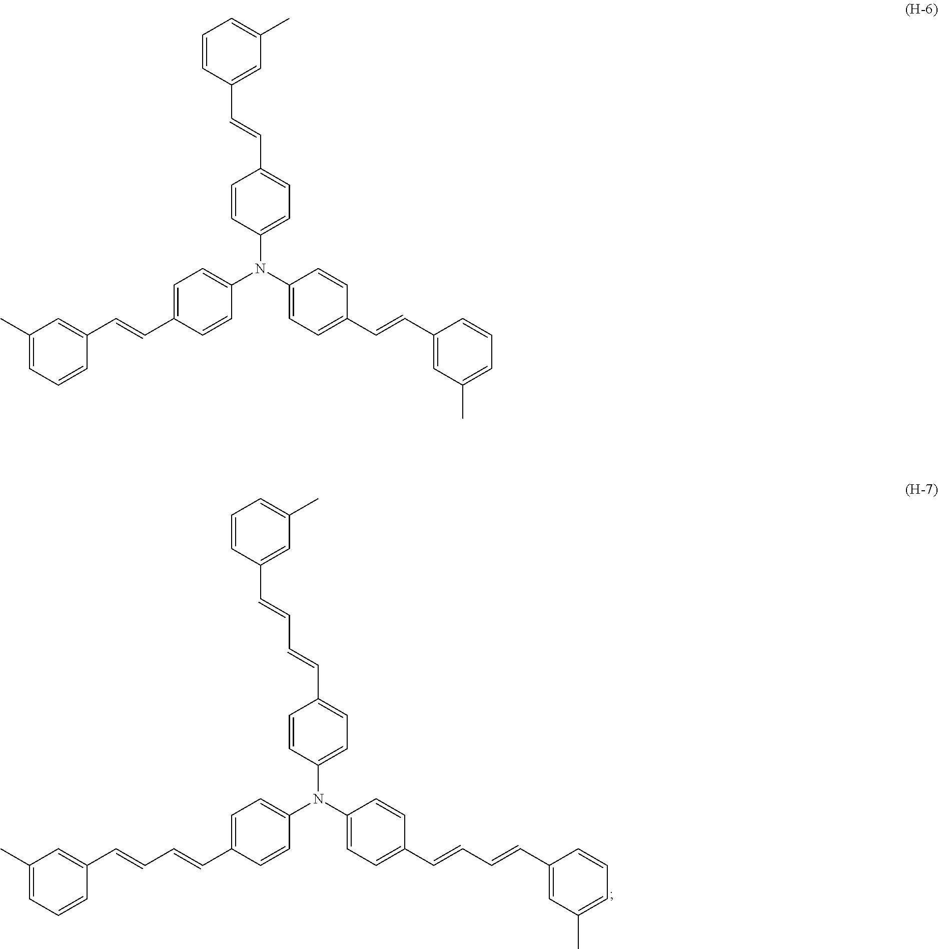 [SMILES: Cc1cccc(/C=C/c2ccc(N(c3ccc(/C=C/c4cccc(C)c4)cc3)c3ccc(/C=C/c4cccc(C)c4)cc3)cc2)c1 ; Cc1cccc(/C=C/C=C/c2ccc(N(c3ccc(/C=C/C=C/c4cccc(C)c4)cc3)c3ccc(/C=C/C=C/c4cccc(C)c4)cc3)cc2)c1]

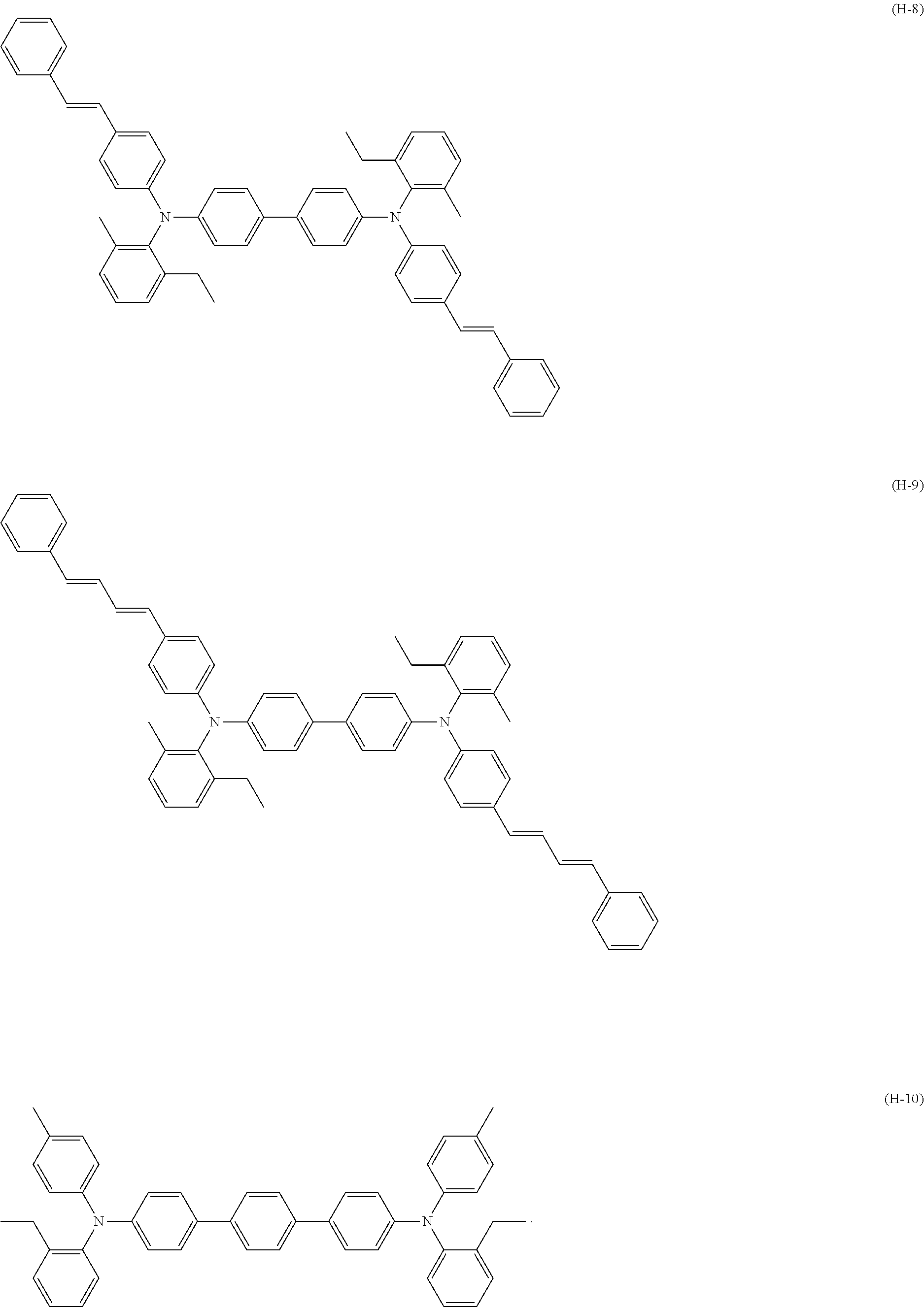 [SMILES: CCc1cccc(C)c1N(c1ccc(/C=C/c2ccccc2)cc1)c1ccc(-c2ccc(N(c3ccc(/C=C/c4ccccc4)cc3)c3c(C)cccc3CC)cc2)cc1 ; CCc1cccc(C)c1N(c1ccc(/C=C/C=C/c2ccccc2)cc1)c1ccc(-c2ccc(N(c3ccc(/C=C/C=C/c4ccccc4)cc3)c3c(C)cccc3CC)cc2)cc1 ; CCc1ccccc1N(c1ccc(C)cc1)c1ccc(-c2ccc(-c3ccc(N(c4ccc(C)cc4)c4ccccc4CC)cc3)cc2)cc1]

17. The electrophotographic photoreceptor according to claim 1, wherein
the photosensitive layer includes one layer, and the one layer of the photosensitive layer is a single-layer photosensitive layer that is the first photosensitive layer.

18. The electrophotographic photoreceptor according to claim 1, wherein
the photosensitive layer includes two layers, and the two layers of the photosensitive layer are a charge generating layer that is the first photosensitive layer and a charge transporting layer that is a second photosensitive layer.

19. A process cartridge, comprising:
at least one selected from the group consisting of a charging device, an exposure device, a development device, and a transfer device; and
the electrophotographic photoreceptor according to claim 1.

20. An image forming apparatus, comprising:
an image carrier;
a charging device that charges a surface of the image carrier to a positive polarity;
an exposure device that exposes the charged surface of the image carrier to form an electrostatic latent image on the surface of the image carrier;
a development device that supplies a toner to the surface of the image carrier to develop the electrostatic latent image as a toner image; and
a transfer device that transfers the toner image from the image carrier to a to-be-transferred body,
the image carrier being the electrophotographic photoreceptor according to claim 1.
